(19) United States
(12) Patent Application Publication
(10) Pub. No.: US 2023/0097093 A1
(43) Pub. Date: Mar. 30, 2023

(54) DIGITAL ASSET SALE USING A BI-DIRECTIONAL DIGITAL ASSET POINT OF SALE DEVICE

(71) Applicant: Flexa Network Inc., New York, NY (US)

(72) Inventors: Trevor Filter, New York, NY (US); Zachary Kilgore, Brooklyn, NY (US); Tyler Robert Spalding, New York, NY (US)

(73) Assignee: Flexa Network Inc., New York, NY (US)

(21) Appl. No.: 17/816,034

(22) Filed: Jul. 29, 2022

Related U.S. Application Data
(63) Continuation of application No. 17/449,429, filed on Sep. 29, 2021.

(51) Int. Cl. G06Q 20/20; G06Q 20/08; G07D 11/14; G06Q 20/36; G06Q 40/04; G07D 11/60; G06F 3/0482

(52) U.S. Cl. CPC G06Q 20/202; G06Q 20/208; G06Q 20/085; G06Q 20/204; G07D 11/14; G06Q 20/367; G06Q 40/04; G07D 11/60; G06F 3/0482; G07D 2211/00

(57) ABSTRACT

A method includes, initiating, by a user computing device, a sale of an amount of digital assets with a bi-directional digital asset point of sale (POS) computing device of a digital asset-based interaction system. The method further includes obtaining, by a digital asset-based interaction computing entity of the digital asset-based interaction system, real-time information regarding the sale of the amount of the digital assets and locking an amount of system digital assets to back the amount of the digital assets. The real-time information includes digital asset type of the digital assets, the amount of the digital assets, and a payment asset format. The method further includes obtaining, by the bi-directional digital asset POS computing device, a confirmation from the digital asset-based interaction computing entity that the amount of system digital assets have been locked and providing an amount of assets in the payment asset format to the user computing device.

### CROSS-REFERENCE TO RELATED APPLICATIONS

The present U.S. Utility patent application claims priority pursuant to 35 U.S.C. § 120 as a continuation of U.S. Utility application Ser. No. 17/449,429, entitled “BI-DIRECTIONAL DIGITAL ASSET POINT OF SALE COMPUTING DEVICE,” filed Sep. 29, 2021, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates generally to a digital asset-based interaction system and more specifically to a bi-directional digital asset point of sale computing device of the digital asset-based interaction system.

### Description of Related Art

Current payment systems are vulnerable to security breaches, fraud, and identity theft. A typical payment card transaction with a merchant involves several steps (e.g., payment card authorization, clearing, and settlement) and the participation of various entities (e.g., financial institutions, payment card companies, and payment processing networks). Each step and each entity has its own varying security problems (e.g., hacking).

The steps involved are also inconvenient, time consuming, and expensive. For example, payment card authorization (e.g., credit or debit card authorization) begins with the cardholder presenting the payment card to a merchant for goods or service. The payment card is issued by a particular financial institution (e.g., a bank) and is associated with a payment card company (e.g., Visa, Mastercard, etc.). The merchant uses a payment card machine, software, or gateway to transmit transaction data to their acquiring bank (or its processor). The acquiring bank routes the transaction data to a payment processing network and the payment processing network sends the transaction data to the cardholder's issuing bank. The issuing bank validates that the card has not been reported stolen or lost, confirms whether funds are available, and sends a response code back through the payment processing network to the acquiring bank as to whether the transaction is approved.

The transaction data typically includes the payment card number, transaction amount, date, merchant's name, merchant's location, merchant category code, and an encrypted personal identification number (PIN) if entered. The response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The payment processing network debits the issuing bank account and credits the acquiring bank account for the amount of the transaction.

Merchants pay substantial payment card processing fees, and those costs are passed along to consumers. Most merchants pay an interchange rate on a total transaction and a flat fee to the payment card company involved (e.g., Visa, Mastercard, etc.). Rates vary based on the payment card company, the payment card type (e.g., credit, debit, business, etc.), processing type (e.g., online payment, swiped, through a mobile device, card not present, etc.), and a Merchant Category Code (MCC) that classifies a merchant's type of business. Further, merchants typically pay a commission and a flat fee to the payment processing network.

Some merchants provide customer convenience features at payment terminals such as cash back on purchases. Merchants do not make a profit on the cash back portion of the transaction yet may still be held responsible for the interchange fee. Because cash exchanges are targets for fraud and abuse, merchants follow certain rules to meet requirements for security and reporting necessary for safe cash back transactions. For example, cash back is typically offered on debit card transactions only where a corresponding card network imposes cash back regulations. For example, cash back may only be allowed if an issuing bank permits it, a purchase must be made to receive cash back, and an electronic terminal is required to process the cash back transaction. Merchants need to track transactions and cash back amounts separately so they can be identified in authorization and clearing messages. While merchants can use discretion in setting a minimum cash back amount, card networks and geographic regions impose maximums for cash back (e.g., $200).

Mobile wallet applications allow cardholders to store payment card data on a computing device via a digital wallet for convenient transactions. For example, some mobile wallet apps use near field communication (NFC) for contactless payments (e.g., exchange of data by holding device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment. Further, user fraud via mobile wallets is possible.

Digital assets are digitally stored content that comes with a right to use. As a few examples, digital assets include images, audio, videos, documents (e.g., contracts, legal documents, etc.), cryptocurrency, cryptocurrency tokens, stocks, and intellectual property rights.

Distributed ledger technology (DLT) is a digital system that provides a consensus of replicated, shared, and synchronized digital data spread across several nodes. Unlike traditional databases, DLTs lack central authority. The nodes of a DLT implement a consensus protocol to validate the authenticity of transactions recorded in the ledger.

Distributed ledger technology reduces the risk of fraudulent activity. For example, a blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the entire network. Once recorded on the blockchain, transactions cannot be altered.

A cryptocurrency is a digital asset that is securely created and transferred via cryptography. Many cryptocurrencies are distributed networks based on distributed ledger technology (e.g., a blockchain). Decentralized networks like Bitcoin use pseudo-anonymous transactions that are open and public (i.e., anyone can join, create, and view transactions). To minimize fraudulent activity and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

Digital assets are typically bought and sold through digital asset exchanges and stored in a digital wallet application. A hosted/custodial digital wallet stores digital assets and safeguards password information such that if a password is forgotten the digital assets are not lost. Setting up a custodial digital wallet requires providing personal information to user identity. Before selling with an exchange, a user must link a bank account and/or a credit or debit card to deposit funds. To buy digital assets, a linked bank account is required.

Digital asset automated teller machines (ATMs) allow users to buy digital assets with a debit card or cash and in some cases sell digital assets for cash. Unlike traditional ATMs, digital asset ATMs are not connected to a bank account. Instead, they are connected directly to a digital asset exchange via an internet connection. Digital asset ATMs provide convenience and privacy to users over using an online exchanges because exchanges occur instantly, and the user is only required to provide minimal personal information. However, digital asset ATMs charge large processing fees to users and are susceptible to fraud.

### BRIEF DESCRIPTION OF THE SEVERAL VIEWS OF THE DRAWING(S)

FIG. 1 is a schematic block diagram of an embodiment of a digital asset-based interaction system;

FIG. 2 is a flowchart of an example of a method of a real-time digital asset-based interaction loop of a digital asset-based interaction system;

FIG. 3 is a flowchart of an example of a method of a nonreal-time digital asset-based interaction loop of a digital asset-based interaction system;

FIG. 4 is a schematic block diagram of another embodiment of a digital asset-based interaction system;

FIG. 4A is a schematic block diagram of an embodiment of a portion of a digital asset-based interaction system;

FIG. 5 is a schematic block diagram of an embodiment of a user computing device of a digital asset-based interaction system;

FIG. 6 is a schematic block diagram of an embodiment of a user computing device of a digital asset-based interaction system;

FIGS. 7A-7B are schematic block diagrams of an embodiment of a user computing device of a digital asset-based interaction system;

FIGS. 8A-8B are schematic block diagrams of an embodiment of a bi-directional digital asset point of sale (POS) computing device of a digital asset-based interaction system;

FIGS. 9A-9B are schematic block diagrams of an embodiment of a bi-directional digital asset point of sale (POS) computing device of a digital asset-based interaction system;

FIG. 10 is a flowchart of an example of a method of a digital asset-based payment of a digital asset-based interaction system;

FIG. 10A is a flowchart of an example of a method of a digital asset-based payment of a digital asset-based interaction system;

FIGS. 11A-11B are schematic block diagrams of an embodiment of a user computing device of a digital asset-based interaction system;

FIG. 12 is a flowchart of an example of a method for a show user authorization scannable code to pay (“show to pay”) payment mode of a digital asset-based interaction system;

FIG. 13 is a schematic block diagram of an embodiment of a scan to pay payment mode of a digital asset-based interaction system;

FIG. 14 is a flowchart of an example of a method for a scan to pay payment mode of a digital asset-based interaction system;

FIGS. 15A-15B are schematic block diagrams of embodiments of a user computing device of a digital asset-based interaction system;

FIGS. 16A-16B are schematic block diagrams of embodiments of a bi-directional digital asset POS computing device of a digital asset-based interaction system;

FIGS. 17A-17B are schematic block diagrams of embodiments of a user computing device of a digital asset-based interaction system;

FIG. 18 is a flowchart of an example of a method of a digital asset-based payment with an amount increase request real-time digital asset-based interaction loop of a digital asset-based interaction system;

FIG. 19 is a flowchart of an example of a method of a digital asset-based payment with an amount increase request nonreal-time digital asset-based interaction loop of a digital asset-based interaction system;

FIGS. 20A-20B are schematic block diagrams of embodiments of a bi-directional digital asset POS computing device of a digital asset-based interaction system;

FIGS. 21A-21B are schematic block diagrams of embodiments of a user computing device of a digital asset-based interaction system;

FIG. 22 is a schematic block diagram of an embodiment of a user computing device of a digital asset-based interaction system;

FIG. 23 is a schematic block diagram of an embodiment of a bi-directional digital asset POS computing device of a digital asset-based interaction system;

FIG. 24 is a flowchart of an example of a method of a digital asset sale real-time digital asset-based interaction loop of a digital asset-based interaction system;

FIG. 25 is a flowchart of an example of a method of a digital asset sale nonreal-time digital asset-based interaction loop of a digital asset-based interaction system;

FIGS. 26A-26B are schematic block diagrams of embodiments of a bi-directional digital asset POS computing device of a digital asset-based interaction system;

FIG. 27 is a schematic block diagram of an embodiment of a user computing device of a digital asset-based interaction system;

FIG. 28 is a schematic block diagram of an embodiment of a bi-directional digital asset POS computing device of a digital asset-based interaction system;

FIG. 29 is a schematic block diagram of an embodiment of a bi-directional digital asset POS computing device of a digital asset-based interaction system;

FIG. 30 is a schematic block diagram of an embodiment of a user computing device of a digital asset-based interaction system;

FIG. 31 is a flowchart of an example of a method of a digital asset purchase real-time digital asset-based interaction loop of a digital asset-based interaction system; and

FIG. 32 is a flowchart of an example of a method of a digital asset purchase nonreal-time digital asset-based interaction loop of a digital asset-based interaction system.

### DETAILED DESCRIPTION OF THE INVENTION

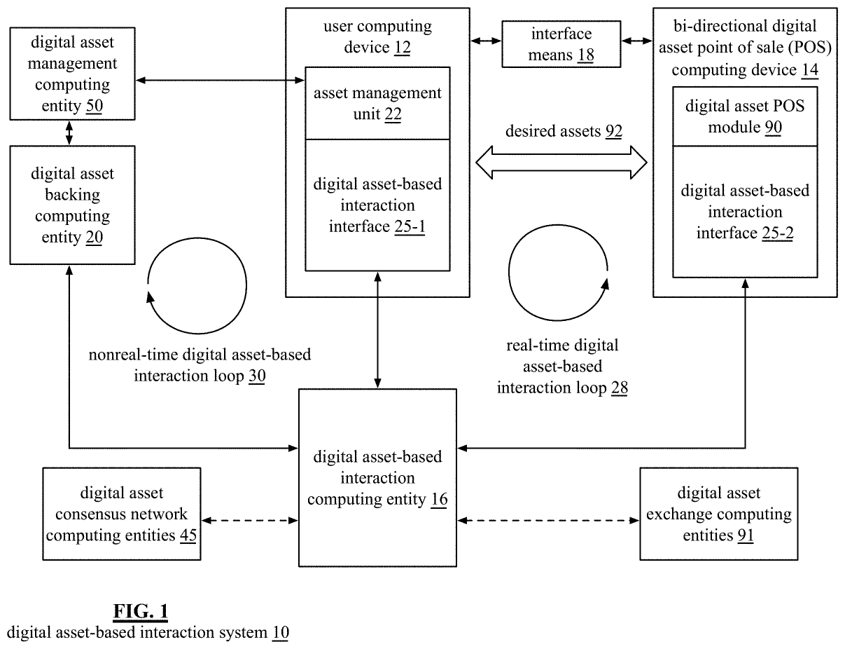

FIG. 1 is a schematic block diagram of an embodiment of a digital asset-based interaction system 10 that includes a user computing device 12, a bi-directional point of sale (POS) computing device 14, a digital asset-based interaction computing entity 16, an interface means 18, a digital asset backing computing entity 20, a digital asset management computing entity 50, one or more digital asset exchange computing entities 91, and one or more digital asset consensus network computing entities 45. The digital asset-based interaction system 10 facilitates a digital asset-based interaction between the user computing device 12 and the bi-directional digital asset POS computing device (e.g., a merchant POS computing device) where the bi-directional digital asset POS computing device 14 is operable to facilitate sending and obtaining desired assets 92 (e.g., digital assets, fiat currency, etc.) to and from a user computing device 12 for processing a variety of digital-asset based interactions (e.g., digital asset-based payments, a digital asset-based payment with an amount increase (e.g., “cash back”), digital asset sales, digital asset purchases, etc.) and overcomes the following issues.

At the filing of this application, digital assets such as cryptocurrency are not widely accepted by merchants as a form of payment for a variety of reasons. Further, merchants do not have the means for customers to receive cash back for digital assets, sell digital assets at a merchant POS terminal, and/or buy digital assets at a merchant POS terminal for a similar variety of reasons. For one, many merchants do not want to hold digital assets such as cryptocurrency. Holding digital assets involves several issues merchants are unfamiliar with and/or unequipped to deal with. These issues include holding private key information, legal compliance, government regulation, timing issues such as waiting for transaction confirmations, etc. Accepting digital assets such as cryptocurrency presents operational security issues and includes a level of technical complexity outside the scope of general merchant capabilities. Additionally, the value of digital assets such as cryptocurrency can be volatile, sometimes fluctuating dramatically in the course of one day. As another reason, merchants are reluctant to invest in expensive point-of-sale upgrades to accommodate digital asset-based payments, digital asset-based cash back, digital asset sales, and/or digital asset purchases directly. As yet another reason, many digital asset payments are public and expose sensitive merchant/customer information.

While some digital wallet applications enable retail blockchain payments, they are universally dependent on existing payment networks and thus are susceptible to the fraud attacks of the existing payment networks. For example, a cryptocurrency is linked to a payment card (e.g., a credit card, debit card, gift card, etc.), where a cryptocurrency payment is converted and conducted as a payment card transaction and, thus susceptible to the same fraud attacks as the payment card. Further, a billing address and/or other personal customer information may be required for a merchant to verify traditional payment card payments. A merchant may store this information which consumes data storage space and renders additional private customer information vulnerable to theft and fraud. Additionally, the costs of the existing payment network (e.g., payment transaction costs, fees, etc.) are maintained. Adding a digital asset payment option within an existing payment network only increases those costs.

Even though digital asset payments such as cryptocurrency payments significantly reduce fraudulent activity as compared to traditional payment systems, fraudulent digital asset transactions are possible. For example, malicious users can manipulate a cryptocurrency blockchain to “double spend” (e.g., create one transaction within a block to transfer an amount to a merchant and create another block without that transaction such that the transfer to the merchant does not exist). As another example, malicious or faulty digital wallet software can prevent a digital asset transaction from being authorized and completed correctly.

Within the digital asset-based interaction system 10, the digital asset-based interaction computing entity 16, the digital asset backing computing entity 20, the digital asset management computing entity 50, the one or more digital asset exchange computing entities 91, and the one or more digital asset consensus network computing entities 45 may be one or more computing devices, one or more distributed computing devices, and/or one or more modules executing on one or more computing devices.

The user computing device 12, the bi-directional digital asset POS computing device 14, the digital asset-based interaction computing entity 16, the digital asset backing computing entity 20, the digital asset management computing entity 50, the one or more digital asset exchange computing entities 91, and the one or more digital asset consensus network computing entities 45 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The digital asset-based interaction computing entity 16 is operable to connect to the one or more digital asset exchange computing entities 91 to convert an asset in a first asset format (e.g., a digital asset, fiat currency) to an asset in a second asset format (e.g., fiat currency, another digital asset, etc.), back digital-asset based interactions via the digital asset backing computing entity 20 such that digital asset-based interactions can be authorized and/or completed successfully in real-time, and connect to the one or more digital asset consensus network computing entities 45 to verify receipt of digital assets (e.g., a consensus network that implements a verification method associated with a particular digital asset). Digital assets are digitally stored content that comes with a right to use. As a few examples, digital assets include images, audio, videos, documents (e.g., contracts, legal documents, etc.), cryptocurrency, cryptocurrency tokens, digital fiat currency, stocks, and intellectual property rights.

The one or more digital asset exchange computing entities 91 are online platforms that allow users to trade digital assets for other forms of digital assets or other assets such as conventional government-issued fiat currency and/or other digital currencies. In an embodiment, the digital asset-based interaction computing entity 16 is a digital asset exchange computing entity where the digital asset exchange computing entity 16 may be specially licensed for exchange when licensing is required. In another embodiment, the digital asset-based interaction computing entity 16 and/or the one or more digital asset exchange computing entities 91 may be associated with one or more digital asset holding companies. A digital asset holding company stores sensitive materials and has insurance policies to protect against theft and fraud. A digital asset holding company may be specially licensed for holding digital assets when licensing is required.

The digital asset-based interaction computing entity 16 may be associated with a stored value account (SVA) device where the SVA device is associated with the bi-directional digital asset POS computing device 14 (e.g., a merchant associated with the bi-directional digital asset POS computing device has an SVA account with the SVA device) such that an SVA is generated for payment. In another embodiment, the digital asset-based interaction computing entity 16 is operable to generate stored value accounts (SVAs). Generation of SVAs for transactions is described in co-pending patent application Ser. No. 16/376,911, entitled, “SECURE AND TRUSTED DATA COMMUNICATION SYSTEM,” filed Apr. 5, 2019.

The user computing device 12 includes an asset management unit 22. The asset management unit 22 may be a digital wallet application or a network enabled smart contract application installed on or otherwise usable by the user computing device 12 that functions to store and manage (e.g., buy, sell, trade, custody, etc.) digital assets. The asset management unit 22 may be a custodial digital wallet application associated with the digital asset management computing entity 50 that may be specially licensed and insured to hold digital assets (e.g., a digital asset holding and management company, a cryptocurrency holding company, a cryptocurrency holding and exchange company, etc.).

Alternatively, the asset management unit 22 may be a non-custodial digital wallet application associated with a non-custodial digital asset management computing entity 50 (e.g., a digital asset exchange company) where the asset management unit 22 store digital assets and the user computing device 12 manages a private key to the asset management unit 22.

Alternatively, the asset management unit 22 may be a custodial or non-custodial digital wallet application associated with the digital asset-based interaction computing entity 16 (e.g., where the digital asset-based interaction computing entity 16 is a digital asset management computing entity 50). Alternatively, the asset management unit 22 is a network enabled smart contract application. A network enabled smart contract application allows a user to upload digital assets to a network enabled smart contract using a private key (e.g., non-custodial) and eliminates double spending issues associated with non-custodial wallets.

The bi-directional digital asset POS computing device 14 is associated with an entity such as a merchant and facilitates payments from a user computing device to the entity, provides a digital asset based cash back feature, facilitates digital asset purchases, and facilitates digital asset sales. The bi-directional digital asset POS computing device 14 includes a digital asset POS module 90 that facilitates sending and/or receiving assets during an interaction and includes POS software and/or hardware with payment features tailored to a type of bi-directional digital asset POS computing device 14. For example, the bi-directional digital asset POS computing device 14 may include one or more scanning devices, touchscreens, receipt printer, digital asset and/or currency storage devices, fiat currency dispensers and/or acceptors, etc., and any processing software related to those features.

The digital asset POS module 90 may include or be associated with a digital wallet application (e.g., similar to the asset management unit 22 examples above) depending on the types of assets the bi-directional digital asset POS computing device 14 wishes to accept and the desired method of receiving those assets. The bi-directional digital asset POS computing device 14 may include a variety of existing payment processing features (e.g., existing hardware and/or software) for processing payments within existing payment networks (e.g., a Secure Socket Layers (SSL) certificate, e-commerce shopping cart software, order and product management features, customer profile management capabilities, a payment gateway, an e-commerce merchant account with a processing bank to accept credit and debit card payments, etc.).

The digital asset backing computing entity 20 may be a part of or separate from the digital asset-based interaction computing entity 16. The digital asset backing computing entity 20 stores (or otherwise has access to) system digital assets (e.g., system cryptocurrency, system tokens, etc.) as collateral to back digital asset-based interactions of the digital asset-based interaction system 10. The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency.

The digital asset backing computing entity 20 is associated with the user computing device 12, the bi-directional digital asset POS computing device 14, and/or a type of digital asset. As shown in this example, the digital asset backing computing entity 20 is associated with the asset management unit 22 of the user computing device 12. The digital asset management computing entity 50 is associated with the digital asset backing computing entity 20 via one or more accounts and is operable to deposit system digital assets into the one or more accounts to back digital asset-based interactions of users of an associated asset management unit (e.g., the asset management unit 22). The digital asset management computing entity 50 is incentivized to back asset management unit interactions by receiving rewards from the digital asset backing computing entity 20 such as a percentage of system digital assets back on successful transactions. Additionally, the system digital asset provides payment utility such as lower foreign exchange rates.

The digital asset management computing entity 50 is also referred to as a staking entity and in this example, is associated with a developer of the asset management unit (e.g., a digital wallet developer). Because the digital asset management computing entity 50 is backing the asset management unit interactions and is rewarded by successful transactions, the digital asset management computing entity 50 is incentivized to produce a quality asset management unit that prevents user fraud and to remedy faulty software that affects transaction success.

In another embodiment, the asset management unit 22 may be backed by a different and/or additional type(s) of staking entities such as one or more user computing devices, one or more merchant computing entities, one or more computing entities associated with a corporation and/or business, etc.

The asset management unit 22 and the digital asset POS module 90 include digital asset-based interaction interfaces 25-1 and 25-2 operable to interface with the digital asset-based interaction computing entity 16. The digital asset-based interaction interfaces 25-1 and 25-2 are digital asset-based interaction computing entity application programming interfaces (APIs) integrated into the asset management unit 22 and the digital asset POS module 90 respectively that allow the user computing device 12 and the bi-directional digital asset POS computing device 14 to connect to the digital asset-based interaction computing entity 16 for digital asset-based interactions. The digital asset-based interaction interfaces 25-1 and 25-2 facilitate digital asset-based interaction system 10 interactions and will be discussed in greater detail with reference to one or more of the following Figures.

A digital asset-based interaction interface may be included in an asset management unit 22 when the digital asset management computing entity 50 deposits system digital assets to back interactions made by the asset management unit 22 or in a digital asset POS module 90 that primarily receives assets (e.g., the bi-directional digital asset POS computing device 14) via the digital asset-based interaction system 10.

The user computing device 12 and the bi-directional digital asset POS computing device 14 are operable to establish an account with the digital asset-based interaction computing entity 16 to use the digital asset-based interaction interfaces 25-1 and 25-2. The user computing device 12 and the bi-directional digital asset POS computing device 14 are operable to access features of the digital asset-based interaction computing entity 16 via the digital asset-based interaction interfaces 25-1 and 25-2 (e.g., via a direct link or by signing in for temporary use).

The user computing device 12 and the bi-directional digital asset POS computing device 14 interact via the interface means 18. The interface means 18 is one or more of: a direct link and a network connection. The direct link includes one or more of: a scanning device (e.g., video, camera, infrared (IR), barcode scanner, etc.), direct user input (e.g., via a touchscreen, keypad, etc.), radio frequency (RF), and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

As an example, the user computing device 12 is a smart phone, the bi-directional digital asset POS computing device 14 is a fixed merchant POS device (e.g., a POS register) and the interface means 18 is the fixed merchant POS device's scanning device (e.g., camera, barcode scanner, etc.). As an example, the user computing device 12 is an NFC enabled smart phone or smart watch, the bi-directional digital asset POS computing device 14 is a fixed merchant POS device (e.g., an NFC enabled POS register) and the interface means 18 is NFC. As another example, the user computing device 12 is a smart phone, the bi-directional digital asset POS computing device 14 is a fixed merchant POS device (e.g., a POS register) and the interface means 18 is the smart phone's scanning device (e.g., a front or back camera).

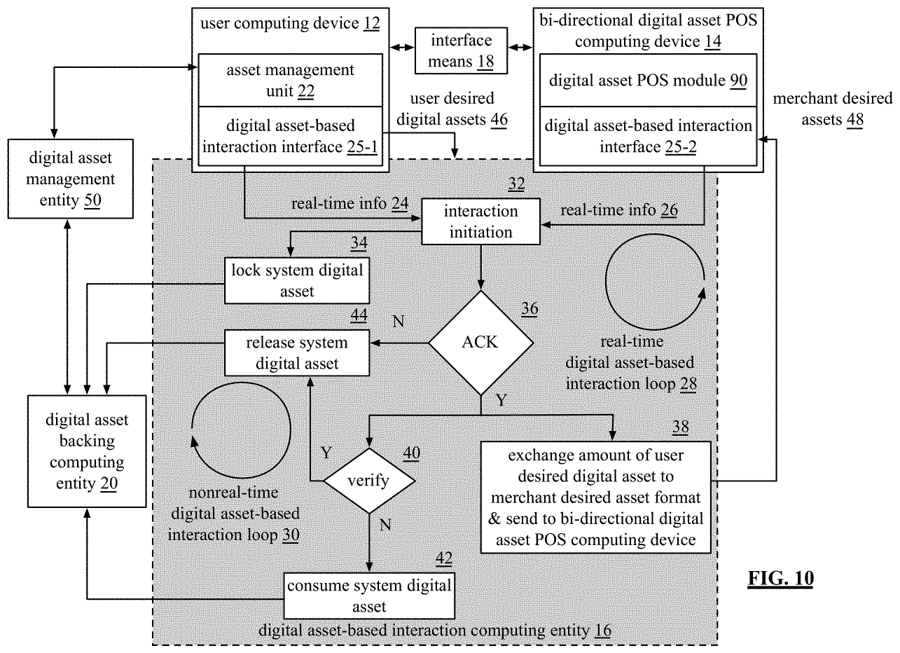

Due to the bi-directional nature of the bi-directional digital asset POS computing device 14, the bi-directional digital asset POS computing device 14 is operable to process a variety of digital asset-based interactions with the user computing device 12. For example, the bi-directional digital asset POS computing device 14 is operable to receive a digital asset-based payment from the user computing device 12 where the user computing device 12 provides digital assets in a user desired asset format (e.g., a particular cryptocurrency) and the bi-directional digital asset POS computing device 14 accepts assets in a merchant desired asset format (e.g., fiat currency). This form of digital asset-based interaction is also referred to herein as a digital asset-based payment. The digital asset-based payment will be discussed in more detail with reference to FIGS. 10-10A.

As another example, the bi-directional digital asset POS computing device 14 is operable to process a cash back feature where the bi-directional digital asset POS computing device 14 receives a digital asset-based payment and an amount increase request from the user computing device 12 where the user computing device 12 provides digital assets in a first user desired asset format (e.g., a particular cryptocurrency) and accepts the amount increase in a second user desired asset format (e.g., a particular cryptocurrency, fiat currency) and the bi-directional digital asset POS computing device 14 accepts assets in a merchant desired asset format (e.g., fiat currency). The digital asset-based payment with an amount increase request will be discussed in more detail with reference to FIGS. 15A-19.

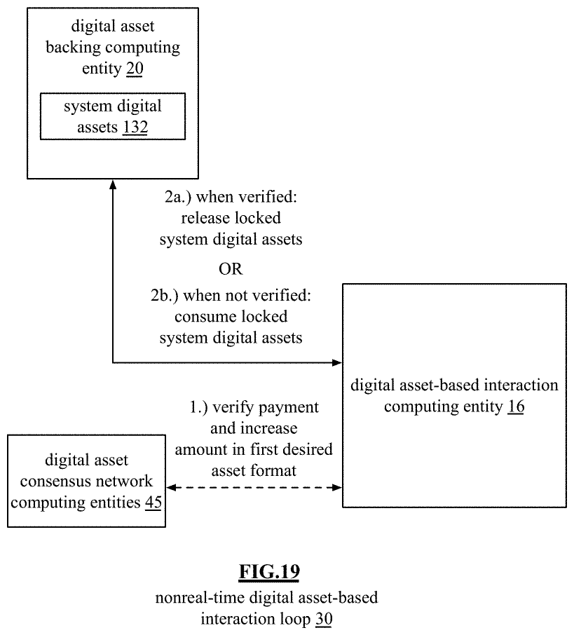

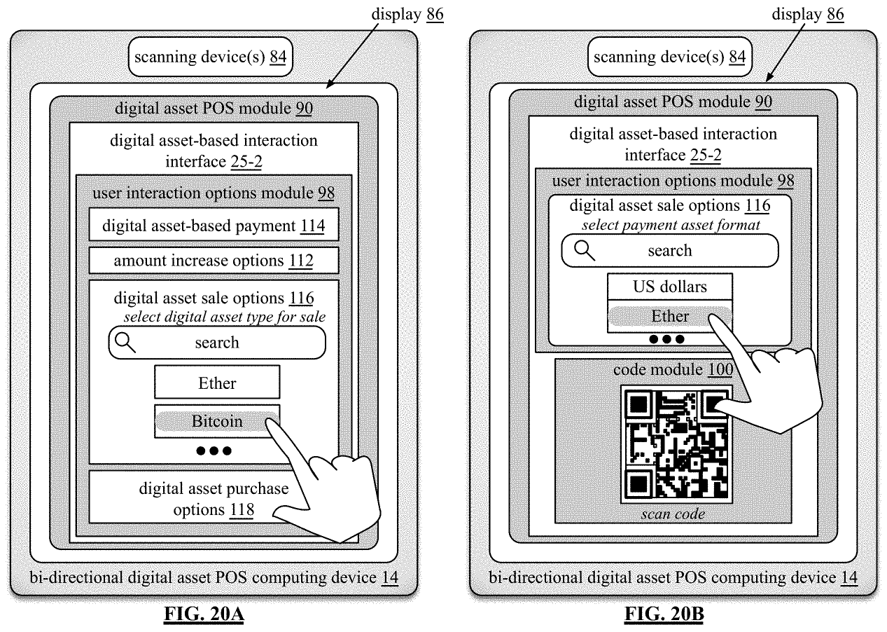

As another example, the bi-directional digital asset POS computing device 14 is operable to process a digital asset sale where the bi-directional digital asset POS computing device 14 receives an amount of digital assets from the user computing device 12 and provides the user computing device 12 with assets in a user desired asset format (e.g., fiat currency, a different digital asset). The digital asset sale will be discussed in more detail with reference to FIGS. 20A-25.

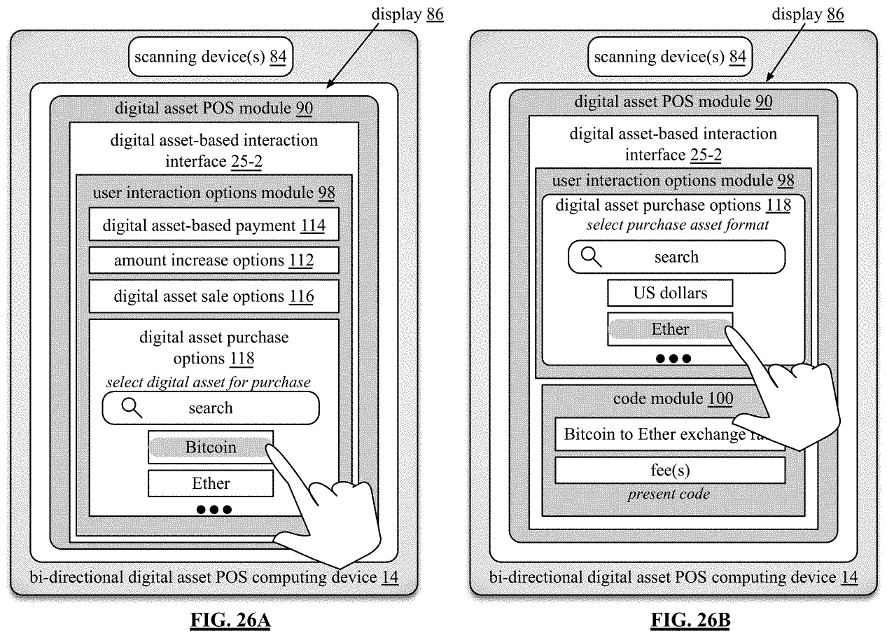

As another example, the bi-directional digital asset POS computing device 14 is operable to process a digital asset purchase where the bi-directional digital asset POS computing device 14 receives an amount of assets in a first asset format (e.g., fiat currency, a digital asset) from the user computing device 12 and provides the user computing device 12 with assets in a second asset format (e.g., fiat currency, a digital asset). The digital asset purchase will be discussed in more detail with reference to FIGS. 26A-32.

By using the bi-directional digital asset POS computing device 14 to process amount increase requests, digital asset sales, and/or digital asset purchases on behalf of a user computing device 12, the user computing device 12 does not need to provide the amount of personal information that it would need to if the user computing device 12 were to connect to a digital asset exchange directly (e.g., establishing an account, providing bank account information, etc.). In exchange for the convenience and privacy, the bi-directional digital asset POS computing device 14 may charge a fee for each interaction where the fee may depend on the type of interaction, the amounts involved, the assets involved, and features of the user computing device 12. Further, by being associated with the digital asset-based computing entity 16, the entity (e.g., the merchant) associated with the bi-directional digital asset POS computing device 14 does not need to possess the licensing required and/or adhere to jurisdictional based regulations involved in exchanging and trading digital assets.

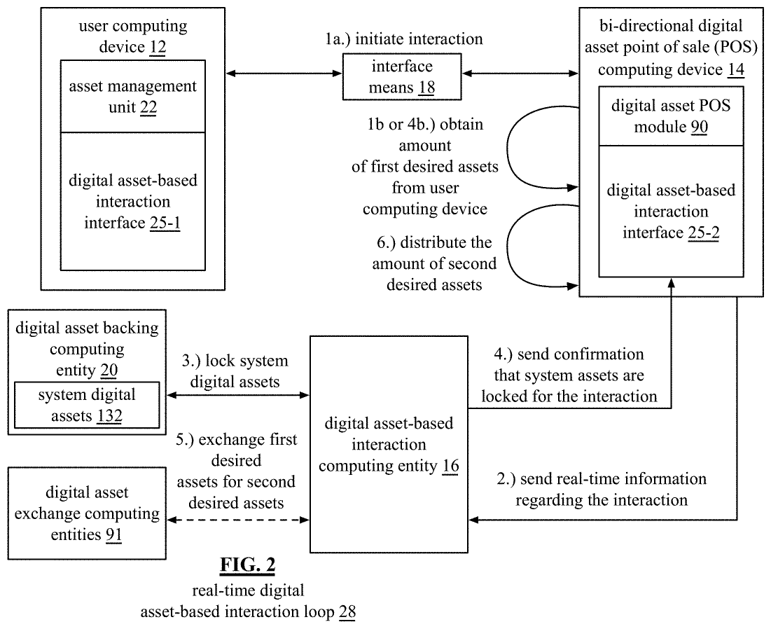

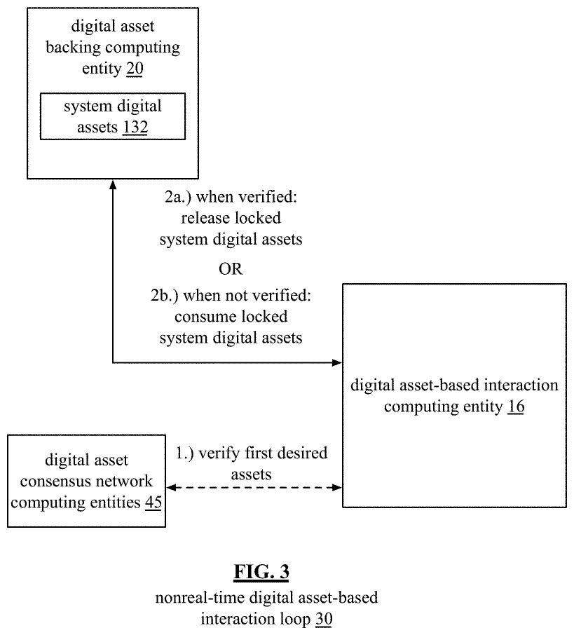

Regardless of the type of digital asset-based interaction, each digital asset-based interaction is processed by the digital asset-based interaction system 10 through the use of two concurrent processes: a real-time digital asset based interaction process (i.e., the real-time digital asset based interaction loop 28) and a nonreal-time digital asset-based interaction process to reconcile the digital asset-based interaction with the digital asset backing computing entity 20 (e.g., the nonreal-time digital asset-based interaction loop 30). The reconciliation of the digital asset-based interaction with the digital asset backing computing entity 20 occurs within a time frame that is longer than the time frame of the real-time digital asset-based interaction process. For example, the reconciliation of the digital asset-based interaction with the digital asset backing computing entity 20 occurs over the course of minutes whereas the time frame of the real-time digital asset-based interaction takes a few seconds. The real-time digital asset based interaction process is discussed in more detail with reference to FIG. 2 and the nonreal-time digital asset-based interaction process is discussed in more detail with reference FIG. 3.

FIG. 2 is a flowchart of an example of a method of a real-time digital asset-based interaction loop of a digital asset-based interaction system. FIG. 2 includes a user computing device 12, a bi-directional digital asset point of sale (POS) computing device 14, a digital asset-based interaction computing entity 16, an interface means 18, a digital asset backing computing entity 20, and the one or more digital asset exchange computing entities 91.

The method begins with steps 1a-1b (which may occur concurrently or in a different order (e.g., step 1b occurs slightly before step 1a)) where at step 1a, a digital asset-based interaction (“interaction”) is initiated between the user computing device 12 and the bi-directional digital asset POS computing device 14 via the interface means 18. An initiation of an interaction means that information pertaining to the interaction is sent to the digital asset-based interaction computing entity. The types of interactions include a digital asset-based payment from the user computing device 12 to the bi-directional digital asset POS computing device 14, a digital asset-based payment with an increase amount request by the user computing device 12, a digital asset sale request by the user computing device 12, and a digital asset purchase request by the user computing device 12.

To begin initiating the interaction, the user computing device 12 may display a unique scannable code to the bi-directional digital asset POS computing device 14 when the interface means 18 is the bi-directional digital asset POS computing device 14. As another example, the bi-directional digital asset POS computing device 14 displays a unique scannable code for the user computing device 12 when the interface means 18 is the user computing device 12 scanning device. Other examples may include sending information from one device to another using NFC or a Bluetooth connection, entering in information using a keypad, etc.

At step 1b, the bi-directional digital asset POS computing device 14 obtains an amount of first desired assets from the user computing device 12 as part of the interaction initiation. The first desired assets may include one or more types of assets (e.g., part fiat currency, part digital asset, etc.). The bi-directional digital asset POS computing device 14 may receive the amount of first desired assets directly from the user computing device 12 (e.g., a user of the user computing device 12 inserts fiat currency into the bi-directional digital asset POS computing device 14) and/or the bi-directional digital asset POS computing device 14 directs the amount of the first desired assets to the digital asset-based interaction computing entity 16. For example, the bi-directional digital asset POS computing device 14 presents a code on a display of the bi-directional digital asset POS computing device 14 where, when the code is scanned by the user computing device, the first desired assets are sent to an address associated with the digital asset-based interaction computing entity 16.

In another example, the bi-directional digital asset POS computing device 14 obtains the amount of first desired assets from the user computing device 12 at step 4b (i.e., at a time prior to the exchange) which may occur concurrently or in a different order than step 4 discussed below (e.g., step 4b occurs slightly before step 4)).

The method continues with step 2, where the bi-directional digital asset POS computing device 14 sends real-time information regarding the interaction to the digital asset-based interaction computing entity 16. The real-time information includes bi-directional digital asset POS computing device real-time information and may also include user computing device real-time information where the bi-directional digital asset POS computing device 14 obtains user computing device real-time information from the user computing device 12 via the interface means 18. In another example, the user computing device 12 sends user computing device real-time information regarding the interaction to the digital asset-based interaction computing entity 16 and the bi-directional digital asset POS computing device 14 sends bi-directional digital asset POS computing device real-time information to the digital asset-based interaction computing entity 16.

The real-time information includes one or more identifiers (e.g., a user ID, a merchant ID, a terminal ID of the bi-directional digital asset POS computing device 14), a type of the digital asset-based interaction, a type of the first desired assets (e.g., one or more user desired fiat currencies, one or more user desired digital assets, one or more merchant desired fiat currencies, and/or one or more merchant desired digital assets), a type of the second desired assets (e.g., one or more user desired fiat currencies, one or more user desired digital assets, one or more merchant desired fiat currencies, and/or one or more merchant desired digital assets), an amount of the first desired assets, and/or an amount of the second desired assets. The real-time information may include further information and/or metadata such as transaction fees, loyalty information, personal information (address, name, etc.), shipping details, bill splitting information, a request for additional information, etc.

The method continues with step 3, where based on the interaction initiation (e.g., receiving the real-time information), the digital asset-based interaction computing entity 16 locks an amount of system digital assets 132 stored by the digital asset backing computing entity 20 to back the interaction. The amount of system digital assets locked may be based on one or more of an amount involved in the interaction, a type of asset involved in the interaction, a type of the interaction, a type of item involved in the interaction, the user computing device 12 (e.g., a typical amount the user computing device 12 spends, an account balance, trading behavior of the user computing device, etc.), and the bi-directional digital asset POS computing device 14 (e.g., the type of merchant the bi-directional digital asset POS computing device 14 is associated with, a type of goods the merchant sells, a default amount set by the merchant, etc.).

When the digital asset-based interaction computing entity 16 locks the system digital asset, a rate quote for the first desired assets to second desired assets exchange may also be locked. The digital asset-based interaction computing entity 16 connects to or maintains a connection to the one or more digital asset exchange computing entities 91 to obtain the rate quote and is operable to adjust the rate quotes according to an asset's availability on the exchange. The digital asset-based interaction computing entity 16 may lock the rate quote based on a tolerance window acceptable to the user of the user computing device 12. For example, the rate quote may be higher than a current rate quote if a longer window of time is provided to the user computing device to receive funds is longer. As another example, once a user authorizes a digital asset-based interaction, the first desired assets may be exchanged by the digital asset-based interaction computing entity 16 (via the one or more digital asset exchange computing entities 91) on credit (even if it has not been received yet) with the exchange to ensure a particular rate quote. Once the amount of the first desired assets is received from the user computing device 12, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the digital asset-based payment) for a substantially equivalent amount of assets in a second desired asset format. When the amount of first desired assets are received by the digital asset-based interaction computing entity 16, the digital asset-based interaction computing entity 16 is operable to exchange (via the one or more digital asset exchange computing entities 91) the amount of the first desired assets to the substantially equivalent amount of the smart contract compatible token used to cover the real-time digital asset exchange.

The method continues with step 4 and step 4b (when applicable). At step 4, the bi-directional digital asset POS computing device 14 receives a confirmation from the digital asset-based interaction computing entity 16 that the amount of system digital assets have been locked to back the interaction.

If the interaction is terminated (e.g., digital asset-based interaction initiation fails and/or is cancelled by the user computing device 12 and/or the bi-directional digital asset POS computing device 14) prior to step 5, the interaction is terminated and the digital asset-based interaction computing entity 16 instructs the digital asset backing computing entity 20 to release the amount of locked system digital asset. If the first desired assets have been obtained prior to the termination, the transaction can be cancelled and/or the user computing device can be refunded (e.g., in the situation where the user computing device deposits fiat currency into the bi-directional digital asset POS computing device 14).

The method continues at step 5 where the digital asset-based interaction computing entity 16 connects to the one or more exchanging computing entities 91 of the digital asset-based interaction system to exchange the amount of the first desired assets to an amount of second desired assets where the amount of second desired assets is substantially equivalent to the amount of the first desired assets. The digital asset exchange occurs quickly (e.g., 30 seconds to a few minutes) to account for exchange rate volatility and so that the bi-directional digital asset POS computing device 14 can provide and/or obtain desired assets in real-time. When the bi-directional digital asset POS computing device 14 is operable to obtain fiat currency directly from the user computing device 12 as the first desired asset, the bi-directional digital asset POS computing device 14 maintains an account with the digital asset-based interaction computing entity 16 such that the digital asset-based interaction computing entity 16 can access funds from the bi-directional digital asset POS computing device 14 account for the exchange. The merchant associated with bi-directional digital asset POS computing device 14 would then balance the accounting with the bi-directional digital asset POS computing device 14's account and the fiat currency received and stored within the with bi-directional digital asset POS computing device 14.

The method continues with step 6 where the bi-directional digital asset POS computing device 14 distributes the amount of the second desired assets in accordance with the interaction. The second desired assets may include one or more types of assets (e.g., part fiat currency, part digital asset, etc.). The bi-directional digital asset POS computing device 14 is operable to distribute the amount of the second desired assets by one or more of: utilizing the amount of the second desired assets as a payment from the user computing device 12 and sending at least a portion of the amount of the second desired assets to a location associated with the user computing device 12.

As an example of utilizing the amount of the second desired assets as a payment from the user computing device 12, the digital asset-based interaction computing entity 16 provides the amount of the second desired assets to the bi-directional digital asset POS computing device 14 by sending the second desired assets to an address associated with a merchant associated with the bi-directional digital asset POS computing device 14 and/or to a merchant banking device associated with the bi-directional digital asset POS computing device 14.

As an example of sending at least a portion of the amount of the second desired assets to a location associated with the user computing device 12, the bi-directional digital asset POS computing device 14 obtains an address associated with the user computing device, where the digital asset-based computing entity 16 is operable to transfer the at least the portion of the second desired assets to the address. The address may be an address of the asset management unit 22 of the user computing device 12, an address of a different computing device of the user of the user computing device 12, and/or an address associated with a friend, family member, business associate, client, etc., of a user of the user computing device 12.

As another example of sending at least a portion of the amount of the second desired assets to a location associated with the user computing device 12, the bi-directional digital asset POS computing device 14 dispenses fiat currency to a user of the user computing device 12. In that example, the digital asset-based interaction computing entity 16 sends a fiat currency payment to the bi-directional digital asset POS computing device 14 (e.g., to a digital asset-based interaction computing entity account associated with the bi-directional digital asset POS computing device 14) and a confirmation to the bi-directional digital asset POS computing device 14 that the fiat currency payment was deposited. Upon receiving the confirmation, the bi-directional digital asset POS computing device 14 outputs stored fiat currency to the user computing device. The merchant associated with the bi-directional digital asset POS computing device 14 would then balance the accounting with the bi-directional digital asset POS computing device 14's account and the fiat currency sent and stored with the bi-directional digital asset POS computing device 14.

FIG. 3 is a flowchart of an example of a method of a nonreal-time digital asset-based interaction loop 30 of a digital asset-based interaction system. FIG. 3 includes a digital asset-based interaction computing entity 16, a digital asset backing computing entity 20, and one or more digital asset consensus network computing entities 45. The nonreal-time digital asset-based interaction loop 30 (e.g., reconciliation of the digital asset-based interaction with the digital asset backing computing entity 20) occurs simultaneously with the real-time digital asset-based interaction loop 28 of FIG. 2, however; the nonreal-time digital asset-based interaction loop 30 occurs within a time frame that is longer than the time frame of the real-time digital asset-based interaction loop. For example, reconciliation of the digital asset-based interaction with the digital asset backing computing entity 20 occurs over the course of minutes whereas the time frame of the real-time digital asset-based interaction loop takes a few seconds.

The method begins at step 1, where when the amount of first desired assets are obtained, the digital asset-based interaction computing entity 16 connects to the one or more digital asset consensus network computing entities 45 to verify the amount of the first desired assets received from the user computing device 12. The one or more digital asset consensus network computing entities 45 implement a verification process that may take minutes to hours of time.

For example, when the first desired asset is a cryptocurrency hosted on a blockchain, the digital asset-based interaction computing entity 16 connects to the blockchain associated with the cryptocurrency to verify whether a certain amount of blocks including transaction of sending the amount of the first desired assets from the user computing device 12 have been added to the blockchain (e.g., a certain amount of confirmations are obtained).

As a specific example, in the Bitcoin blockchain, miners record new transactions into blocks that verify all previous transactions within the blockchain. At the filing of this application, it takes a miner ten minutes, on average, to write a block on the Bitcoin blockchain. The average block time depends on a total hash power of the Bitcoin network. Once a block is created and a new transaction is verified and included in a block, the transaction will have one confirmation. Each subsequent block (which verifies the previous state of the blockchain) provides one additional network confirmation.

Typically, between 5-10 transaction confirmations (depending on the monetary value of the transaction) are acceptable for cryptocurrency exchanges to avoid losses due to potential fraud. Therefore, if the first computing entity 12 is using Bitcoin, the digital asset-based interaction computing entity 16 seeks a desired number of confirmations of the amount of the cryptocurrency received by the first computing entity 12 from the consensus network 16 (e.g., via Bitcoin miners). The transaction may not be verified by the digital asset-based interaction computing entity 16 for an hour or more. As such, the nonreal-time digital asset-based interaction loop 30 takes longer than the real-time digital asset-based interaction loop 28.

Other asset verification processes are possible and are based on the type of asset involved. When the first desired asset is a fiat currency obtained by the bi-directional digital asset POS computing device 14 directly from the user computing device 12, the digital asset-based interaction computing entity 16 accesses funds from an account associated with the bi-directional digital asset POS computing device 14 for the exchange. If the funds are stored by the digital asset-based interaction computing entity 16, the verification process may not be necessary. However, when the funds are not stored by the digital asset-based interaction computing entity 16, the digital asset-based interaction computing entity 16 may need to perform a verification process on the received assets (e.g., when the account associated with the bi-directional digital asset POS computing device 14 stores digital assets for a digital asset to fiat exchange).

The method continues with steps 2a or 2b. At step 2a, when the amount of the first desired assets are verified (or received via a method that does not involve the verification process), the digital asset-based interaction computing entity 16 instructs the digital asset backing computing entity 20 to unlock the locked amount of system digital assets.

At step 2b, when the amount of the first desired assets are not verified (or not received via a method that does not involve the verification process), the digital asset-based interaction computing entity 16 instructs the digital asset backing computing entity 20 to consume the locked amount of system digital assets. For example, if fraudulent activity occurs (e.g., the user computing device 12 acts maliciously to spend at two merchants simultaneously, software of the asset management unit 22 is corrupted, etc.) the digital asset-based interaction computing entity 16 consumes the amount of system digital asset associated with the real-time digital asset interaction. As a specific example, if the user computing device 12 attempts to double spend a transaction, the verification (e.g., the desired number of confirmations in a Bitcoin blockchain example) will not be received and the digital asset-based interaction computing entity 16 will not be able to verify the amount of the first desired assets received by the user computing device 12.

Consuming the amount of system digital asset means that the digital asset backing computing entity 20 transfers the amount of system digital assets to an address controlled by the digital asset-based interaction computing entity 16 in order to cover the amount of the digital asset-based interaction.

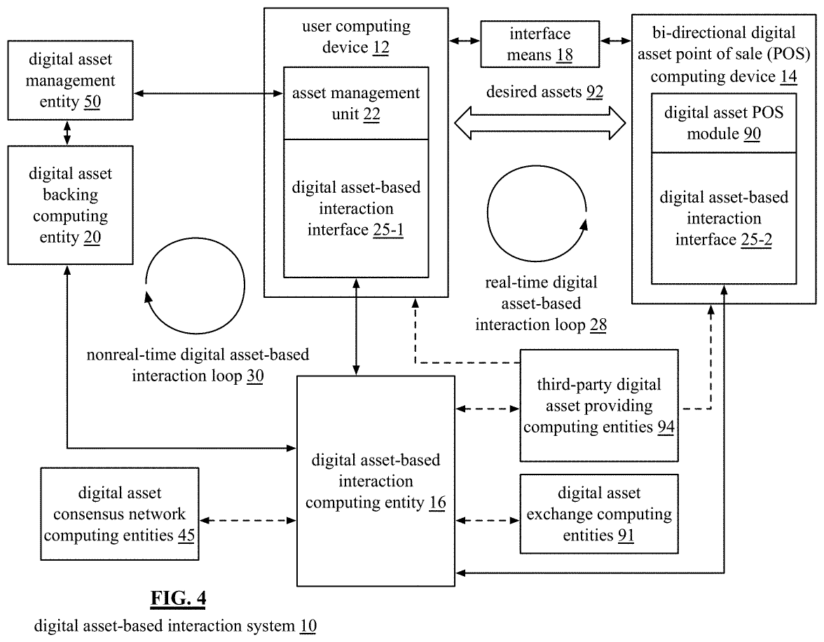

FIG. 4 is a schematic block diagram of another embodiment of the digital asset-based interaction system 10 that includes a user computing device 12, a bi-directional point of sale (POS) computing device 14, a digital asset-based interaction computing entity 16, an interface means 18, a digital asset backing computing entity 20, a digital asset management computing entity 50, one or more digital asset exchange computing entities 91, one or more digital asset consensus network computing entities 45, and one or more third party digital asset providing computing entities 94.

The digital asset-based interaction system 10 of FIG. 4 operates similarly to the digital asset-based interaction system 10 of FIGS. 1-3 except for the addition of the third party digital asset providing computing entities 94. The third party digital asset providing computing entities 94 may be one or more computing devices, one or more distributed computing devices, and/or one or more modules executing on one or more computing devices. The third party digital asset providing computing entities 94 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The third party digital asset providing computing entities 94 are third party liquidity providers associated with the digital asset-based interaction computing entity 16. Liquidity providers include one or more of a digital asset exchange computing entity, a broker dealer computing entity, a banking computing entity, a digital asset custodial company computing entity, a digital wallet, and a smart contract. For example, the third party digital asset providing computing entities 94 are the one or more digital asset exchange computing entities 91. In another embodiment, the third party digital asset providing computing entities 94 includes the digital asset management entity 50.

The digital asset-based interaction computing entity 16 is operable to send instructions to the one or more third party digital asset providing computing entities 94 regarding sending and/or receiving digital assets to/from the one or more of the user computing device 12 and the bi-directional digital asset POS computing device 14. For example, the third party digital asset providing computing entities 94 includes a digital asset custodial company computing entity associated with the digital asset-based interaction computing entity 16 (e.g., the digital asset-based interaction computing entity 16 has an account with the digital asset custodial company computing entity). To send digital assets to the one or more of the user computing device 12 and the bi-directional digital asset POS computing device 14, the digital asset-based interaction computing entity 16 instructs the digital asset custodial company computing entity to send digital assets to an address associated with a particular computing device of the digital asset-based interaction system.

In another embodiment, the one or more of the user computing device 12 and the bi-directional digital asset POS computing device 14 may directly communicate with the one or more third party digital asset providing computing entities 94 to obtain and/or send digital assets within the digital asset-based interaction system.

FIG. 4A is a schematic block diagram of an embodiment of a portion of a digital asset-based interaction system 10 that includes a user computing device 12, a bi-directional point of sale (POS) computing device 14, a digital asset-based interaction computing entity 16, an interface means 18, one or more digital asset exchange computing entities 91, and one or more third party digital asset providing computing entities 94.

The digital asset-based interaction system 10 of FIG. 4A operates similarly to the digital asset-based interaction system 10 of FIGS. 1-4 and shows an example of the digital asset-based interaction computing entity 16 communicating with the one or more digital asset exchange computing entities 91 and the one or more third party digital asset providing computing entities 94 to execute a digital asset-based interaction between the user computing device 12 and the bi-directional POS computing device 14.

The third party digital asset providing computing entities 94 are third party liquidity providers associated with the digital asset-based interaction computing entity 16. Liquidity providers include one or more of a digital asset exchange computing entity, a broker dealer computing entity, a banking computing entity, a digital asset custodial company computing entity, a digital wallet, and a smart contract. For example, the third party digital asset providing computing entities 94 are the one or more digital asset exchange computing entities 91.

The digital asset-based interaction computing entity 16 is operable to send instructions to the one or more third party digital asset providing computing entities 94 regarding sending and/or receiving digital assets to/from the one or more of the user computing device 12 and the bi-directional digital asset POS computing device 14. For example, the third party digital asset providing computing entities 94 includes a digital asset custodial company computing entity associated with the digital asset-based interaction computing entity 16 (e.g., the digital asset-based interaction computing entity 16 has an account with the digital asset custodial company computing entity). To send digital assets to the one or more of the user computing device 12 and the bi-directional digital asset POS computing device 14, the digital asset-based interaction computing entity 16 instructs the digital asset custodial company computing entity to send digital assets (and how much) to an address or an account associated with a particular computing device of the digital asset-based interaction system.

When the third party digital asset providing computing entities 94 are not digital asset exchange computing entities, the digital asset-based interaction computing entity 16 sends instructions to exchange assets to the one or more digital asset exchange entities 91 in accordance one or more digital asset-based interactions. The instructions to exchange assets may also include instructions to send digital assets to the third party digital asset providing computing entities 94 or the digital asset-based interaction computing entity 16 where the third party digital asset providing computing entities 94 or the digital asset-based interaction computing entity 16 is operable to send the digital assets to one or more of the user computing device 12 and the bi-directional digital asset POS computing device 14.

In another example, the instructions to exchange assets may also include instructions to send digital assets (and how much) to an address or an account associated with one or more of the user computing device 12 and the bi-directional digital asset POS computing device 14. In another embodiment, the one or more of the user computing device 12 and the bi-directional digital asset POS computing device 14 may directly communicate with the one or more third party digital asset providing computing entities 94 to obtain and/or send assets within the digital asset-based interaction system.

FIG. 5 is a schematic block diagram of an embodiment of a user computing device 12 of a digital asset-based interaction system. The user computing device 12 includes an asset management unit 22, a display 66, a front scanning device 62 (e.g., a front camera), and a back scanning device 64 (e.g., a back camera). A scanning device may be a video device, a camera, an infrared (IR) device, a barcode scanner, etc. The user computing device 12 may have more or less scanning devices than shown. Further, the scanning devices may be located in different positions on the user computing device 12 than what is shown. The display 66 may be a liquid crystal display (LCD), a light emitting diode (LED), and/or other type of display technology. The display 66 may include touchscreen functionality implemented by 5-wire resistive, thin film transistor (TFT), in-place switching (IPS), surface capacitive, surface acoustic wave (SAW), infrared, and/or any other type of touch sense and/or touchscreen technology.

The asset management unit 22 includes an asset depository and/or acceptance unit 58, a digital asset-based interaction interface 25, and a scanning interface 60. In this example, the asset depository and/or acceptance unit 58 is a digital wallet that stores and/or shows a representation of stored digital assets (e.g., when the digital assets are custodied by a digital asset management entity associated with the asset management unit 22). Here, the asset depository and/or acceptance unit 58 stores cryptocurrency A 66, cryptocurrency B 68, and token X 70. The asset depository and/or acceptance unit 58 could store more or less digital assets and may include additional features for digital asset management. For example, the asset depository and/or acceptance unit 58 may include functions and/or features for trading, exchange, deposit, withdrawal, market information, digital asset news, etc. In another example, the asset depository and/or acceptance unit 58 is an interface for depositing digital assets to a network enabled smart contract.

The scanning interface 60 is coupled to one or more of the front and/or back scanning devices 62-64 and includes image capturing, image display, image processing, and/or encoding/decoding circuitry operable to capture, display, and/or analyze optically scanned, saved (e.g., a screenshot of a code, a code stored in a memory) or otherwise detected image data such as graphical coded representations of data (e.g., barcodes).

The digital asset-based interaction interface 25-1 interfaces with the digital asset-based interaction computing entity to facilitate digital asset-based interactions. The digital asset-based interaction interface 25-1 may be included in the asset depository and/or acceptance unit 58 as shown. For example, the asset depository and/or acceptance unit 58 is a digital wallet and a “pay” icon and/or button within the digital wallet asset depository and/or acceptance unit 58 links to the digital asset-based interaction interface 25-1. The digital asset-based interaction interface 25-1 may automatically open when the “pay” icon is selected (e.g., when the asset management unit 22 maintains an active link to the digital asset-based interaction computing entity 16) or the user of the user computing device 12 may be prompted to sign into the digital asset-based interaction system (e.g., when the asset management unit 22 does not maintain an active link to the digital asset-based interaction computing entity 16).

As an alternative example, the digital asset-based interaction interface 25-1 may be included in the scanning interface 60 such that when a scan function is initiated by the scanning interface 60, the digital asset-based interaction interface 25 is accessed. A scan function may be initiated by selecting a scan icon or automatically when certain scannable codes are detected, and an automatic scan to interact function is enabled. The digital asset-based interaction interface 25-1 may automatically open when the scan function is initiated (e.g., when the asset management unit 22 maintains an active link to the digital asset-based interaction computing entity 16) or the user of the user computing device 12 may be prompted to sign into the digital asset-based interaction system (e.g., when the asset management unit 22 does not maintain an active link to the digital asset-based interaction computing entity 16).

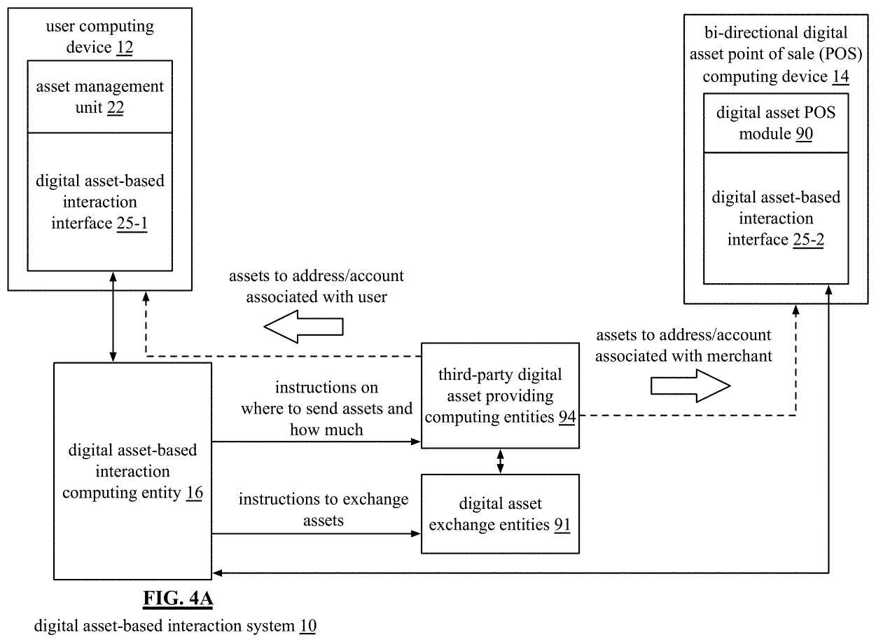

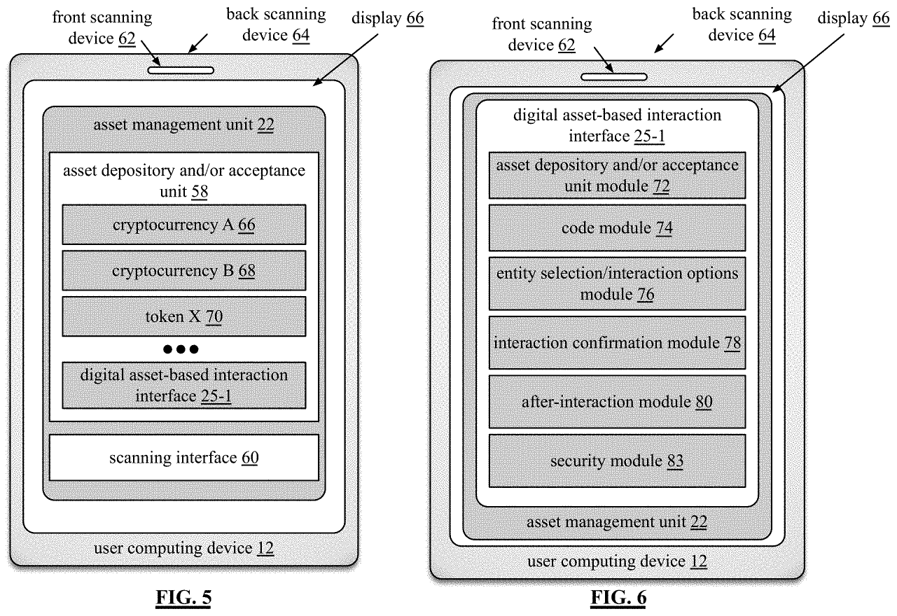

FIG. 6 is a schematic block diagram of an embodiment of a user computing device 12 of a digital asset-based interaction system that includes an asset management unit 22, a display 66, a front scanning device 62 (e.g., a front camera), and a back scanning device 64 (e.g., a back camera). FIG. 6 operates similarly to FIG. 5 and shows the digital asset-based interaction interface 25-1 of the asset management unit 22 (e.g., accessed via the asset depository and/or acceptance unit 58 or the scanning interface 60) in more detail.

FIG. 6 depicts modules of the digital asset-based interaction interface 25-1 that include an asset depository and/or acceptance unit module 72, a code module 74, an entity selection/interaction options module 76, an interaction confirmation module 78, an after-interaction module 80, and a security module 83. More or less modules are possible. For example, the entity selection/interaction options module 76 may not be necessary when the entity (e.g., merchant) selection functionality is included in other features and/or components. The asset depository and/or acceptance unit module 72 is coupled to the asset depository and/or acceptance unit of the asset management unit 22.

When the asset depository and/or acceptance unit is a digital wallet, the asset depository and/or acceptance unit module 72 displays balance information of the digital assets in the digital wallet (or a default digital asset selected for use in digital asset-based interaction system interactions) and is operable to communicate with the digital wallet to adjust digital assets (e.g., withdrawal, deposit, etc.) based on digital asset-based interaction system interactions. The balance information is based on rate quotes determined by a digital asset exchange used by the digital asset-based interaction computing entity at a point in time (e.g., a current exchange rate, an average exchange rate for a time period, etc.). The digital asset-based interaction computing entity is operable to exchange a variety of digital assets (e.g., fiat currency, cryptocurrency, etc.) and to facilitate exchange across jurisdictions (e.g., for foreign currency exchange). The balance information is updated as exchange rates fluctuate and/or based on a predetermined time (e.g., every 30 minutes, once a day, every time a user of the computing entity 12 or 14 opens digital asset-based interaction interface 25, etc.). The balance information may be shown in terms of US dollars or in any other desired digital asset.

The code module 74 is coupled to the scanning interface 60, the front scanning device 62, and/or the back scanning devices 64 of the user computing device 12 and includes software for detecting and analyzing scannable codes captured by the front and/or back scanning devices 62-64. The code module 74 is operable to receive codes (e.g., from the digital asset-based interaction computing entity), scan scannable codes (e.g., capture via the front and/or back optical scanner 62-64, digitize, and bring into a frame of reference), display scannable codes on the display 66, interpret codes to determine interaction information, and display the interaction information interpreted from the codes. The code module 74 may be a function of the scanning interface 60 that is tailored for scanning and interpreting scannable codes associated with digital asset-based interaction system interactions.

The entity selection/interaction options module 76 is operable to connect to the digital asset-based interaction computing entity and/or a database associated with the digital asset-based interaction computing entity to receive digital asset-based interaction system entity data (e.g., a list of merchants and/or users associated with the digital asset-based interaction system). The entity selection/interaction options module 76 may display a list of merchants and/or users that are associated with the digital asset-based interaction system for selection by the computing entity 12 or 14. The entity selection/interaction options module 76 includes a search function to allow a user to search for a desired merchant and/or user. The displayed list of merchants and/or users may be based on location (e.g., nearby users and/or merchants are listed), category (e.g., restaurant merchants are listed), interaction data (e.g., users associated with a requested interaction are displayed), relationship (e.g., users that have been previously connected to and/or are authorized for contact), and/or availability (e.g., according to merchant hours of operation).

The entity selection/interaction options module 76 is also operable to present interaction options related to a selected entity. For example, the merchant may be associated with a bi-directional digital asset POS computing device that provides a cash back feature, a digital asset sale feature, and/or a digital asset purchase feature. The options related to those features may be displayed in the entity selection/interaction options module 76 upon merchant selection.

The interaction confirmation module 78 includes options for confirming an interaction and adding additional information (e.g., shipping information, bill splitting options, etc.) prior to confirming an interaction. The after-interaction module 80 includes after-interaction options that can be selected after an interaction is authorized and/or confirmed. For example, the after-interaction module 80 includes functions for an interaction adjustment (e.g., change wallets, change digital asset, etc.), adding additional information (e.g., a shipping address), bill splitting, and adding tip.

The security module 83 includes security mechanisms for authenticating the user and/or user activity of the user computing device 12 for a digital asset-based interaction. For example, the security module 83 uses facial recognition technology to perform a facial scan prior to initiating an interaction. As another example, the security module 83 stores and/or verifies usernames, passcodes, and/or keys related to authorization of digital asset-based interactions by the user computing device 12.

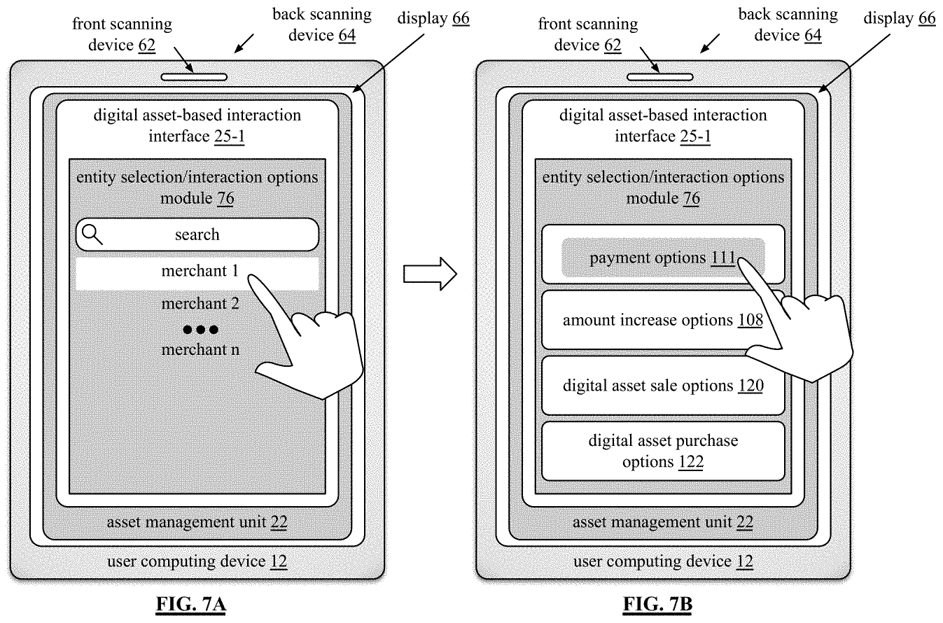

FIGS. 7A-7B are schematic block diagrams of an embodiment of a user computing device 12 of a digital asset-based interaction system that includes an asset management unit 22, a display 66, a front scanning device 62 (e.g., a front camera), and a back scanning device 64 (e.g., a back camera). In FIG. 7A, the entity selection/interaction options module 76 of the digital asset-based interaction interface 25-1 is shown and is featuring a list of merchants. In this example, the entity selection/interaction options module 76 includes a search function to allow a user to search for a desired merchant and/or user (or other entity). The displayed list of merchants and/or users may be based on location (e.g., nearby users and/or merchants are listed), category (e.g., restaurant merchants are listed), interaction data (e.g., users associated with a requested interaction are displayed), relationship (e.g., users that have been previously connected to and/or are authorized for contact), and/or availability (e.g., according to merchant hours of operation).

Here, the user of the user computing device 12 has selected a merchant 1 which is associated with a particular bi-directional digital asset POS computing device. In FIG. 7B, selecting the merchant 1 has presented interaction options available with that particular bi-directional digital asset POS computing device in the entity selection/interaction options module 76. For example, the entity selection/interaction options module 76 presents a selection menu including payment options 111, amount increase options 108, digital asset sale options 120, and digital asset purchase options 122. As an example, the user has selected to view the payment options 111. In an alternative example, selecting the merchant 1 may automatically bring up a particular set of options based on the capabilities of the bi-directional digital asset POS computing device and/or a default setting of one or more of the user computing device 12 and the bi-directional digital asset POS computing device. The various interaction options will be discussed in greater detail with reference to one or more of the following Figures.

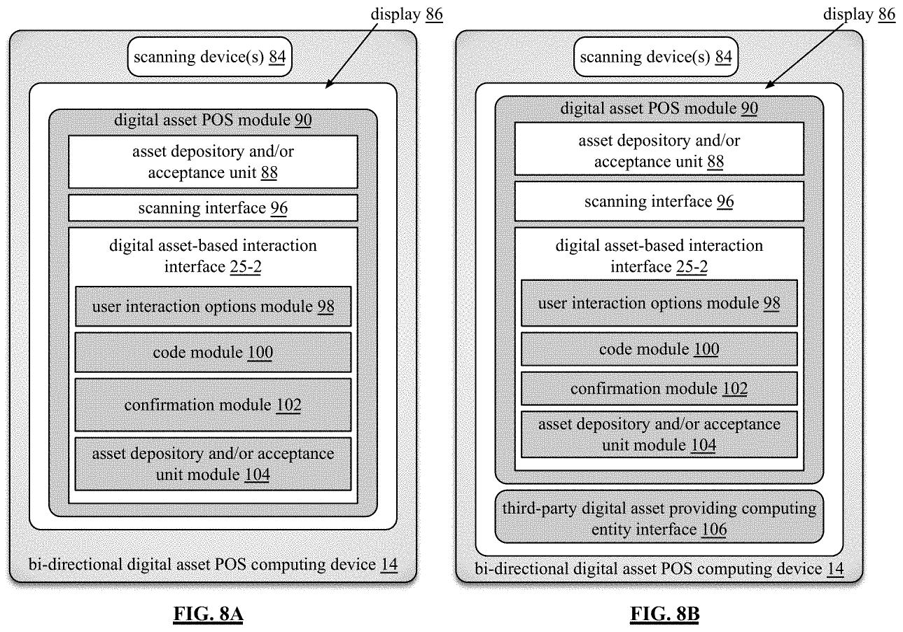

FIGS. 8A-8B are schematic block diagrams of an embodiment of a bi-directional digital asset point of sale (POS) computing device 14 of a digital asset-based interaction system. The bi-directional digital asset POS computing device 14 of FIG. 8A includes a digital asset point of sale (POS) module 90, a display 86, and one or more scanning devices 84. A scanning device of the one or more scanning devices 86 may be a video device, a camera, an infrared (IR) device, a barcode scanner, etc. The one or more scanning devices 84 may be located in different positions on the bi-directional digital asset POS computing device 14 than what is shown. The display 86 may be a liquid crystal display (LCD), a light emitting diode (LED), and/or other type of display technology. The display 86 may include touchscreen functionality implemented by 5-wire resistive, thin film transistor (TFT), in-place switching (IPS), surface capacitive, surface acoustic wave (SAW), infrared, and/or any other type of touch sense and/or touchscreen technology.

The digital asset POS module 90 includes an asset depository and/or acceptance unit 88, a scanning interface 96, and a digital asset-based interaction interface 25-2. The asset depository and/or acceptance unit 88 may be a digital wallet application that stores and/or shows a representation of stored digital assets (e.g., when the digital assets are custodied by a digital asset management entity). For example, the asset depository and/or acceptance unit 88 may include functions and/or features for trading, exchange, deposit, withdrawal, market information, digital asset news, etc. In another example, the asset depository and/or acceptance unit 88 is an interface for depositing digital assets to a network enabled smart contract.

In another example, the asset depository and/or acceptance unit 88 is POS hardware and/or software that facilitates receiving assets from other computing entities and may or may not store and/or manage digital assets. In another example, the asset depository and/or acceptance unit 88 includes and/or interfaces with a safe, a dispenser and/or acceptor of fiat currency, a drawer, and/or any appropriate receptacle for storing, receiving, and/or dispensing fiat currency. The asset depository and/or acceptance unit 88 may include a variety of existing payment processing features for processing payments within existing payment networks.

The scanning interface 96 is coupled to one or more of the scanning devices 84 and includes image capturing, image display, image processing, and/or encoding/decoding circuitry operable to capture, display, and/or analyze optically scanned, saved (e.g., a screenshot of a code, a code stored in a memory) or otherwise detected image data such as graphical coded representations of data (e.g., barcodes).

The digital asset-based interaction interface 25-2 interfaces with the digital asset-based interaction computing entity to facilitate digital asset-based interactions and includes a user interaction options module 98, a code module 100, a confirmation module 102, and an asset depository and/or acceptance module 104.

The user interaction options module 98 is operable to display various interaction options to a user and includes appropriate user interface features for obtaining user inputs regarding interaction options such as a keypad, a card reader (e.g., a magnetic card reader), NFC, Bluetooth, a wireless and/or wired connection, software for interpreting touchscreen inputs of the display 86, the one or more scanning devices 84, a printer, and any other means for interacting with a user and/or a user computing device.

The asset depository and/or acceptance unit module 104 is coupled to the asset depository and/or acceptance unit 88 of the digital asset POS module 90. When the asset depository and/or acceptance unit is a digital wallet, the asset depository and/or acceptance unit module 88, may display balance/digital asset availability information of digital assets in the digital wallet and is operable to communicate with the digital wallet to adjust digital assets (e.g., withdrawal, deposit, etc.) based on digital asset-based interaction system interactions. The balance information is based on rate quotes determined by a digital asset exchange used by the digital asset-based interaction computing entity at a point in time (e.g., a current exchange rate, an average exchange rate for a time period, etc.). The digital asset-based interaction computing entity is operable to exchange a variety of digital assets (e.g., fiat currency, cryptocurrency, etc.) and to facilitate exchange across jurisdictions (e.g., for foreign currency exchange). The balance information is updated as exchange rates fluctuate and/or based on a predetermined time (e.g., every 30 minutes, once a day, etc.). The balance information may be shown in terms of US dollars or in any other desired digital asset.

The code module 100 is coupled to the scanning interface 96 and/or the one or more scanning devices 84 and includes software for detecting and analyzing scannable codes captured by the one or more scanning devices 84. The code module 100 is operable to receive codes (e.g., from the digital asset-based interaction computing entity, via a keypad and/or touchscreen from a user, etc.), scan scannable codes (e.g., capture via the one or more scanning devices 84, digitize, and bring into a frame of reference), display scannable codes on the display 86, interpret codes to determine interaction information, and display the interaction information interpreted from the codes. The code module 100 may be a function of the scanning interface 96 that is tailored for scanning and interpreting scannable codes associated with digital asset-based interaction system interactions.

The confirmation module 102 receives and sends confirmations (i.e., acknowledgments) from and to the digital asset-based interaction computing entity regarding the status of various steps in a digital asset-based interaction. For example, when an amount of system digital assets are locked for a digital asset-based interaction, the digital asset-based interaction computing entity sends the bi-directional digital asset POS computing device 14 a confirmation via the confirmation module 102. As another example, when the digital asset-based interaction computing entity receives digital assets for a particular digital asset-based interaction, the digital asset-based interaction computing entity may send the bi-directional digital asset POS computing device 14 a confirmation via the confirmation module 102. As another example, when the bi-directional digital asset POS computing device 14 distributes assets for a particular digital asset-based interaction, the bi-directional digital asset POS computing device 14 may send the digital asset-based interaction computing entity a confirmation via the confirmation module 102.

The bi-directional digital asset POS computing device 14 of FIG. 8B operates similarly to the bi-directional digital asset POS computing device 14 of FIG. 8A except for the addition of the third party digital asset providing computing entity interface 106. The third party digital asset providing computing entity interface 106 is an application associated with a third party digital asset providing computing entity and allows for the bi-directional digital asset POS computing device 14 to communicate with the third party digital asset providing computing entity. In another example, the third party digital asset providing computing entity is incorporated into the digital asset POS module 90 (e.g., via one or more of the asset depository and/or acceptance unit 88 and/or the digital asset-based interaction interface 25-2). In another embodiment, the user computing device 12 may also include a third party digital asset providing computing entity interface for interacting directly with a third party digital asset providing computing entity. Examples of interactions involving one or more third party digital asset providing computing entities are discussed in more detail with reference to FIGS. 4 and 4A.

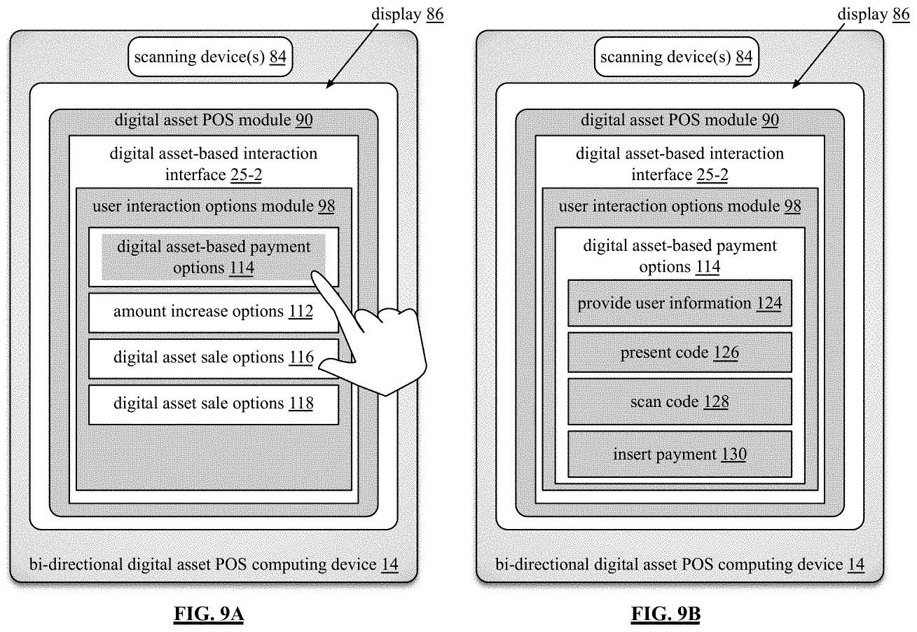

FIGS. 9A-9B are schematic block diagrams of an embodiment of a bi-directional digital asset point of sale (POS) computing device 14 of a digital asset-based interaction system that includes a digital asset POS module 90, one or more scanning devices 84, and a display 86. The bi-directional digital asset POS computing device 14 of FIGS. 9A-9B operates similarly to the bi-directional digital asset POS computing device 14 of FIGS. 8A-8B except that only a user interaction options module 98 of a digital asset-based interaction interface 25-2 of the digital asset POS module 90 is shown and it is shown in more detail.

In FIG. 9A, the user interaction options module 98 is displaying various interaction options to a user. The interaction options include digital asset-based payment options 114, amount increase options 112, digital asset sale options 116, and digital asset purchase options 118. As an example, a user selects the digital asset-based payment options 114. After the digital asset-based payment options 114 are selected by the user, the digital asset-based payment options are displayed as shown in FIG. 9B. The digital asset-based payment options 114 include provide user information 124, present code 126, scan code 128, and insert payment 130. In an alternative example, selecting the digital asset-based payment options 114 may automatically initiate an option based on the capabilities of the bi-directional digital asset POS computing device and/or a default setting of one or more of the user computing device 12 and the bi-directional digital asset POS computing device 14. As another example, a user input and/or action may initiate an option without a deliberate selection of the option. For example, the user computing device displays a code to the bi-directional digital asset POS computing device 14 to initiate an interaction. The various interaction options will be discussed in greater detail with reference to one or more of the following Figures.

FIG. 10 is a flowchart of an example of a method of a digital asset-based payment of the digital asset-based interaction system. FIG. 10 includes a user computing device 12, a bi-directional digital asset POS computing device 14, a digital asset-based interaction computing entity 16, an interface means 18, a digital asset backing computing entity 20, and a digital asset management computing entity 50. The user computing device 12 and the bi-directional digital asset POS computing device 14 include digital asset-based interaction interfaces 25-1 and 25-2 respectively and operate as discussed with reference to one or more of the previous Figures. The digital asset-based interaction interfaces 25-1 and 25-2 interface with the digital asset-based interaction computing entity 16 to facilitate digital asset-based interactions.

The bi-directional digital asset POS computing device 14 may be associated with a merchant and is operable to process digital asset-based payments from a user computing user and includes features tailored to the type of bi-directional digital asset POS computing device 14 it is (e.g., a scanning device, a touchscreen, mobile payment features, online payment features, etc.).

The digital asset management computing entity 50 is associated with the digital asset backing computing entity 20 via an account and is operable to deposit system digital assets into its account to back digital asset-based interactions made by users of its associated asset management unit (e.g., asset management unit 22). The user computing device 12 and the bi-directional digital asset POS computing device 14 interact via the interface means 18 as discussed with reference to FIG. 1. For example, the interface means 18 is a scanning device of the user computing device 12 and/or the bi-directional digital asset POS computing device 14.

The method begins with step 32 where a digital asset-based payment is initiated. The digital asset-based payment is a digital asset-based interaction where the user computing device 12 uses a user desired digital asset to pay a merchant via the bi-directional digital asset POS computing device 14 where the bi-directional digital asset POS computing device 14 accepts assets in a merchant desired asset format (e.g., fiat currency or a desired digital asset that may differ from the digital asset the user computing device 12 wishes to use in the interaction). The digital asset-based payment is initiated when the user computing device 12 and the bi-directional digital asset POS computing device 14 interact via the interface means 18 to send real-time information to the digital asset-based interaction computing entity 16 as discussed with reference to FIGS. 1-3.

During the digital asset-based payment initiation, the digital asset-based interaction computing entity 16 receives real-time information 24 and/or 26 regarding the digital asset-based payment between the user computing device 12 sending user desired digital assets and the bi-directional digital asset POS computing device 14 accepting merchant desired assets in the merchant desired asset format.

For example, the user computing device 12 sends user computing device real-time information 24 to the digital asset-based interaction computing entity 16 via the digital asset-based interaction interface 25-1 of the asset management unit 22 and the bi-directional digital asset POS computing device 14 sends bi-directional digital asset POS computing device real-time information 26 to the digital asset-based interaction computing entity 16 via the digital asset-based interaction interface 25-2 (e.g., from either requesting or scanning a scannable code). As another example, the digital asset-based interaction interface of the user computing device 12 or the bi-directional digital asset POS computing device 14 may send the user computing device real-time information 24 and the bi-directional digital asset POS computing device real-time information 26 to the digital asset-based interaction computing entity 16 (e.g., the user computing device 12 sends the bi-directional digital asset POS computing device real-time information 26 and the user computing device real-time information 24).

The user computing device real-time information 24 includes an identifier (e.g., a user ID) and a type of user desired digital asset (e.g., a cryptocurrency) selected for use in a digital asset-based payment with the bi-directional digital asset POS computing device 14. The bi-directional digital asset POS computing device real-time information 26 includes an identifier (e.g., a merchant ID) and a type of merchant desired asset format (e.g., a fiat currency, another cryptocurrency) for receiving payment from the user computing device 12. One or more of the user computing device real-time information 24 and the bi-directional digital asset POS computing device real-time information 26 includes the amount of the digital asset-based payment. The user computing device real-time information 24 and the bi-directional digital asset POS computing device real-time information 26 may include further information and/or metadata such as loyalty information, personal information (address, name, etc.), shipping details, bill splitting information, a request for additional information, etc.

When the digital asset-based interaction computing entity 16 receives the user computing device real-time information 24 and the bi-directional digital asset POS computing device real-time information 26 (e.g., the real-time information 24-26), the digital asset-based interaction computing entity 16 initiates 1) a real-time digital asset-based interaction process (e.g., the real-time digital asset-based interaction loop 28) and 2) a nonreal-time digital asset-based interaction process to reconcile the digital asset-based interaction with the digital asset backing computing entity 20 (e.g., the nonreal-time digital asset-based interaction loop 30). The reconciliation of the digital asset-based interaction with the digital asset backing computing entity 20 occurs within a time frame that is longer than the time frame of the real-time digital asset-based interaction.

The method continues with step 34 where the digital asset-based interaction computing entity 16 instructs the digital asset backing computing entity 20 to lock an amount of system digital asset associated with the digital asset-based payment. The amount of system digital asset locked may be based on one or more of an amount involved in the digital asset-based payment, a type of digital asset-based payment, a type of item involved in the digital asset-based payment, the user computing device 12 (e.g., a typical amount the user computing device 12 spends, an account balance, etc.), and the bi-directional digital asset POS computing device 14 (e.g., the type of merchant the bi-directional digital asset POS computing device 14 is associated with, a type of goods the merchant sells, a default amount set by the merchant, etc.).

When the digital asset-based interaction computing entity 16 locks the system digital asset, a rate quote for the amount of digital asset used by the user computing device 12 may be locked. Within the real-time digital asset-based interaction loop 28, the method continues with step 36 where a network acknowledgment (ACK) of the receipt of the amount of the user desired digital assets is or is not generated. For example, when the digital asset-based interaction computing entity 16 receives an amount of user desired digital assets 46 from the user computing device 12 to use in the digital asset-based payment, the ACK is generated and the method continues to steps 38 and 40. If the digital asset-based payment initiation is terminated (e.g., digital asset-based payment initiation fails and/or is cancelled by the user computing device 12 and/or the bi-directional digital asset POS computing device 14) within a certain amount of time prior to the digital asset-based interaction computing entity 16 continuing with the following steps of the real-time digital asset-based interaction loop 28, the ACK is not generated, and the digital asset-based payment terminates. When the ACK is not generated, the method continues with step 44 where the digital asset-based interaction computing entity 16 instructs the digital asset backing computing entity 20 to release the amount of locked system digital asset.

Within the real-time digital asset-based interaction loop 28, when the ACK is generated, the method continues with step 38 where the digital asset-based interaction computing entity 16 exchanges (or connects to one or more digital asset exchange computing entities to exchange) the amount of the user desired digital asset 46 received from the user computing device 12 to an amount of assets in a merchant desired asset format (e.g., fiat currency, a particular digital asset, etc.). Digital asset exchange is done quickly (e.g., 30 seconds to a few minutes) to account for exchange rate volatility. The digital asset-based interaction computing entity 16 sends the amount in the merchant desired asset format 48 to the bi-directional digital asset POS computing device 14 to complete the digital asset-based payment.

Within the nonreal-time digital asset-based interaction loop 30, when the ACK is generated at step 36, the method continues with step 40 where the digital asset-based interaction computing entity 16 verifies the amount of the user desired digital asset 46 received from the user computing device 12. For example, the digital asset-based interaction computing entity 16 connects to one or more digital asset consensus network computing entities to verify the amount of the user desired digital asset 46 received from the user computing device 12. The one or more digital asset consensus network computing entities implement a verification process that may take minutes to hours of time. For example, when the user desired digital asset is a cryptocurrency hosted on a blockchain, the digital asset-based interaction computing entity 16 connects to the blockchain associated with the cryptocurrency to verify whether a certain amount of blocks including the transaction of sending the user desired digital assets from the user computing device to the 12 to the digital asset-based interaction computing entity 16 have been added to the blockchain (e.g., a certain amount of confirmations are obtained). Other digital asset verification processes are possible and are based on the type of digital asset involved.

When the digital asset-based interaction computing entity 16 verifies the amount of the user desired digital assets received by the user computing device 12 at step 40, the method continues to step 44 where the digital asset-based interaction computing entity 16 instructs the digital asset backing computing entity 20 to release the amount of system digital asset locked for the digital asset-based payment. When the digital asset-based interaction computing entity 16 does not verify the amount of the digital asset received by the user computing device 12 at step 40, the method continues to step 42 where the digital asset-based interaction computing entity 16 instructs the digital asset backing computing entity 20 to consume the amount of system digital asset locked for the digital asset-based interaction. Consuming the amount of system digital asset means that the digital asset backing computing entity 20 transfers the amount of system digital assets to an address controlled by the digital asset-based interaction computing entity 16 in order to cover the amount of the digital asset-based payment.

FIG. 10A is a flowchart of an example of a method of a digital asset-based payment of a digital asset-based interaction system. FIG. 10A is similar to the method of FIG. 10 except that the ACK at step 36 is generated after the system digital asset is locked but prior to receiving the amount of the user desired digital asset from the user computing device 12. Locking the system digital asset implies authorization of the digital asset-based payment and the digital asset-based interaction computing entity 16 allows a time period (e.g., up to five minutes) prior to obtaining user desired digital assets from the user computing device 12 (e.g., the user computing device has time to add tip, split the payment with another user, adjust type of digital asset used, etc.). The bi-directional digital asset POS computing device 14 is provided a confirmation of this ACK. For example, when the bi-directional digital asset POS computing device 14 is a POS computing device such as an attended register, this ACK may successfully end the in-person transaction such that the merchant and customer can part ways. However, the bi-directional digital asset POS computing device 14 receives payment up to a few minutes after the in-person transaction.

When the digital asset-based interaction computing entity 16 locks the system digital asset, a rate quote for the amount of digital asset used by the user computing device 12 is locked. The digital asset-based interaction computing entity 16 locks the rate quote based on a tolerance window acceptable to the user of the user computing device 12. For example, the rate quote may be higher than a current rate quote if the window of time provided to receive funds is longer. The digital asset-based interaction computing entity 16 has knowledge of the fluctuations on the digital asset exchange used and is operable to adjust the rate quotes according to a digital asset's availability on the exchange. Further, once a user authorizes a digital asset-based payment, the digital asset indicated in the digital asset-based payment may be exchanged by the digital asset-based interaction computing entity 16 on credit (even if it has not been received yet) with the exchange to ensure a particular rate quote. Once the digital asset is received from the user, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the digital asset-based payment) for a substantially equivalent amount of assets in a merchant desired asset format. When the amount of user desired digital asset is received by the digital asset-based interaction computing entity 16, the digital asset-based interaction computing entity 16 is operable to exchange the amount of user desired digital asset to the substantially equivalent amount of the smart contract compatible token used to cover the real-time digital asset exchange.

When the ACK is generated, the digital asset-based interaction computing entity 16 sends the bi-directional digital asset POS computing device 14 a confirmation 35 of the digital asset-based payment. If the digital asset-based payment initiation is terminated (e.g., digital asset-based payment initiation fails and/or is cancelled by the user computing device 12 and/or the bi-directional digital asset POS computing device 14) within a certain amount of time prior to the digital asset-based interaction computing entity 16 continuing with the following steps of the real-time digital asset-based interaction loop 28, the ACK is not generated, and the confirmation 35 of the digital asset-based payment is not sent.

When the ACK is not generated, the method continues with step 44 where the digital asset-based interaction computing entity 16 instructs the digital asset backing computing entity 20 to release the amount of locked system digital asset. Within the real-time digital asset-based interaction loop 28, when the ACK is generated, the method continues with step 37 where, after a time period (e.g., up to 5 minutes), the amount of user desired digital asset 46 is obtained. For example, an initial amount of user desired digital asset is received at a time T1, and an additional amount of user desired digital asset (e.g., tip is added) is received at a time T2 where the initial amount and the additional amount equal the amount of user desired digital asset 46.

The method continues with step 38 where the digital asset-based interaction computing entity 16 exchanges (or connects to one or more digital asset exchange computing entities to exchange) the amount of the user desired digital asset 46 received from the user computing device 12 to an amount of asset in the merchant desired asset format. Alternatively, if the smart contract compatible token is used to cover the real-time digital asset exchange, the digital asset-based interaction computing entity 16 exchanges an amount of the smart contract compatible token to an amount of assets in the merchant desired asset format 48. The digital asset-based interaction computing entity 16 sends the amount in the merchant desired asset format 48 to the bi-directional digital asset POS computing device 14 to complete the digital asset-based payment.

Within the nonreal-time digital asset-based interaction loop 30, after the amount of digital asset 46 is obtained at step 37, the method continues with step 40 where the digital asset-based interaction computing entity 16 verifies the amount of the digital asset 46 received from the user computing device 12. For example, the digital asset-based interaction computing entity 16 connects to a consensus network that verifies the amount of the digital asset received from the user computing device 12. The consensus network implements a verification process that may take minutes to hours of time.

When the digital asset-based interaction computing entity 16 verifies the amount of the digital asset received by the user computing device 12 at step 40, the method continues to step 44 where the digital asset-based interaction computing entity 16 instructs the digital asset backing computing entity 20 to release the amount of system digital asset locked for the digital asset-based interaction. When smart contract compatible tokens were used to cover the real-time digital asset exchange, the digital asset-based interaction computing entity 16 exchanges the amount of the digital asset 46 received from the user computing device 12 to an amount of the smart contract compatible token used to cover the digital asset-based payment.

When the digital asset-based interaction computing entity 16 does not verify the amount of the digital asset received by the user computing device 12 at step 40, the method continues to step 42 where the digital asset-based interaction computing entity 16 instructs the digital asset backing computing entity 20 to consume the amount of system digital asset locked for the real-time digital asset-based interaction. Consuming the amount of system digital asset means that the digital asset backing computing entity 20 transfers the amount of system digital asset to an address controlled by the digital asset-based interaction computing entity 16 in order to cover the amount of the digital asset-based payment.

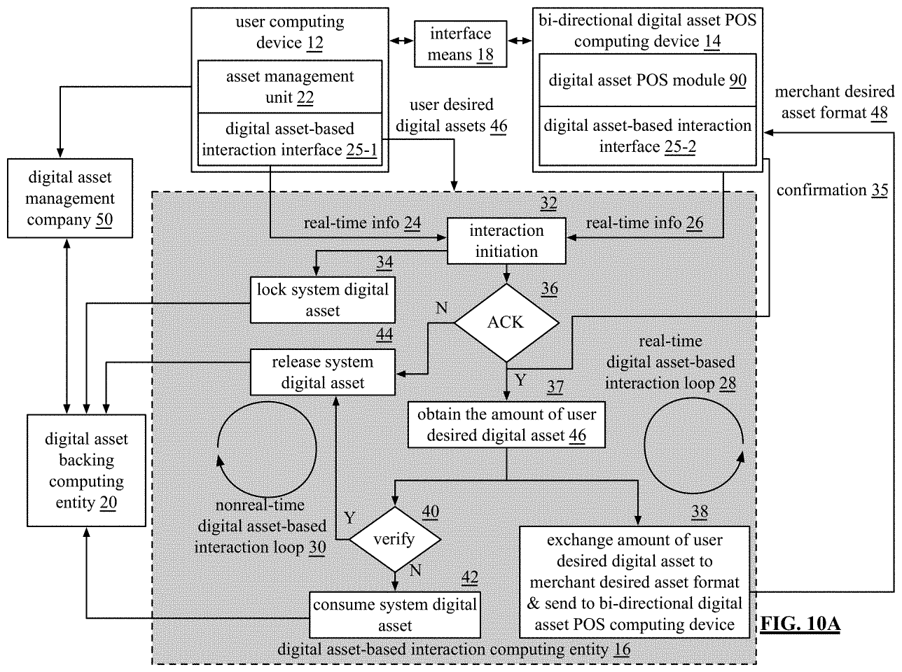

FIGS. 11A-11B are schematic block diagrams of an embodiment of a user computing device 12 of a digital asset-based interaction system. FIGS. 11A-11B depicts a user interface perspective of the user computing device 12 using a “show to pay” payment mode. The user computing device 12 includes the asset management unit 22, a display 66, a front scanning device 62, and a back scanning device 64 and operates similarly to the user computing device 12 of previous Figures. The asset management unit 22 includes a digital asset-based interaction interface 25-1 that interfaces with the digital asset-based interaction computing entity.

In the user interface perspective, the digital asset-based interaction interface 25-1 includes the asset depository and/or acceptance unit module 72 which is operable to display one or more balances of the asset depository and/or acceptance unit, the code module 74, and the entity selection/interaction options module 76 as discussed with reference to FIG. 6. As shown in FIG. 11A, a user of the user computing device 12 initiates a digital asset-based payment using a show to pay payment mode by selecting a merchant (merchant 1 in this example) from a displayed list of merchants in the entity selection/interaction options module 76. In this example, interaction options are not shown and the show to pay method is automatically initiated when the merchant is selected (e.g., based on information received by the digital asset-based interaction computing device, based on the type of merchant, a default setting, etc.).

As shown in FIG. 11B, when the merchant is selected, the user computing device 12 receives a user authorization code 91 and a verification code 93 (e.g., the bi-directional digital asset POS computing device 14 requires a verification code along with the user authorization code 91 to authorize the digital asset-based interaction system payment) from the digital asset-based interaction computing entity. The user authorization code 91 and the verification code 93 are displayed within the code module 74 of the user computing device's 12 display 66. The user computing device 12 is operable to present the user authorization code 91 and the verification code 93 to a bi-directional digital asset POS computing device to authorize a digital asset-based payment.

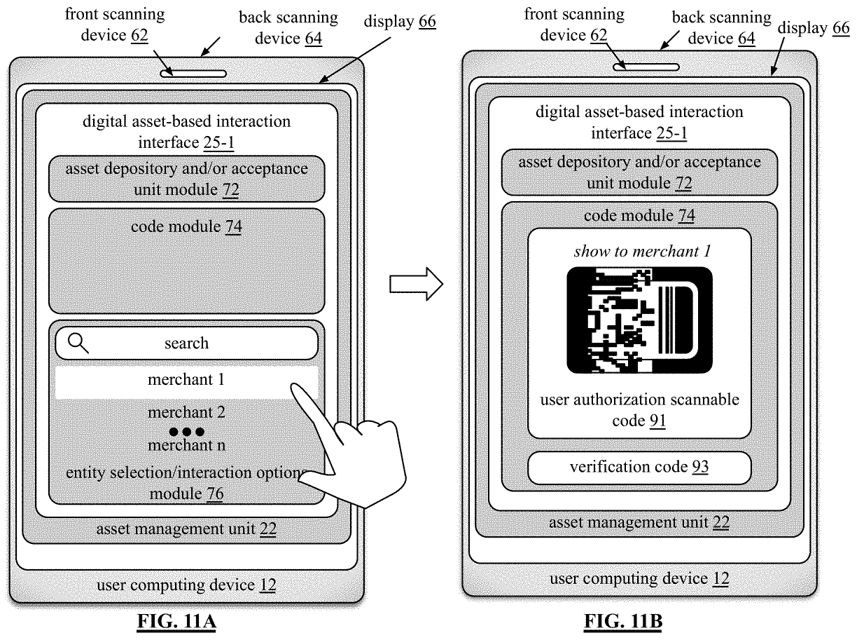

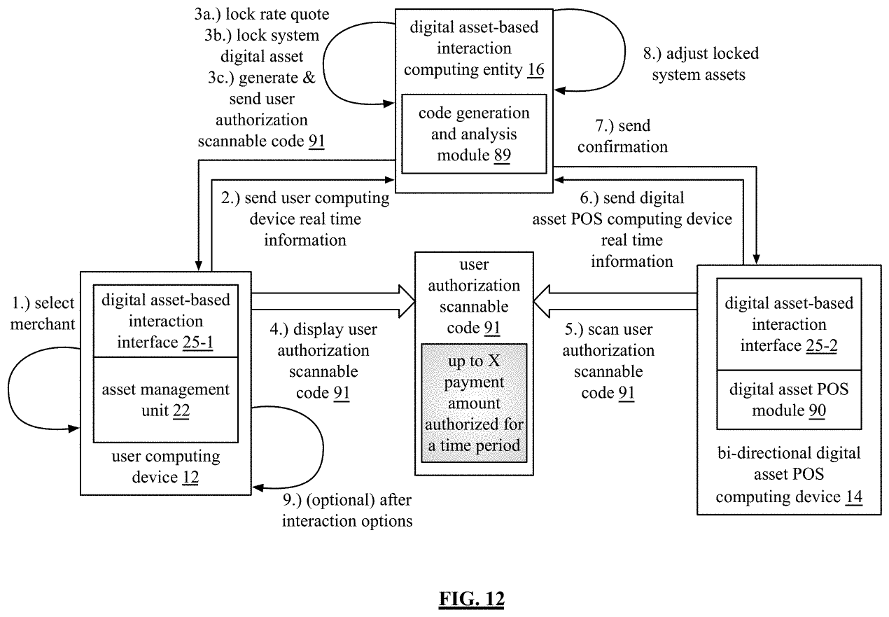

FIG. 12 is a flowchart of an example of a method for a show user authorization scannable code to pay (“show to pay”) payment mode of a digital asset-based interaction system. FIG. 12 includes a user computing device 12, a bi-directional digital asset POS computing device 14, and a digital asset-based interaction computing entity 16 of a digital asset-based interaction system. The user computing device 12 includes a digital asset management unit 22 that includes a digital asset-based interaction interface 25-1 that interfaces with the digital asset-based interaction computing entity 16 and is coupled to one or more scanning devices.

The bi-directional digital asset POS computing device 14 includes a digital asset-based interaction interface 25-2 that interfaces with the digital asset-based interaction computing entity 16. In this example, the bi-directional digital asset POS computing device 14 is a merchant POS device that includes one or more scanning devices.

The digital asset-based interaction computing entity 16 includes a code generation and analysis module 89 operable to generate and send scannable codes containing digital asset payment authorization information to one or more of the user computing device 12 and the bi-directional digital asset POS computing device 14. A scannable code may be a one-dimensional barcode, a two-dimensional barcode (e.g., a QR code), or any type of scannable/graphical code that can be scanned and/or read.

For a show to pay payment mode, the method begins with step 1 where the user computing device 12 selects a merchant associated with the bi-directional digital asset POS computing device 14 to pay via an entity selection/interaction options module of the digital asset-based interaction interface 25-1. For example, the user computing device is in a merchant's brick and mortar store and selects the merchant from a merchant list displayed based on user computing device GPS information (e.g., closest merchants are listed first). The method continues with step 2 where selecting the merchant sends user computing device real-time payment information to the digital asset-based interaction computing entity 16.

The user computing device real-time payment information includes a user identifier (ID) and a type of digital asset to use in a real-time payment to the bi-directional digital asset POS computing device 14. For example, when the user computing device 12 selects a merchant, the user may also select a specific digital asset (e.g., Bitcoin) to use. Alternatively, a preferred digital asset is stored as a default payment method. The user computing device real-time payment information may include other metadata such as user loyalty information (e.g., a user's customer loyalty account number associated with the merchant), user account information associated with a merchant (e.g., username, password, etc.), personal information (e.g., address, name, etc.), shipping details, etc.

The method continues with steps 3a-3c which may occur concurrently or in a different order (e.g., step 3b occurs slightly before step 3a). In step 3a, the digital asset-based interaction computing entity 16 locks the rate quote for the digital asset selected by the user computing device 12 such that the rate quote presented to the user computing device 12 (via the digital asset balance in US dollars or other digital asset) is what is used for the real-time payment even if the rate fluctuates during that time.

The method continues with step 3b where the digital asset-based interaction computing entity 16 locks an amount of system digital assets (e.g., that was deposited by the digital asset management company associated with the digital asset management unit 22) as collateral for the real-time digital asset payment. The amount of system digital assets locked may be based on the user computing device 12 (e.g., how much the user computing device typically spends, how much digital asset the user computing device has in the digital asset management unit, etc.) and/or the bi-directional digital asset POS computing device 14 (e.g., what type of products the merchant sells, an average price point of items the merchant sells, a default collateral amount the merchant requires, etc.).

The method continues with step 3c where the code generation and analysis module 89 of the digital asset-based interaction computing entity 16 generates and sends a user authorization scannable code 91 to the user computing device 12. The format of the user authorization scannable code 91 generated depends on the POS requirements of the bi-directional digital asset POS computing device 14. For example, the user authorization scannable code 91 generated depends on the scanning technology used by the bi-directional digital asset POS computing device. A merchant may also require the digital asset-based interaction computing entity 16 to generate and send a verification code along with a user authorization scannable code 91. For example, a verification code is an alpha numeric code that can be manually entered or scanned by the bi-directional digital asset POS computing device.

If a verification code is required, the code generation and analysis module 89 generates and sends a temporary verification code along with the user authorization scannable code 91 to the user computing device 12. The user authorization scannable code 91 authorizes a purchase for up to a certain amount (e.g., X amount) for a time period (e.g., 5-30 seconds). The certain amount authorized may be based on one or more of the amount of system digital assets locked, the user computing device 12, and the bi-directional digital asset POS computing device 14.

The time period may be a few seconds up to a few minutes of time depending on the user computing device 12, the type of payment, and/or the bi-directional digital asset POS computing device 14. For example, a fast food retail payment may have a shorter time period than a car purchase payment because the car purchase may involve lengthy paperwork and identity verification checks coinciding with payment. If the time period expires prior to real-time payment confirmation, the user authorization scannable code 91 will no longer be valid and the user computing device 12 will need to request a new user authorization scannable code 91. Alternatively, the digital asset-based interaction computing entity 16 may automatically send a new user authorization scannable code 91 to the user computing device 12 every few seconds for a time period (e.g., up to 5 minutes) before the user computing device 12 would need to request a new user authorization scannable code 91.

The method continues with step 4 where the user computing device 12 displays the user authorization scannable code 91 (via the code module of the digital asset-based interaction interface 25-1) on a display of the user computing device 12. The method continues with step 5 where the bi-directional digital asset POS computing device 14 is operable to scan the user authorization scannable code 91 via a scanning device of the bi-directional digital asset POS computing device 14. For example, a user of the user computing device 12 places the user computing device 12 display near a scanning device of the bi-directional digital asset POS computing device 14 (e.g., the bi-directional digital asset POS computing device 14 is a tablet and the scanning device is a front or back camera) for the bi-directional digital asset POS computing device 14 to capture the user authorization scannable code 91. In that example, the bi-directional digital asset POS computing device 14 may be an unattended POS register (e.g., at a retail kiosk, self-checkout location, a gas pump checkout, a vending machine, etc.).

As another example, the bi-directional digital asset POS computing device 14 is a POS register that includes a handheld scanning device (e.g., a barcode scanner, a smart phone camera, etc.). The user of the user computing device 12 presents the user authorization scannable code 91 to an attendant of the bi-directional digital asset POS computing device 14, and the attendant scans the user authorization scannable code 91 with the handheld scanning device.

If user metadata is included in the user authorization scannable code 91, the bi-directional digital asset POS computing device 14 is operable to view that metadata upon scanning. For example, the user's loyalty information applies a discount to the total amount owed. As another example, a user's shipping information adjusts the shipping rate applied to the total amount owed. As another example, the user metadata authorizes a future and/or reoccurring charge (e.g., the merchant is a hotel and requires a payment method “on file”). In that example, the bi-directional digital asset POS computing device is authorized to store limited user computing device 12 information such that the bi-directional digital asset POS computing device can send a future request for payment to the digital asset-based interaction computing entity when a future payment is due. The digital asset-based interaction computing entity receives that request from the bi-directional digital asset POS computing device and generates a push notification to send to the user computing device where the user computing device can authorize the future payment via the push notification.

The method continues with step 6 where, when the bi-directional digital asset POS computing device 14 scans the user authorization scannable code 91, the bi-directional digital asset POS computing device 14 sends bi-directional digital asset POS computing device real-time payment information to the digital asset-based interaction computing entity 16. The bi-directional digital asset POS computing device real-time payment information includes a merchant identifier (ID) and a type of desired digital asset (e.g., a fiat currency, a different cryptocurrency, etc.) it wishes to receive in the real-time payment from the user computing device 12. The bi-directional digital asset POS computing device real-time payment information also includes the amount of the real-time payment in this example. The bi-directional digital asset POS computing device real-time payment information may include other information and/or metadata such as a terminal ID of the bi-directional digital asset POS computing device, discounts offered and/or applied, shipping details (rates, method, etc.), bill splitting options, etc.

When the digital asset-based interaction computing entity 16 receives both the user computing device real-time payment information and the bi-directional digital asset POS computing device real-time payment information and the system digital assets have been locked for the payment, the method continues with step 7 where the digital asset-based interaction computing entity 16 provides a confirmation to the bi-directional digital asset POS computing device 14 that the payment is approved.

The method continues with step 8 where the digital asset-based interaction computing entity 16 adjusts the amount of locked system digital assets based on the amount of the payment. The user authorization scannable code 91 implies authorization of payment to the bi-directional digital asset POS computing device 14 but funds are not necessarily pulled from the user computing device 12 for a time period. As such, the method continues with an optional step 8b where the user computing device 12 has a certain amount of time (a few seconds to up to five minutes) to implement after interaction options. The after interaction options include switching between asset management units, switching the type of digital asset used, adding a tip, splitting the bill, moving items for purchase between users, etc. Further, because funds are not pulled immediately, if a network connection issue occurs (e.g., internet connection is lost for a few seconds) after payment confirmation, funds can be pulled when the network connection is reestablished. The method continues with steps similar to steps 36-44 of FIG. 10-10A.

While FIGS. 11A-12 discuss a show to pay payment mode, the steps of authorizing an interaction by a user presenting a user authorization code to the bi-directional digital asset POS computing device can be used to authorize/initiate other types of interactions of the digital asset-based interaction system.

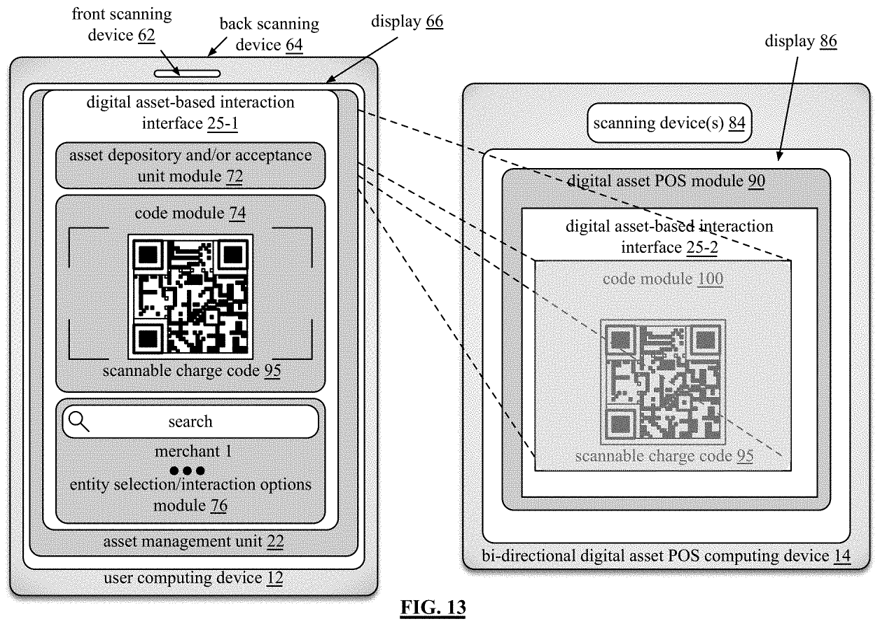

FIG. 13 is a schematic block diagram of an embodiment of a scan to pay payment mode of a digital asset-based interaction system. FIG. 13 depicts a user interface perspective of the user computing device 12 and a bi-directional digital asset POS computing device utilizing a scan to pay payment mode. The user computing device 12 includes the asset management unit 22, a display 66, a front scanning device 62, and a back scanning device 64 and operates similarly to the user computing device 12 of previous Figures. The asset management unit 22 includes a digital asset-based interaction interface 25-1 that interfaces with the digital asset-based interaction computing entity.

In the user interface perspective, the digital asset-based interaction interface 25-1 includes the asset depository and/or acceptance unit module 72 which is operable to display one or more balances of the asset depository and/or acceptance unit, the code module 74, and the entity selection/interaction options module 76 as discussed with reference to FIG. 6. In this example, the bi-directional digital asset POS computing device includes scanning device(s) 84 and a display 86. For example, the bi-directional digital asset POS computing device 14 is a tablet enabled as a register and is associated with a merchant.

The bi-directional digital asset POS computing device 14 includes a digital asset POS module 90 that includes a digital asset-based interaction interface 25-2 that interfaces with the digital asset-based interaction computing entity and operates similarly to the bi-directional digital asset POS computing device 14 of previous Figures. The digital asset-based interaction interface 25-2 includes a code module 100 coupled to the scanning device(s) 84. The code module 100 is operable to receive scannable codes (e.g., from the digital asset-based interaction computing entity), scan scannable codes (e.g., capture via the scanning device(s) 84, digitize, and bring into a frame of reference), display scannable codes on the display 86, and interpret scannable codes to determine and/or display payment information.

As shown, the bi-directional digital asset POS computing device 14 displays a scannable charge code 95 on a display 86 of the bi-directional digital asset POS computing device 14 for use in a digital asset-based payment. As another example, the bi-directional digital asset POS computing device 14 prints a scannable charge code 95 (e.g., onto a receipt) and provides the printed scannable charge code 95 to the user computing device 12. In that example, the bi-directional digital asset POS computing device 14 may not include a display 86 and operate similarly to a traditional POS register.

Within the digital asset-based interaction interface 25-1, the user computing device 12 is operable to scan the scannable charge code 95 via the back scanning device 64 in this example (e.g., the back camera of a smart phone). The code module 74 digitizes the scannable charge code 95 and brings the scannable charge code 95 into a frame of reference. The code module 74 analyzes information in the scannable charge code 95 and presents the information to the user when needed. If the scannable charge code 95 includes requests and/or notifications from the bi-directional digital asset POS computing device, those requests and/or notifications are displayed in the code module 74 or another portion of the display 66. While the entity selection/interaction options module 76 is shown here, it may collapse out of view during a scanning function. Many user interface views are possible within the digital asset-based interaction interface 25-1 in addition to what is shown.

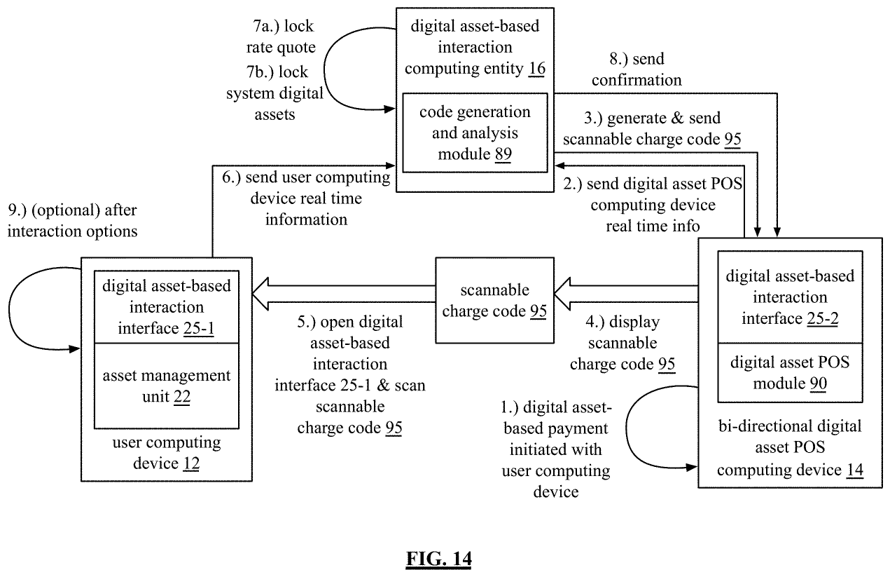

FIG. 14 is a flowchart of an example of a method for a scan to pay payment mode of a digital asset-based interaction system. FIG. 14 includes the user computing device 12, the bi-directional digital asset POS computing device 14, and the digital asset-based interaction computing entity 16 of a digital asset-based interaction system. The user computing device 12 includes a digital asset management unit 22 including a digital asset-based interaction interface 25-1 that interfaces with the digital asset-based interaction computing entity 16 and is coupled to one or more scanning devices.

The bi-directional digital asset POS computing device 14 includes a digital asset-based interaction interface 25-2 that interfaces with the digital asset-based interaction computing entity 16. In this example, the bi-directional digital asset POS computing device 14 may be any type of a bi-directional digital asset POS computing device 14 such as a merchant POS device, an e-commerce website, an e-commerce mobile application, etc.

The digital asset-based interaction computing entity 16 includes a code generation and analysis module 89 operable to generate and send scannable codes containing digital asset-based payment authorization information to one or more of the user computing device 12 and the bi-directional digital asset POS computing device 14. A scannable code may be a one-dimensional barcode, a two-dimensional barcode (e.g., a QR code), or any type of graphical code that can be optically scanned and/or read.

For a scan to pay payment mode, the method begins with step 1 where a digital asset-based payment is initiated with the user computing device 12 by the bi-directional digital asset POS computing device 14. For example, the bi-directional digital asset POS computing device 14 is a POS register and one or more of the user computing device 12 and the bi-directional digital asset POS computing device 14 select a digital asset-based payment option during checkout.

The method continues with step 2 where, when the digital asset-based payment is initiated with the user computing device 12, the bi-directional digital asset POS computing device 14 sends bi-directional digital asset POS computing device real-time payment information to the digital asset-based interaction computing entity 16. The bi-directional digital asset POS computing device real-time payment information includes a merchant identifier (ID) of a merchant associated with the bi-directional digital asset POS computing device and a type of desired asset (e.g., a fiat currency, a digital asset, etc.) it wishes to receive in the real-time payment from the user computing device 12. The bi-directional digital asset POS computing device real-time payment information also includes the amount of the real-time payment in this example. The bi-directional digital asset POS computing device real-time payment information may include other information and/or metadata such as a terminal ID of the bi-directional digital asset POS computing device, discounts offered and/or applied, shipping details (rates, method, etc.), bill splitting options, a request for user computing device information, etc.

The method continues with step 3 where the code generation and analysis module 89 of the digital asset-based interaction computing entity 16 generates and sends a scannable charge code 95 to the bi-directional digital asset POS computing device 14. The scannable charge code 95 includes a transaction and/or terminal identifier (ID) of the bi-directional digital asset POS computing device 14, merchant information (e.g., a merchant ID, merchant name, etc.) the amount of the payment, the digital asset requested, and other metadata. For example, scannable charge code 95 metadata includes a request for customer loyalty information, for shipping details (method, customer address), a discount applied (e.g., according to certain conditions such as when a certain digital asset is used), etc.

The method continues with step 4 where the bi-directional digital asset POS computing device 14 displays the scannable charge code 95. For example, the bi-directional digital asset POS computing device 14 is a POS register and displays the scannable charge code 95 on a display. As another example, the bi-directional digital asset POS computing device 14 is a POS register and prints the scannable charge code 95 onto a receipt.

The method continues with step 5 where the user computing device 12 opens a digital asset-based interaction interface 25-1 on the asset management unit 22 and scans the scannable charge code 95 via a scanning device of the user computing device 12. For example, the scanning device of the user computing device 12 scans the scannable charge code 95 presented on a display of the bi-directional digital asset POS computing device 14 (e.g., the bi-directional digital asset POS computing device 14 is a POS register). As another example, the scanning device of the user computing device 12 scans the scannable charge code 95 presented on a receipt of the bi-directional digital asset POS computing device 14 (e.g., the bi-directional digital asset POS computing device 14 is a POS register that printed the scannable charge code 95 onto a receipt).

The scannable code module of the digital asset-based interaction interface 25-1 interprets the scanned scannable charge code 95 and may display merchant requests included in the scannable charge code information to the user computing device 12 such as a request for a shipping address and shipping method, a request for customer loyalty information, discount information, etc.

The method continues with step 6 where scanning the scannable charge code 95 sends user computing device real-time payment information to the digital asset-based interaction computing entity 16. The user computing device real-time payment information includes a user identifier (ID) and a type of digital asset to use in a real-time payment to the bi-directional digital asset POS computing device 14.

When merchant requests are displayed to the user computing device 12, the user computing device real-time payment information may further include user inputs in response to those merchant requests (e.g., the user computing device 12 enters in customer loyalty information, shipping details, etc.).

The method continues with step 7a-7b which may occur concurrently or in a different order (e.g., step 7b occurs slightly before step 7a). In step 7a, the digital asset-based interaction computing entity 16 locks the rate quote for the digital asset selected by the user computing device 12 such that the rate quote presented to the user computing device 12 (via the digital asset balance in US dollars or other digital asset) is what is used for the real-time payment even if the rate fluctuates during that time.

The method continues with step 7b where the digital asset-based interaction computing entity 16 locks an amount of system digital assets (e.g., that was deposited by the digital asset management company associated with the digital asset management unit 22) as collateral for the digital asset-based payment. The amount of system digital assets locked may be based on the user computing device 12 (e.g., how much the user computing device typically spends, how much digital asset the user computing device has in the digital asset management unit, etc.) and/or the merchant computing 14 (e.g., what type of products the merchant sells, an average price point of items the merchant sells, a default collateral amount the merchant requires, etc.). In this example, the amount of the payment is known, therefore the amount of the system digital assets locked may be based on that amount.

When the digital asset-based interaction computing entity 16 receives both the user computing device real-time payment information and the bi-directional digital asset POS computing device real-time payment information and the system digital assets have been locked for the payment, the method continues with step 8 where the digital asset-based interaction computing entity 16 provides a confirmation to the bi-directional digital asset POS computing device 14 that the digital asset-based payment is approved.

The scannable charge code 95 implies authorization of payment to the bi-directional digital asset POS computing device 14 but funds are not necessarily pulled from the user computing device 12 for a few seconds or more. As such, the method continues with an optional step 9 where the user computing device 12 has a time period (e.g., a few second or more) to implement after-payment options (e.g., switch between digital asset management units, switch the type of digital asset used, etc.). The method continues with steps similar to steps 36-44 of FIGS. 10-10A.

While FIGS. 13-14 discuss a scan to pay payment mode, the steps of authorizing an interaction by a bi-directional digital asset POS computing device presenting a scannable code to a user computing device can be used to authorize/initiate other types of interactions of the digital asset-based interaction system.

FIGS. 15A-15B are schematic block diagrams of embodiments of a user computing device 12 of a digital asset-based interaction system. The user computing device 12 includes an asset management unit 22, a display 66, a front scanning device 62, and a back scanning device 64 and operates similarly to the user computing device 12 of previous Figures. The user computing device 12 includes a digital asset-based interaction interface 25-1 for communicating with the digital asset-based interaction computing entity to facilitate digital asset-based interactions. The digital asset-based interaction interface 25-1 is simplified in this example and shows a user interface perspective of an entity selection/interaction options module 76 and the asset depository and/or acceptance unit module 104. In this example, the display 66 includes touchscreen capabilities such that a user of the user computing device is operable to select options through the digital asset-based interaction interface 25-1 via touch user inputs. Other user input functionality is possible such as voice command, inputs received via an external device, etc.

FIG. 15A shows an example where a user of the user computing device 12 has initiated a digital asset-based interaction with a bi-directional digital asset POS computing device associated with a merchant 1 by selecting “merchant 1” via the entity selection/interaction options module 76 of the digital asset-based interaction interface 25-1. For example, the user searched for a particular merchant and selected the result. As another example, the entity selection/interaction options module 76 presents a list of merchants based on location information (e.g., GPS location, etc.) of the user computing device 12 and the user selects the desired merchant from the list.

As another example, a bi-directional digital asset POS computing device associated with merchant 1 displays a scannable charge code and when the user computing device 12 scans the scannable code (e.g., via the front or back scanning device), the merchant 1 is selected.

Once the merchant is selected (or a code having merchant information is input and/or scanned), the asset depository and/or acceptance unit module 104 presents digital asset pay options 106 to the user of the user computing device 12. For example, the digital asset pay options 106 include the cryptocurrencies Bitcoin and Ether. In that example, the asset depository and/or acceptance unit stores Bitcoin and Ether and those cryptocurrencies are accepted for use within the digital asset-based interaction system. The asset depository and/or acceptance unit may store additional digital assets that are not accepted for use within the digital asset-based interaction system and those digital assets are not shown as digital asset pay options 106.

The digital asset pay options 106 also display the available balances associated with those digital assets (e.g., in terms of United States dollars (USD)). In this example, the user has selected Bitcoin from the digital asset pay options 106 (e.g., via a touch user input). In another example, the user has stored a default digital asset pay option and that option is automatically selected when the user initiates a digital asset-based payment or in accordance with digital asset based payment conditions (e.g., when paying a particular merchant, when a payment is over a certain amount, etc.).

In FIG. 15B, the asset depository and/or acceptance unit module 104 (or other appropriate module of the digital asset-based interaction interface 25-1 such as the interaction confirmation module) displays further interaction options associated with merchant 1 on display 66. For example, further pay options are included as metadata in a scannable charge code and when the user computing device 12 scans the scannable charge code (e.g., via the front or back scanning device), the options are presented.

For example, the merchant 1 allows users to request an amount increase on a payment (e.g., a “cash back” feature) when paying at a bi-directional digital asset POS computing device. As shown in FIG. 15B, the merchant 1 amount increase options 108 include a plurality of asset formats (e.g., US dollars, Bitcoin, fiat currency, etc.) and a plurality of amounts (e.g., $20, $40, etc., in terms of US dollars). In another example, the user is able to enter in a custom amount for the amount increase via a user computing device touchscreen keyboard or other user input functionality.

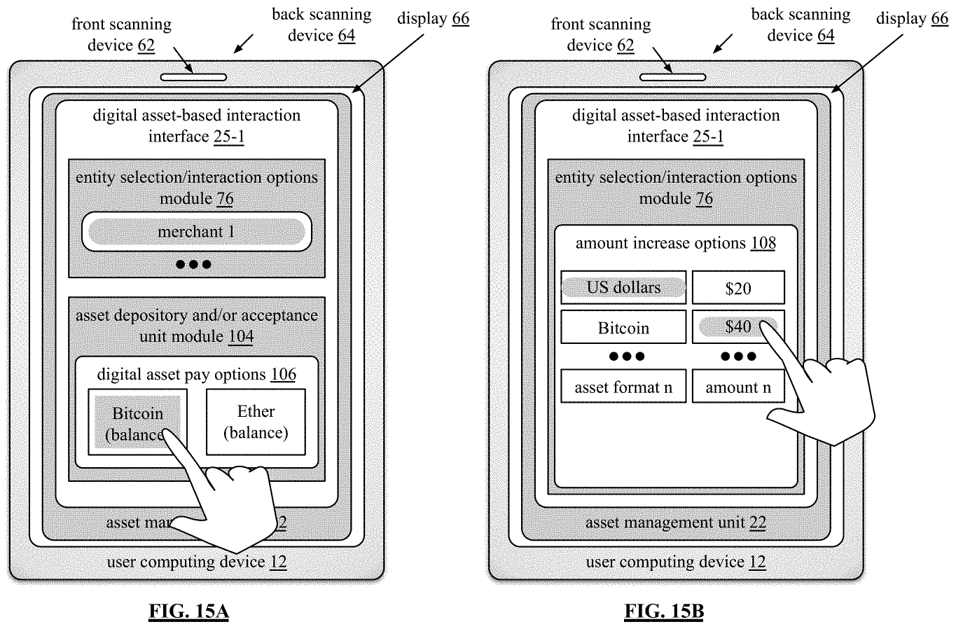

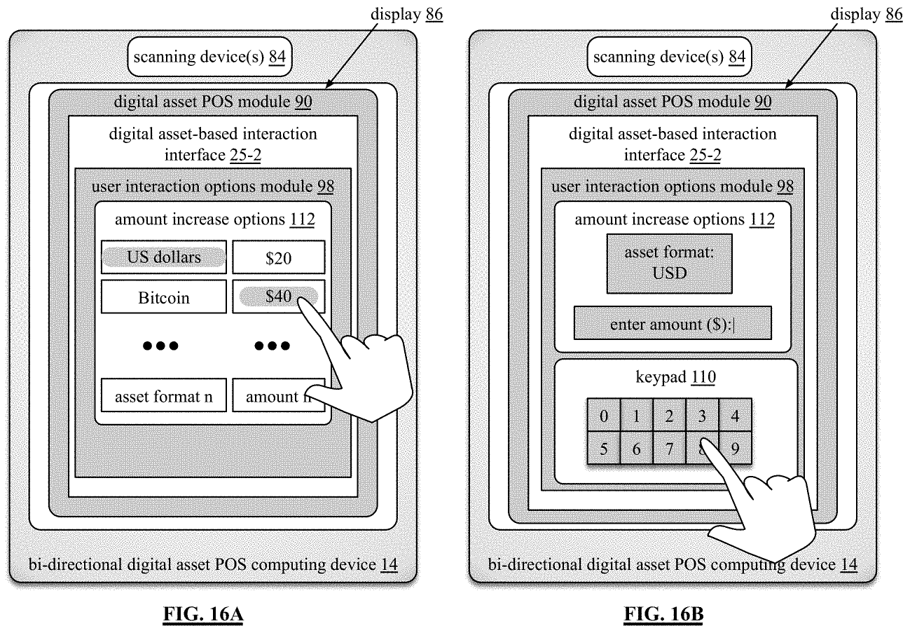

FIGS. 16A-16B are schematic block diagrams of embodiments of a bi-directional digital asset point of sale (POS) computing device 14 of a digital asset-based interaction system. The bi-directional digital asset POS computing device 14 includes one or more scanning devices 84, a display 86, and a digital asset point POS module 90 and operates similarly to the bi-directional digital asset POS computing device 14 of previous Figures. The digital asset point POS module 90 includes a digital asset-based interaction interface 25-2 that interfaces with the digital asset-based interaction computing entity. In this example, a simplified user interface perspective of the digital asset-based interaction interface 25-2 is shown to include a user interaction options module 98 operable to display a particular entity's amount increase options 112.

In an alternative example to FIGS. 15A-15B, the bi-directional digital asset POS computing device 14 associated with a merchant, is operable to display the merchant's amount increase options 112 via the digital asset-based interaction interface 25-2 on the display 86 of the bi-directional digital asset POS computing device 14 such that a user of a user computing device engaging in a digital asset-based interaction with the bi-directional digital asset POS computing device 14 can view and select the options.

For example, as depicted in FIG. 16A, after initiating a digital asset-based payment with the bi-directional digital asset POS computing device 14 (e.g., by presenting a scannable code to the bi-directional digital asset POS computing device 14 for scanning etc.), the bi-directional digital asset POS computing device 14 is operable to present the amount increase options 112 to the user of the user computing device 12 via the display 86. The display 86 in this example includes touchscreen functionality for receiving touch user inputs.

The amount increase options 112 may include a plurality of asset formats (e.g., US dollars, Bitcoin, other digital assets, other fiat currency, etc.) and a plurality of amounts (e.g., $20, $40, etc., in terms of US dollars) that a user of the user computing device 12 has the option of selecting. As another example, as depicted in FIG. 16B, the user is able to enter in a custom amount for the amount increase via a touchscreen keyboard and/or keypad 110 of the bi-directional digital asset POS computing device 14. The amount increase options 112 may also include an amount increase limit, transaction fees, and any other information related to the amount increase functionality. Other user input functionality is possible to obtain user selections (e.g., voice command, code generation and scanning, etc.).

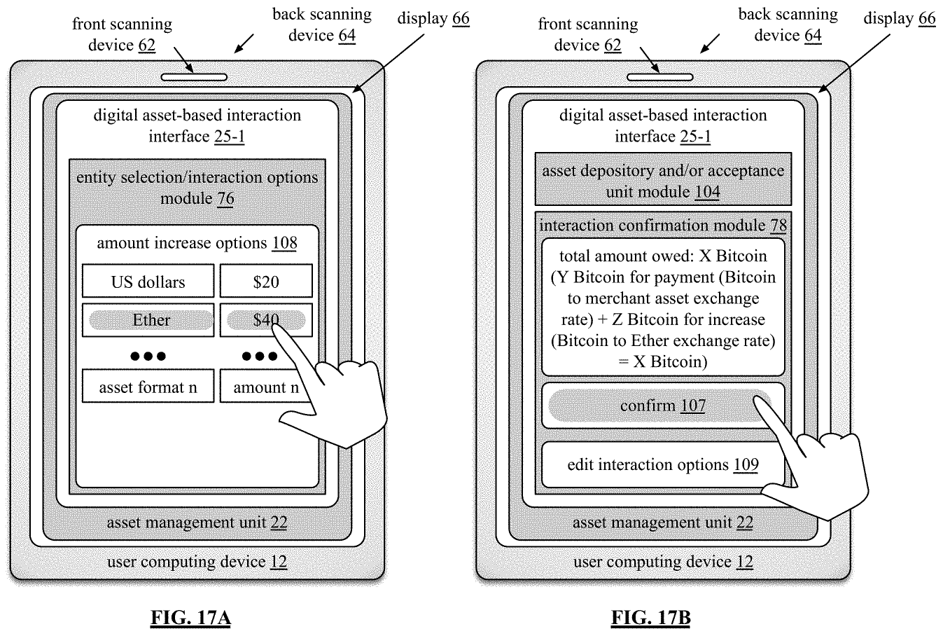

FIGS. 17A-17B are schematic block diagrams of embodiments of a user computing device 12 of a digital asset-based interaction system. The user computing device 12 includes the asset management unit 22, a display 66, a front scanning device 62, and a back scanning device 64 and operates similarly to the user computing device 12 of previous Figures. The user computing device 12 includes a digital asset-based interaction interface 25-1 for communicating with the digital asset-based interaction computing entity to facilitate digital asset-based interactions. In FIG. 17A, the digital asset-based interaction interface 25-1 is simplified and shows a user interface perspective of an entity selection/interaction options module 76. In this example, the display 66 includes touchscreen capabilities such that a user of the user computing device is operable to select options through the digital asset-based interaction interface 25-1 via touch user inputs. Other user input functionality is possible such as voice command, inputs received via an external device, etc.

FIG. 17A shows an example where a user of the user computing device 12 has initiated a digital asset-based interaction with a bi-directional digital asset POS computing device associated with a merchant 1 and the user has selected Bitcoin from the digital asset pay options 106 (e.g., via a touch user input). In another example, the user has stored a default digital asset pay option and that option is automatically selected when the user initiates a digital asset-based payment or in accordance with digital asset based payment conditions (e.g., when paying a particular merchant, when a payment is over a certain amount, etc.).

The entity selection/interaction options module 76 displays further pay options associated with merchant 1 on display 66. For example, the merchant 1 allows users to request an amount increase on a payment (e.g., a “cash back” feature) when paying at a bi-directional digital asset POS computing device and display amount increase options 108. As shown in FIG. 17A, the merchant 1 amount increase options 108 include a plurality of asset formats (e.g., US dollars, Bitcoin, fiat currency, etc.) and a plurality of amounts (e.g., $20, $40, etc., in terms of US dollars). In another example, the user is able to enter in a custom amount for the amount increase via a user computing device touchscreen keyboard or other user input functionality. In this example, the user selects an amount increase of $40 to be received in Ether. When the user desired asset format for receiving the amount increase is a digital asset, the bi-directional digital asset POS computing device authorizes sending the digital assets to the user computing device 12 via the digital asset-based interaction computing entity.

In FIG. 17B, the digital asset-based interaction interface 25-1 is simplified and shows a user interface perspective the asset depository and/or acceptance unit module 104 and the interaction confirmation module 78. As shown in FIG. 17B, when the digital asset pay options 106 and the merchant 1 amount increase options 108 are selected, the interaction confirmation module 78 of the digital asset-based interaction interface 25-1 opens (automatically or by a user input) to display the amount owed. In this example, the user is paying with Bitcoin and owes X amount of Bitcoin where X Bitcoin is the combination of Y Bitcoin to cover the digital asset-based payment plus Z Bitcoin to cover the increase request amount. The exchange rates for Bitcoin to the merchant desired asset format and Bitcoin to Ether may also be displayed. The amount owed may also include a transaction fee payable to the bi-directional digital asset POS computing device for processing the increase amount request.

The user can then confirm 107 the amount owed to authorize the payment and increase amount or choose to edit payment options 109 (e.g., select a different digital asset for payment, select a different increase amount, etc.). Alternatively, the merchant 1 amount increase options may be displayed by the bi-directional digital asset POS computing device as discussed with reference to FIGS. 16A-16B.

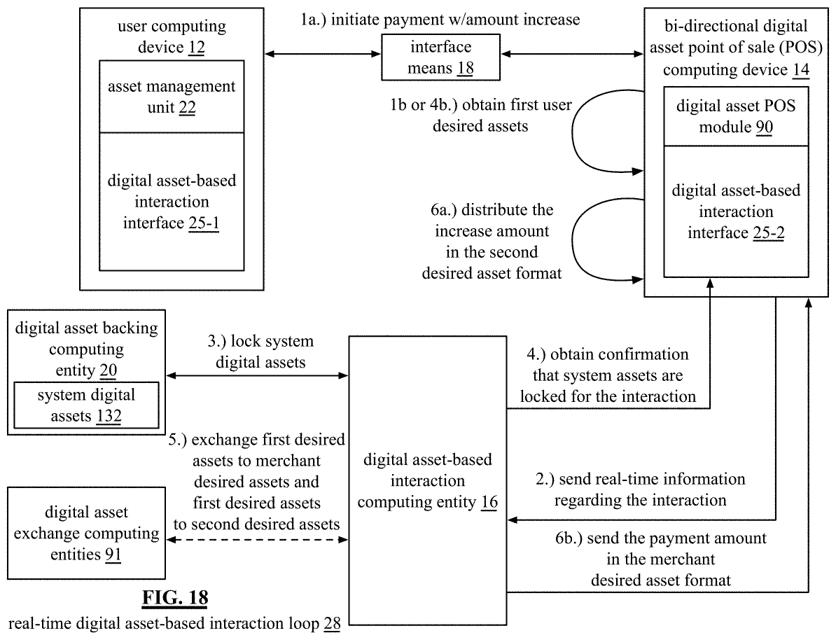

FIG. 18 is a flowchart of an example of a method of a digital asset-based payment with an amount increase request real-time digital asset-based interaction loop of a digital asset-based interaction system. FIG. 18 includes the user computing device 12, the bi-directional digital asset POS computing device 14, the digital asset-based interaction computing entity 16, the digital asset backing computing entity 20, and the one or more digital asset exchange computing entities 91 of the digital asset-based interaction system and depicts the real-time digital asset-based interaction loop steps of the interaction.

The method begins with steps 1a-1b (which may occur concurrently or in a different order (e.g., step 1b occurs slightly before step 1a)) where at step 1a, the digital asset-based payment with the amount increase request is initiated between the user computing device 12 and the bi-directional digital asset POS computing device 14 via the interface means 18. For example, the user computing device 12 may select to pay the bi-directional digital asset POS computing device 14 via an entity selection/interaction options module of the digital asset-based interaction interface 25-1 (e.g., via a network connection interface means) and select a further option to increase the amount.

At step 1b, the bi-directional digital asset POS computing device 14 obtains an amount of first user desired assets from the user computing device 12. The bi-directional digital asset POS computing device 14 may receive the amount of first user desired assets directly from the user computing device 12 (e.g., a user of the user computing device 12 inserts fiat currency into the bi-directional digital asset POS computing device 14) and/or the bi-directional digital asset POS computing device 14 directs the amount of the first user desired assets to the digital asset-based interaction computing entity 16. For example, the bi-directional digital asset POS computing device 14 presents a code on a display of the bi-directional digital asset POS computing device 14 where, when the code is scanned by the user computing device, the first user desired assets are sent to an address associated with the digital asset-based interaction computing entity 16.

In another example, the bi-directional digital asset POS computing device 14 obtains the amount of the first user desired assets from the user computing device 12 at step 4b (i.e., at a time prior to the exchange) which may occur concurrently or in a different order than step 4 discussed below (e.g., step 4b occurs slightly before step 4)).

The method continues with step 2, where the bi-directional digital asset POS computing device 14 sends real-time information regarding the interaction to the digital asset-based interaction computing entity 16. The real-time information includes bi-directional digital asset POS computing device real-time information and may also include user computing device real-time information where the bi-directional digital asset POS computing device 14 obtains user computing device real-time information from the user computing device 12 via the interface means 18. In another example, the user computing device 12 sends user computing device real-time information regarding the interaction to the digital asset-based interaction computing entity 16 and the bi-directional digital asset POS computing device 14 sends bi-directional digital asset POS computing device real-time information to the digital asset-based interaction computing entity 16.

The real-time information includes one or more identifiers (e.g., a user ID, a merchant ID, a terminal ID of the bi-directional digital asset POS computing device 14), a type of the digital asset-based interaction (e.g., the digital asset-based payment with an amount increase request), a type of the first user desired assets (e.g., a user desired fiat currency, a user desired digital asset, a merchant desired fiat currency, and/or a merchant desired digital asset), a type of a second user desired asset that the user computing device 12 wishes to receive the amount increase in (e.g., a user desired fiat currency, a user desired digital asset), a type of a merchant desired asset (e.g., a merchant desired fiat currency, and/or a merchant desired digital asset), an amount of the payment, and/or an amount of the amount increase. The real-time information may include further information and/or metadata such as transaction fees, loyalty information, personal information (address, name, etc.), shipping details, bill splitting information, a request for additional information, etc.

The method continues with step 3 where, based on the interaction initiation (e.g., receiving the real-time information), the digital asset-based interaction computing entity 16 locks an amount of system digital assets 132 stored by the digital asset backing computing entity 20 to back the interaction. The amount of system digital asset locked may be based on one or more of an amount involved in the interaction, a type of asset involved in the interaction, a type of the interaction, a type of item involved in the interaction, the user computing device 12 (e.g., a typical amount the user computing device 12 spends, an account balance, trading behavior of the user computing device, etc.), and the bi-directional digital asset POS computing device 14 (e.g., the type of merchant the bi-directional digital asset POS computing device 14 is associated with, a type of goods the merchant sells, a default amount set by the merchant, etc.).

When the digital asset-based interaction computing entity 16 locks the system digital asset, rate quotes for the first user desired assets to second user desired assets exchange and the first user desired assets to the merchant desired assets exchange may also be locked. The digital asset-based interaction computing entity 16 connects to or maintains a connection to the one or more digital asset exchange computing entities 91 to obtain the rate quote and is operable to adjust the rate quotes according to an asset's availability on the exchange. The digital asset-based interaction computing entity 16 may lock the rate quote based on a tolerance window acceptable to the user of the user computing device 12. For example, the rate quote may be higher than a current rate quote if a longer window of time is provided to the user computing device to receive funds is longer. As another example, once a user authorizes a digital asset-based interaction, the first desired assets may be exchanged by the digital asset-based interaction computing entity 16 (via the one or more digital asset exchange computing entities 91) on credit (even if it has not been received yet) with the exchange to ensure a particular rate quote. Once the amount of the first user desired assets is received from the user computing device 12, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the digital asset-based payment) for a substantially equivalent amount of assets in a second desired asset format. When the amount of first user desired assets are received by the digital asset-based interaction computing entity 16, the digital asset-based interaction computing entity 16 is operable to exchange (via the one or more digital asset exchange computing entities 91) the amount of the first user desired assets to the substantially equivalent amount of the smart contract compatible token used to cover the real-time digital asset exchange.

The method continues with step 4 and step 4b (when applicable). At step 4, the bi-directional digital asset POS computing device 14 receives a confirmation from the digital asset-based interaction computing entity 16 that the amount of system digital assets have been locked to back the interaction. If the interaction is terminated (e.g., digital asset-based interaction initiation fails and/or is cancelled by the user computing device 12 and/or the bi-directional digital asset POS computing device 14) prior to step 5 (i.e., no exchanged has occurred), the interaction is terminated and the digital asset-based interaction computing entity 16 instructs the digital asset backing computing entity 20 to release the amount of locked system digital assets. If the first user desired assets have been obtained prior to the termination, the transaction can be cancelled and/or the user computing device can be refunded (e.g., in the situation where the user computing device deposits fiat currency into the bi-directional digital asset POS computing device 14).

The method continues at step 5 where the digital asset-based interaction computing entity 16 connects to the one or more exchanging computing entities 91 of the digital asset-based interaction system to exchange the payment amount of the first user desired assets to a payment amount of merchant desired assets where the payment amount of the first user desired assets is substantially equivalent to the payment amount of the merchant desired assets. The digital asset-based interaction computing entity 16 also connects to the one or more exchanging computing entities 91 of the digital asset-based interaction system to exchange the increase amount of the first user desired assets to an increase amount of second user desired assets where the increase amount of the first user desired assets is substantially equivalent to the increase amount of the second user desired assets. The digital asset exchange occurs quickly (e.g., 30 seconds to a few minutes) to account for exchange rate volatility and so that the bi-directional digital asset POS computing device 14 can provide and/or obtain desired assets in real-time.

When the bi-directional digital asset POS computing device 14 is operable to obtain fiat currency directly from the user computing device 12 as the first user desired asset, the bi-directional digital asset POS computing device 14 maintains an account with the digital asset-based interaction computing entity 16 such that the digital asset-based interaction computing entity 16 can access funds from the bi-directional digital asset POS computing device 14 account for the exchange. The merchant associated with bi-directional digital asset POS computing device 14 would then balance the accounting with the bi-directional digital asset POS computing device 14's account and the fiat currency received and stored within the with bi-directional digital asset POS computing device 14.

The method continues with steps 6a-6b which may occur concurrently or in a different order (e.g., step 6b occurs slightly before step 6a). At step 6a, the bi-directional digital asset POS computing device 14 distributes the increase amount of the second desired user assets to the user computing device 12. For example, the bi-directional digital asset POS computing device 14 sends the increase amount of the second user desired assets to a location associated with the user computing device 12 (e.g., information in the real-time information directs the amount of the second desired user assets from the digital asset-based interaction computing entity 16 (or one or more exchange entities) to a location associated with the user computing device 12, etc.). For example, the bi-directional digital asset POS computing device 14 directs the increase amount of the second user desired assets to an address of the asset management unit 22 of the user computing device 12. As another example, the bi-directional digital asset POS computing device 14 sends the increase amount of the second user desired assets to an address associated with a friend, family member, business associate, client, etc., of a user of the user computing device 12.

As another example, the bi-directional digital asset POS computing device 14 dispenses fiat currency to a user of the user computing device 12. For example, the bi-directional digital asset POS computing device 14 automatically outputs the increase amount of the second user desired assets from fiat storage receptacle (e.g., similar to an automated teller machine (ATM)). As another example, an operator of the bi-directional digital asset POS computing device 14 collects the increase amount of the second user desired assets from the fiat storage receptacle and provides the increase amount of the second user desired assets to a user of the user computing device 12.

In the above examples, the digital asset-based interaction computing entity 16 sends the increase amount of the second user desired assets to the bi-directional digital asset POS computing device 14 (e.g., to a digital asset-based interaction computing entity account associated with the bi-directional digital asset POS computing device 14) and a confirmation to the bi-directional digital asset POS computing device 14 that the fiat currency payment was deposited. Upon receiving the confirmation, the bi-directional digital asset POS computing device 14 outputs stored fiat currency to the user computing device. The merchant associated with the bi-directional digital asset POS computing device 14 would then balance the accounting with the bi-directional digital asset POS computing device 14's account and the fiat currency sent and stored within the with bi-directional digital asset POS computing device 14.

At step 6b, the bi-directional digital asset POS computing device 14 utilizes the payment amount of the merchant desired assets to cover the payment with the user computing device 12. For example, the bi-directional digital asset POS computing device 14 receives the payment amount of the merchant desired assets from the user computing device 12 (e.g., where the digital asset-based interaction computing entity 16 provides the payment amount of the merchant desired assets to the bi-directional digital asset POS computing device 14, to an address associated with a merchant associated with the bi-directional digital asset POS computing device 14, and/or to a merchant banking device associated with the bi-directional digital asset POS computing device 14).

In an alternative embodiment, the digital asset-based payment with the amount increase request occurs as two processes where the digital asset-based payment is processed first, similarly to the methods of FIG. 10 or 10A, and the increase amount request is processed second, similarly to the method of FIG. 18 (without the payment related steps such as step 6b). When the digital asset-based payment with the amount increase request occur as two processes, the digital asset-based interaction computing entity 16 may adjust the lock on the system digital asset when processing the increase amount request to back the amount increase request along with the digital asset-based payment and to send a confirmation to the bi-directional digital asset POS computing device 14 that the amount increase request is approved (i.e., authorized).

FIG. 19 is a flowchart of an example of a method of a digital asset-based payment with an amount increase request nonreal-time digital asset-based interaction loop of a digital asset-based interaction system. FIG. 19 includes the digital asset-based interaction computing entity 16, the digital asset backing computing entity 20, and one or more digital asset consensus network computing entities 45 of the digital asset-based interaction system and depicts the nonreal-time digital asset-based interaction loop 30 of the digital asset-based payment with an amount increase request.

The nonreal-time digital asset-based interaction loop 30 (e.g., reconciliation of the digital asset-based interaction with the digital asset backing computing entity 20) occurs simultaneously with the real-time digital asset-based interaction loop 28 of FIG. 18, however; the nonreal-time digital asset-based interaction loop 30 occurs within a time frame that is longer than the time frame of the real-time digital asset-based interaction loop. For example, reconciliation of the digital asset-based interaction with the digital asset backing computing entity 20 occurs over the course of minutes whereas the time frame of the real-time digital asset-based interaction loop takes a few seconds.

The method begins at step 1, where when the payment amount and the increase amount of first user desired assets are obtained, the digital asset-based interaction computing entity 16 connects to the one or more digital asset consensus network computing entities 45 to verify the payment amount and the increase amount of the first user desired assets received from the user computing device 12. The one or more digital asset consensus network computing entities 45 implement a verification process that may take minutes to hours of time.

For example, when the first user desired asset is a cryptocurrency hosted on a blockchain, the digital asset-based interaction computing entity 16 connects to the blockchain associated with the cryptocurrency to verify whether a certain amount of blocks including transaction of sending the payment amount and the increase amount of the first desired assets from the user computing device 12 have been added to the blockchain (e.g., a certain amount of confirmations are obtained). Other asset verification processes are possible and are based on the type of asset involved.

When the first user desired asset is a fiat currency obtained by the bi-directional digital asset POS computing device 14 directly from the user computing device 12, the digital asset-based interaction computing entity 16 accesses funds from an account associated with the bi-directional digital asset POS computing device 14 for the exchange. If the funds are stored by the digital asset-based interaction computing entity 16, the verification process may not be necessary. However, when the funds are not stored by the digital asset-based interaction computing entity 16, the digital asset-based interaction computing entity 16 may need to perform a verification process on the received assets (e.g., when the account associated with the bi-directional digital asset POS computing device 14 stores digital assets for a digital asset to fiat exchange).

The method continues with steps 2a or 2b. At step 2a, when the payment amount and the increase amount of the first user desired assets are verified (or received via a method that does not involve the verification process), the digital asset-based interaction computing entity 16 instructs the digital asset backing computing entity 20 to unlock the locked amount of system digital assets.

At step 2b, when the payment amount and the increase amount of the first user desired assets are not verified (or not received via a method that does not involve the verification process), the digital asset-based interaction computing entity 16 instructs the digital asset backing computing entity 20 to consume the locked amount of system digital assets. Consuming the amount of system digital asset means that the digital asset backing computing entity 20 transfers the amount of system digital assets to an address controlled by the digital asset-based interaction computing entity 16 in order to cover the amount of the digital asset-based interaction.

FIGS. 20A-20B are schematic block diagrams of an embodiment of a bi-directional digital asset point of sale (POS) computing device 14 of a digital asset-based interaction system. The bi-directional digital asset POS computing device 14 includes a digital asset POS module 90, a display 86, and one or more scanning devices 84 and operates similarly to the bi-directional digital asset POS computing device 14 of previous Figures. The digital asset point POS module 90 includes a digital asset-based interaction interface 25-2 that interfaces with the digital asset-based interaction computing entity. A simplified user interface perspective of the digital asset-based interaction interface 25-2 is shown to include a user interaction options module 98.

As shown in FIG. 20A, the user interaction options module 98 includes digital asset-based payment options 114, amount increase options 112, digital asset sale options 116, and digital asset purchase options 118. In this example, a user of the user computing device 12 interacts with the bi-directional digital asset POS computing device 14 to display the digital asset sale options 116 (e.g., selected an option to the display the digital asset sale options 116 using a touchscreen interface of the bi-directional digital asset POS computing device 14, etc.). The digital asset sale options 116 are shown to include a plurality of types of digital assets the bi-directional digital asset POS computing device 14 is operable to facilitate a sale of (e.g., as determined by the digital asset-based interaction computing entities ability to exchange those digital assets and/or based on the preferences of the bi-directional digital asset POS computing device 14). The digital asset sale options 116 may include a search function for the user to search for a particular type of digital asset. In another embodiment, the user computing device provides information to the bi-directional digital asset POS computing device 14 (e.g., a user identifier, account login information, etc.) such that the options displayed are personalized to the user computing device 12. For example, the user computing device 12 may only store Bitcoin and Ether in its asset management unit and therefore only those two digital asset options are presented to the user. The user in this example selects the option to sell the digital asset Bitcoin.

In FIG. 20B the simplified user interface perspective of the digital asset-based interaction interface 25-2 is shown to include the user interaction options module 98 and a code module 100. The code module 100 is operable to obtain codes (e.g., via the scanning devices, via the digital asset-based interaction computing entity, etc.), interpret codes, and display codes via the display 86.

After the user selects the type of digital asset for sale, the user may be prompted to select an asset format for payment (“payment asset format”). In FIG. 20B, the digital asset sale options 116 are shown to include a plurality of types of assets the bi-directional digital asset POS computing device 14 is operable to provide the user computing device as payment for the digital asset sale. The digital asset sale options 116 may include a search function for the user to search for a particular type of payment asset format. The digital asset sale options 116 may be operable to display an exchange rate for the digital asset selected to the payment asset format by receiving exchange rate information from the digital asset-based interaction computing entity. In another embodiment, when the user computing device provides information to the bi-directional digital asset POS computing device 14, the user computing device 12 may share a preferred payment asset format such that the bi-directional digital asset POS computing device 14 does not display payment asset format options and the preferred payment asset format option is automatically selected. In this example, the user selects the payment asset format of Ether.

After the user has specified the type of digital asset for sale and the payment asset format, the code module 100 displays a code with a prompt for the user to scan the code with the user computing device. The code includes an address associated with the bi-directional digital asset POS computing device 14, information pertaining to the digital asset sale (e.g., type of digital asset, exchange rates, transaction fees, transaction amount limits, etc.), and/or requests for information (e.g., an amount of digital assets for sale, personal information, etc.).

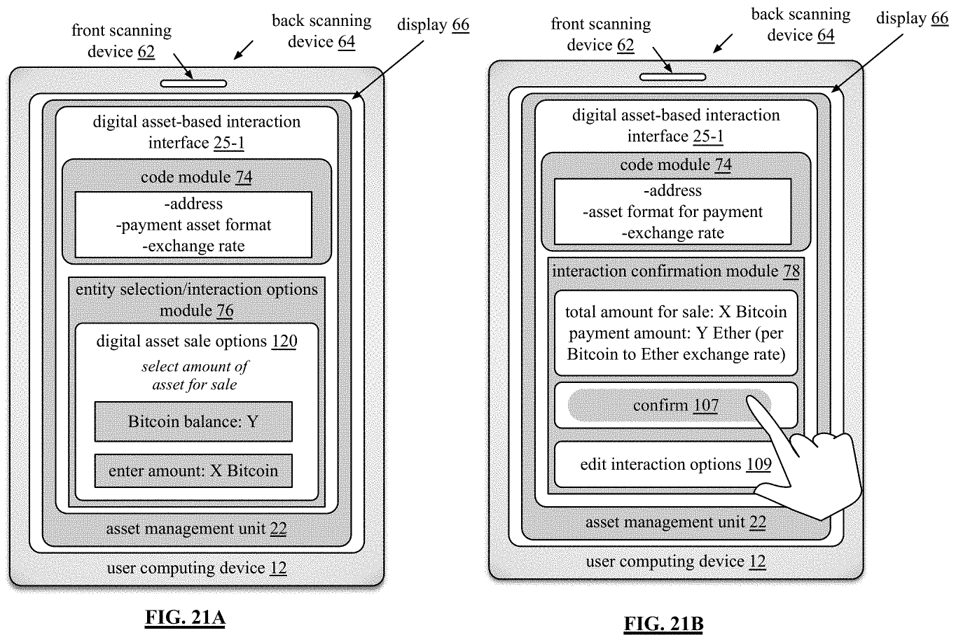

FIGS. 21A-21B are schematic block diagrams of embodiments of a user computing device 12 of a digital asset-based interaction system. The user computing device 12 includes an asset management unit 22, a display 66, a front scanning device 62, and a back scanning device 64 and operates similarly to the user computing device 12 of previous Figures. The asset management unit 22 includes a digital asset-based interaction interface 25-1 that interfaces with the digital asset-based interaction computing entity. FIGS. 21A-21B continue the example of FIGS. 20A-20B where the user computing device 12 scanned the code presented by the bi-directional digital asset POS computing device 14 via the front or back scanning device 62-64.

In FIG. 21A, a simplified view of the digital asset-based interaction interface 25-1 is shown including a code module 74 and an entity selection/interaction options module 76. The code module 74 interprets information from the scanned code and may display that information on the display 66. For example, an address of where to send the digital assets, the selected asset format, and/or the exchange rate for the digital asset selected to the payment asset format may be shown. In another example, the digital asset-based interaction interface 25-1 connects to the digital asset-based interaction computing entity to obtain the exchange rate for the digital asset selected to the payment asset format.

When the code is scanned, the entity selection/interaction options module 76 may display interaction options associated with the information obtained from the code. For example, the digital asset sale options 120 present an option for the user to input the amount of the digital asset for sale. In this example, the digital asset sale options 120 connect to the asset depository and/or acceptance unit to display the balance of the digital asset selected. As shown, a Bitcoin balance of Y Bitcoin is displayed and the user enters an amount of X Bitcoin to sell.

In FIG. 21B, a simplified view of the digital asset-based interaction interface 25-1 is shown including a code module 74 and an interaction confirmation module 78. The interaction confirmation module 78 presents the amount of Bitcoin for sale (e.g., X Bitcoin) and the amount of the payment the user computing device 12 will receive for the sale (e.g., Y Ether as per the Bitcoin to Ether exchange rate). The total amount for sale may be increased by a transaction fee charged by the bi-directional digital asset POS computing device 14. The interaction confirmation module 78 presents an option to confirm 107 the interaction or choose to edit interaction options 109 (e.g., select a different digital asset for sale, select a different amount, etc.). In this example, the user selects to confirm 107 the interaction which would send the X Bitcoin to the address provided in the code.

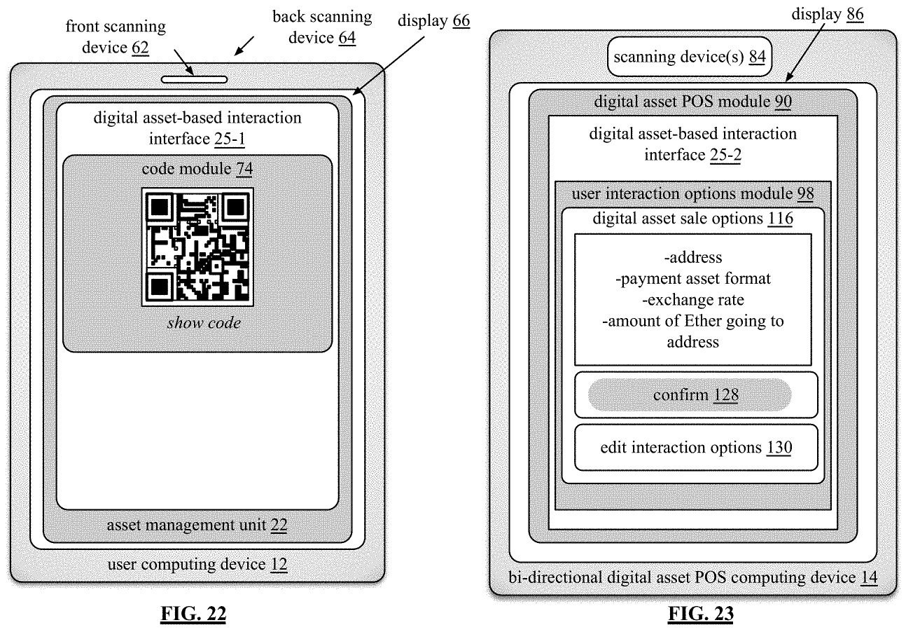

FIG. 22 is a schematic block diagram of an embodiment of a user computing device 12 of a digital asset-based interaction system. The user computing device 12 includes an asset management unit 22, a display 66, a front scanning device 62, and a back scanning device 64 and operates similarly to the user computing device 12 of previous Figures. The asset management unit 22 includes a digital asset-based interaction interface 25-1 that interfaces with the digital asset-based interaction computing entity. The digital asset-based interaction interface 25-1 in this example includes the code module 74. The code module 74 is operable to obtain codes (e.g., via the scanning devices, via the digital asset-based interaction computing entity, etc.), interpret codes, and display codes via the display 66. FIG. 22 continues the example of FIGS. 20A-21B where the code module 74 displays a code to the bi-directional digital asset POS computing device 14 to accept the payment from the digital asset sale.

When the user is not receiving fiat currency directly from the bi-directional digital asset POS computing device 14 for the sale, after the user has confirmed the interaction, the code module 74 displays a code with a prompt for the user to show the code to the bi-directional digital asset POS computing device 14. The code includes an address associated with the user computing device 12, information pertaining to the digital asset sale (e.g., type of digital asset, exchange rates, transaction fees, etc.), and/or other information (e.g., personal information). The address associated with the user computing device 12 may be an address of the asset depository and/or acceptance unit, an address of a digital wallet associated with the user computing device 12, and/or an address associated with a different user as specified by the user computing device (e.g., a family member, colleague, associate, merchant, etc.).

FIG. 23 is a schematic block diagram of an embodiment of a bi-directional digital asset point of sale (POS) computing device 14 of the digital asset-based interaction system. The bi-directional digital asset POS computing device 14 includes a digital asset POS module 90, a display 86, and one or more scanning devices 84 and operates similarly to the bi-directional digital asset POS computing device 14 of previous Figures. The digital asset point POS module 90 includes a digital asset-based interaction interface 25-2 that interfaces with the digital asset-based interaction computing entity. A simplified user interface perspective of the digital asset-based interaction interface 25-2 is shown to include a user interaction options module 98. FIG. 23 continues the example of FIG. 22 where the bi-directional digital asset POS computing device 14 scanned the code presented by the user computing device 12 via the one or more scanning devices 84.

The digital asset sale options 116 of the user interaction options module 98 may present the information obtained from the code (e.g., the address associated with the user, the payment asset format (e.g., Ether), the exchange rate, the amount of Ether going to the address based on the exchange rate, etc.). The user interaction options module 98 may allow the user computing device 12 to confirm 128 the information or edit the interaction options 130. In another embodiment, scanning the code automatically sends the amount of the payment assets to the address associated with the user computing device 12. In this example, the user has selected to confirm 128 the interaction.

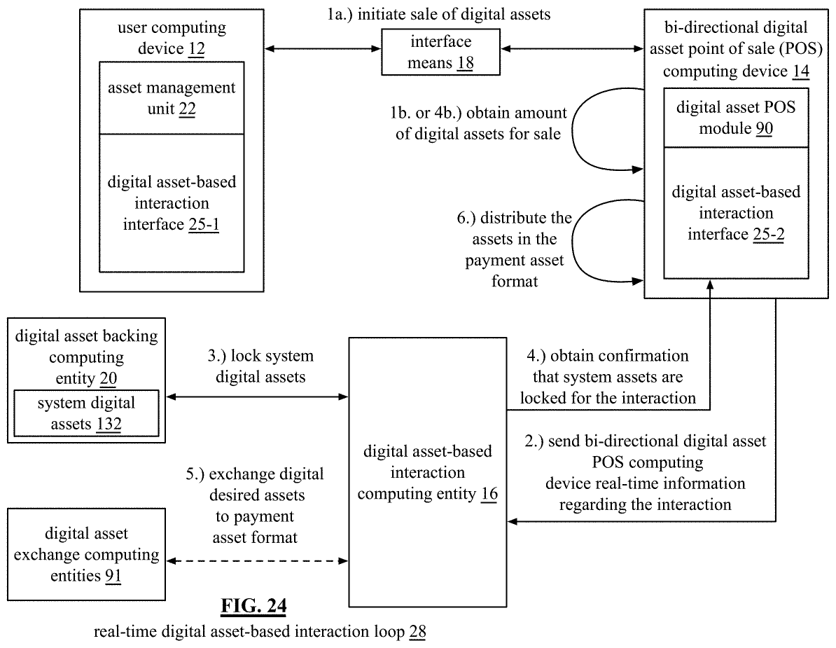

FIG. 24 is a flowchart of an example of a method of a digital asset sale real-time digital asset-based interaction loop of a digital asset-based interaction system. FIG. 24 includes the user computing device 12, the bi-directional digital asset POS computing device 14, the digital asset-based interaction computing entity 16, the digital asset backing computing entity 20, and the one or more digital asset exchange computing entities 91 of the digital asset-based interaction system and depicts the real-time digital asset-based interaction loop steps of the interaction.

The method begins with steps 1a-1b (which may occur concurrently or in a different order (e.g., step 1b occurs slightly before step 1a)) where at step 1a, the digital asset sale is initiated between the user computing device 12 and the bi-directional digital asset POS computing device 14 via the interface means 18. For example, the user computing device 12 may use prompts displayed on the bi-directional digital asset POS computing device 14 (e.g., as discussed with reference to FIGS. 20A-23) to initiate the digital asset sale.

At step 1b, the bi-directional digital asset POS computing device 14 obtains an amount of digital assets for sale from the user computing device 12. The bi-directional digital asset POS computing device 14 receives the amount of the digital assets for sale by directing the amount of the digital assets to the digital asset-based interaction computing entity 16. For example, the bi-directional digital asset POS computing device 14 presents a code on a display of the bi-directional digital asset POS computing device 14 where, when the code is scanned by the user computing device, the amount of the digital assets are sent to an address associated with the bi-directional digital asset POS computing device 14 and the digital asset-based interaction computing entity 16.

In another example, the bi-directional digital asset POS computing device 14 obtains the amount of the first user desired assets from the user computing device 12 at step 4b (i.e., at a time prior to the exchange) which may occur concurrently or in a different order than step 4 discussed below (e.g., step 4b occurs slightly before step 4)).

When the digital asset sale is initiated, the method continues with step 2, where the bi-directional digital asset POS computing device 14 sends real-time information regarding the interaction to the digital asset-based interaction computing entity 16. The real-time information includes bi-directional digital asset POS computing device real-time information and may also include user computing device real-time information where the bi-directional digital asset POS computing device 14 obtains user computing device real-time information from the user computing device 12 via the interface means 18. In another example, the user computing device 12 sends user computing device real-time information regarding the interaction to the digital asset-based interaction computing entity 16 and the bi-directional digital asset POS computing device 14 sends bi-directional digital asset POS computing device real-time information to the digital asset-based interaction computing entity 16.

The real-time information includes one or more identifiers (e.g., a user ID, a merchant ID, a terminal ID of the bi-directional digital asset POS computing device 14), a type of the digital asset-based interaction (e.g., the digital asset sale), a type of the digital asset, a payment asset format (e.g., a desired fiat currency, and/or a desired digital asset), and an amount of the digital assets. The real-time information may include further information and/or metadata such as transaction fees, loyalty information, personal information (address, name, etc.), a request for additional information, etc.

The method continues with step 3, where based on the interaction initiation and the real-time information, the digital asset-based interaction computing entity 16 locks an amount of system digital assets 132 stored by the digital asset backing computing entity 20 to back the interaction. The amount of system digital asset locked may be based on one or more of an amount involved in the interaction, a type of asset involved in the interaction, a type of the interaction, a type of item involved in the interaction, the user computing device 12 (e.g., a typical amount the user computing device 12 spends, an account balance, trading behavior of the user computing device, etc.), and the bi-directional digital asset POS computing device 14 (e.g., the type of merchant the bi-directional digital asset POS computing device 14 is associated with, a type of goods the merchant sells, a default amount set by the merchant, etc.).

When the digital asset-based interaction computing entity 16 locks the system digital asset, rate quotes for the digital asset to payment asset format may also be locked. The digital asset-based interaction computing entity 16 connects to or maintains a connection to the one or more digital asset exchange computing entities 91 to obtain the rate quote and is operable to adjust the rate quotes according to an asset's availability on the exchange. The digital asset-based interaction computing entity 16 may lock the rate quote based on a tolerance window acceptable to the user of the user computing device 12. For example, the rate quote may be higher than a current rate quote if a longer window of time is provided to the user computing device to receive funds is longer. As another example, once a user authorizes a digital asset-based interaction, the digital assets may be exchanged by the digital asset-based interaction computing entity 16 (via the one or more digital asset exchange computing entities 91) on credit (even if it has not been received yet) with the exchange to ensure a particular rate quote. Once the amount of the digital assets is received from the user computing device 12, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the digital asset-based payment) for a substantially equivalent amount of assets in the payment asset format. When the amount of digital assets are received by the digital asset-based interaction computing entity 16, the digital asset-based interaction computing entity 16 is operable to exchange (via the one or more digital asset exchange computing entities 91) the amount of the digital assets to the substantially equivalent amount of the smart contract compatible token used to cover the real-time digital asset exchange.

The method continues with step 4 and step 4b (when applicable). At step 4, the bi-directional digital asset POS computing device 14 receives a confirmation from the digital asset-based interaction computing entity 16 that the amount of system digital assets have been locked to back the interaction. If the interaction is terminated (e.g., digital asset-based interaction initiation fails and/or is cancelled by the user computing device 12 and/or the bi-directional digital asset POS computing device 14) prior to step 5 (i.e., no exchanged has occurred), the interaction is terminated and the digital asset-based interaction computing entity 16 instructs the digital asset backing computing entity 20 to release the amount of locked system digital assets. If the digital assets have been obtained prior to the termination, the transaction can be cancelled.

The method continues at step 5 where the digital asset-based interaction computing entity 16 connects to the one or more exchanging computing entities 91 of the digital asset-based interaction system to exchange the amount of the digital assets to a payment amount of assets in the payment asset format where the payment amount of assets in the payment asset format is substantially equivalent to the amount of the digital assets. The digital asset exchange occurs quickly (e.g., 30 seconds to a few minutes) to account for exchange rate volatility and so that the bi-directional digital asset POS computing device 14 can provide and/or obtain desired assets in real-time.

The method continues with step 6 where the bi-directional digital asset POS computing device 14 distributes the payment amount of assets in the payment asset format to the user computing device 12. For example, the bi-directional digital asset POS computing device 14 sends the payment amount of assets in the payment asset format to a location associated with the user computing device 12 (e.g., information in the real-time information (obtained via scanning a code from the user computing device) directs the payment amount of assets in the payment asset format from the digital asset-based interaction computing entity 16 (or one or more exchange entities) to a location associated with the user computing device 12, etc.). For example, the bi-directional digital asset POS computing device 14 directs the payment amount of assets in the payment asset format to an address of the asset management unit 22 of the user computing device 12. As another example, the bi-directional digital asset POS computing device 14 sends the payment amount of assets in the payment asset format to an address associated with a friend, family member, business associate, client, etc., of a user of the user computing device 12.

As another example, the bi-directional digital asset POS computing device 14 dispenses fiat currency to a user of the user computing device 12. For example, the bi-directional digital asset POS computing device 14 automatically outputs the payment amount of assets in the payment asset format from fiat storage receptacle (e.g., similar to an automated teller machine (ATM)). As another example, an operator of the bi-directional digital asset POS computing device 14 collects the payment amount of assets in the payment asset format from the fiat storage receptacle and provides the payment amount of assets in the payment asset format to a user of the user computing device 12.

In the above examples, the digital asset-based interaction computing entity 16 sends the payment amount of assets in the payment asset format to the bi-directional digital asset POS computing device 14 (e.g., to a digital asset-based interaction computing entity account associated with the bi-directional digital asset POS computing device 14) and a confirmation to the bi-directional digital asset POS computing device 14 that the fiat currency payment was deposited. Upon receiving the confirmation, the bi-directional digital asset POS computing device 14 outputs stored fiat currency to the user computing device. The merchant associated with the bi-directional digital asset POS computing device 14 would then balance the accounting with the bi-directional digital asset POS computing device 14's account and the fiat currency sent and stored within the with bi-directional digital asset POS computing device 14.

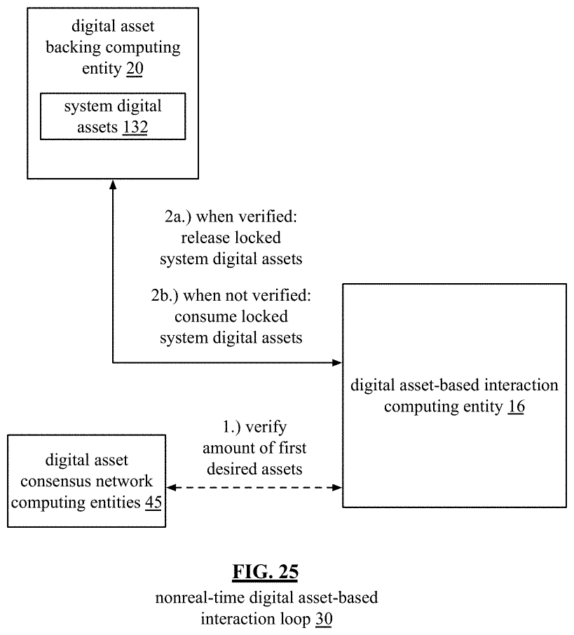

FIG. 25 is a flowchart of an example of a method of a digital asset sale nonreal-time digital asset-based interaction loop of a digital asset-based interaction system. FIG. 25 includes the digital asset-based interaction computing entity 16, the digital asset backing computing entity 20, and one or more digital asset consensus network computing entities 45 of the digital asset-based interaction system and depicts the nonreal-time digital asset-based interaction loop 30 of the digital asset sale of FIG. 24.

The nonreal-time digital asset-based interaction loop 30 (e.g., reconciliation of the digital asset-based interaction with the digital asset backing computing entity 20) occurs simultaneously with the real-time digital asset-based interaction loop 28 of FIG. 24, however; the nonreal-time digital asset-based interaction loop 30 occurs within a time frame that is longer than the time frame of the real-time digital asset-based interaction loop. For example, reconciliation of the digital asset-based interaction with the digital asset backing computing entity 20 occurs over the course of minutes whereas the time frame of the real-time digital asset-based interaction loop takes a few seconds.

The method begins at step 1, where when the amount of digital assets for sale are obtained, the digital asset-based interaction computing entity 16 connects to the one or more digital asset consensus network computing entities 45 to verify the amount of digital assets for sale received from the user computing device 12. The one or more digital asset consensus network computing entities 45 implement a verification process that may take minutes to hours of time.

For example, when the digital asset is a cryptocurrency hosted on a blockchain, the digital asset-based interaction computing entity 16 connects to the blockchain associated with the cryptocurrency to verify whether a certain amount of blocks including transaction of sending the payment amount and the increase amount of the first desired assets from the user computing device 12 have been added to the blockchain (e.g., a certain amount of confirmations are obtained). Other asset verification processes are possible and are based on the type of asset involved.

The method continues with steps 2a or 2b. At step 2a, when the amount of digital assets for sale are verified (or received via a method that does not involve the verification process), the digital asset-based interaction computing entity 16 instructs the digital asset backing computing entity 20 to unlock the locked amount of system digital assets.

At step 2b, when the amount of digital assets for sale are not verified (or not received via a method that does not involve the verification process), the digital asset-based interaction computing entity 16 instructs the digital asset backing computing entity 20 to consume the locked amount of system digital assets. Consuming the amount of system digital asset means that the digital asset backing computing entity 20 transfers the amount of system digital assets to an address controlled by the digital asset-based interaction computing entity 16 in order to cover the amount of the digital asset-based interaction.

FIGS. 26A-26B are schematic block diagrams of an embodiment of a bi-directional digital asset point of sale (POS) computing device 14 of the digital asset-based interaction system. The bi-directional digital asset POS computing device 14 includes a digital asset POS module 90, a display 86, and one or more scanning devices 84 and operates similarly to the bi-directional digital asset POS computing device 14 of previous Figures. The digital asset point POS module 90 includes a digital asset-based interaction interface 25-2 that interfaces with the digital asset-based interaction computing entity. A simplified user interface perspective of the digital asset-based interaction interface 25-2 is shown to include a user interaction options module 98.

As shown in FIG. 26A, the user interaction options module 98 includes digital asset-based payment options 114, amount increase options 112, digital asset sale options 116, and digital asset purchase options 118. In this example, a user of the user computing device 12 interacts with the bi-directional digital asset POS computing device 14 to display the digital asset purchase options 118 (e.g., the user selected an option to the display the digital asset sale options 118 using a touchscreen interface of the bi-directional digital asset POS computing device 14, etc.). The digital asset purchase options 118 are shown to include a plurality of types of digital assets the bi-directional digital asset POS computing device 14 is operable to facilitate a purchase of (e.g., as determined by the digital asset-based interaction computing entities ability to exchange those digital assets and/or based on the preferences of the bi-directional digital asset POS computing device 14). The digital asset purchase options 118 may include a search function for the user to search for a particular type of digital asset.

In FIG. 26B the simplified user interface perspective of the digital asset-based interaction interface 25-2 is shown to include the user interaction options module 98 and a code module 100. The code module 100 is operable to obtain codes (e.g., via the scanning devices, via the digital asset-based interaction computing entity, etc.), interpret codes, and display codes via the display 86. The user in this example selects the option to purchase the digital asset Bitcoin.

After the user selects the type of digital asset for purchase, the user may be prompted to select an asset format for performing the purchase (“purchase asset format”). In FIG. 26B, the digital asset purchase options 118 are shown to include a plurality of types of assets the bi-directional digital asset POS computing device 14 is operable to accept from the user computing device to purchase digital assets. The digital asset purchase options 118 may include a search function for the user to search for a particular type of purchase asset format. In another embodiment, the user computing device provides information to the bi-directional digital asset POS computing device 14 (e.g., a user identifier, account login information, etc.) such that the options displayed are personalized to the user computing device 12. For example, the user computing device 12 may only store Bitcoin and Ether in its asset management unit and therefore only those two purchase asset format options are presented to the user.

The digital asset purchase options 118 may be operable to display an exchange rate for the digital asset selected to the purchase asset format by receiving exchange rate information from the digital asset-based interaction computing entity. In another embodiment, when the user computing device provides information to the bi-directional digital asset POS computing device 14, the user computing device 12 may share a preferred purchase asset format such that the bi-directional digital asset POS computing device 14 does not display purchase asset format options and the preferred purchase asset format option is automatically selected. In this example, the user selects the purchase asset format of Ether.

After the user selects the purchase asset format (or a default purchase asset format is used/known), the code module 100 shares an exchange rate for the purchase asset format to the type of digital assets and any fees owed for the transaction. The code module 100 prompts the user to present a code.

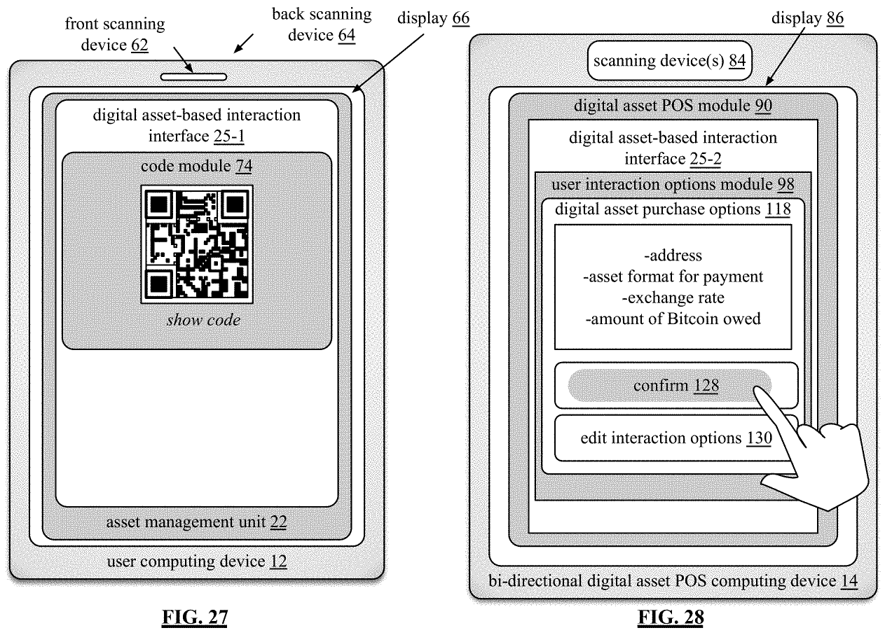

FIG. 27 is a schematic block diagram of an embodiments of a user computing device 12 of a digital asset-based interaction system. The user computing device 12 includes an asset management unit 22, a display 66, a front scanning device 62, and a back scanning device 64 and operates similarly to the user computing device 12 of previous Figures. The asset management unit 22 includes a digital asset-based interaction interface 25-1 that interfaces with the digital asset-based interaction computing entity. FIG. 27 continues the example of FIGS. 26A-26B where the code module 74 of the user computing device 12 where when the user is not providing fiat currency directly to the bi-directional digital asset POS computing device 14 for the purchase, after the user has confirmed the interaction, the code module 74 displays a code with a prompt for the user to show the code to the bi-directional digital asset POS computing device 14.

The code includes an address associated with the user computing device 12, information pertaining to the digital asset sale (e.g., type of digital asset, exchange rates, transaction fees, etc.), and/or other information (e.g., personal information). The address associated with the user computing device 12 may be an address of the asset depository and/or acceptance unit, an address of a digital wallet associated with the user computing device 12, and/or an address associated with a different user as specified by the user computing device (e.g., a family member, colleague, associate, merchant, etc.).

For example, if the user has not already, the user would sign into the digital asset-based interaction interface 25-1 to request a code for a digital asset purchase. The digital asset-based interaction computing entity is operable to generate and send the code to the digital asset-based interaction interface 25-1 for the user to display. The code includes an address associated with the user computing device 12 and possibly information pertaining to the digital asset purchase (e.g., type of digital asset, exchange rates, transaction fees, transaction amount limits, etc.) if the user has entered in information pertaining to the purchase on the digital asset-based interaction interface 25-1. scanned the code presented by the bi-directional digital asset POS computing device 14 via the front or back scanning device 62-64.

FIG. 28 is a schematic block diagram of an embodiment of a bi-directional digital asset point of sale (POS) computing device 14 of the digital asset-based interaction system. The bi-directional digital asset POS computing device 14 includes a digital asset POS module 90, a display 86, and one or more scanning devices 84 and operates similarly to the bi-directional digital asset POS computing device 14 of previous Figures. The digital asset point POS module 90 includes a digital asset-based interaction interface 25-2 that interfaces with the digital asset-based interaction computing entity. A simplified user interface perspective of the digital asset-based interaction interface 25-2 is shown to include a user interaction options module 98. FIG. 28 continues the example of FIG. 27 where the bi-directional digital asset POS computing device 14 scanned the code presented by the user computing device 12 via the one or more scanning devices 84.

The digital asset purchase options 118 of the user interaction options module 98 may present the information obtained from the code (e.g., the address associated with the user, the purchase asset format (e.g., Ether), the exchange rate, the amount of Bitcoin going to the address based on the exchange rate, etc.). The user interaction options module 98 may allow the user computing device 12 to confirm 128 the information or edit the interaction options 130. In this example, the user has selected to confirm 128 the interaction.

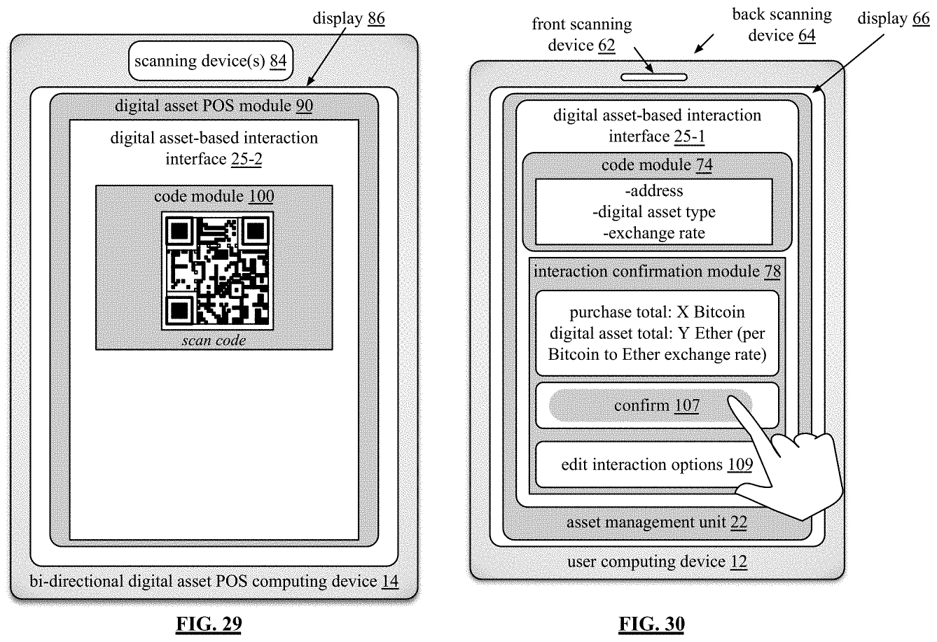

FIG. 29 is a schematic block diagram of an embodiment of a bi-directional digital asset point of sale (POS) computing device 14 of the digital asset-based interaction system. The bi-directional digital asset POS computing device 14 includes a digital asset POS module 90, a display 86, and one or more scanning devices 84 and operates similarly to the bi-directional digital asset POS computing device 14 of previous Figures. The digital asset point POS module 90 includes a digital asset-based interaction interface 25-2 that interfaces with the digital asset-based interaction computing entity. A simplified user interface perspective of the digital asset-based interaction interface 25-2 is shown to include a code module 100. FIG. 29 continues the example of FIG. 28 where the bi-directional digital asset POS computing device 14 after the user has confirmed the details of the purchase, the code module 100 displays a code with a prompt for the user to scan the code with the user computing device.

The code includes an address associated with the bi-directional digital asset POS computing device 14, information pertaining to the digital asset sale (e.g., type of digital asset, exchange rates, transaction fees, transaction amount limits, etc.), and/or requests for information (e.g., an amount of digital assets for sale, personal information, etc.).

FIG. 30 is a schematic block diagram of an embodiment of a user computing device 12 of a digital asset-based interaction system. The user computing device 12 includes an asset management unit 22, a display 66, a front scanning device 62, and a back scanning device 64 and operates similarly to the user computing device 12 of previous Figures. The asset management unit 22 includes a digital asset-based interaction interface 25-1 that interfaces with the digital asset-based interaction computing entity. The digital asset-based interaction interface 25-1 in this example includes the code module 74 and an interaction confirmation module 78. The code module 74 is operable to obtain codes (e.g., via the scanning devices, via the digital asset-based interaction computing entity, etc.), interpret codes, and display codes via the display 66. FIG. 30 continues the example of FIG. 29 where the user computing device 12 scanned the code presented by the bi-directional digital asset POS computing device 14 via a scanning device 64-66.

The code module 74 may present the information obtained from the code (e.g., the address associated with the bi-directional digital asset POS computing device 14, the digital asset type (e.g., Bitcoin), the exchange rate, the amount of Ether needed for the purchase based on the exchange rate, etc.). The interaction confirmation module 78 may present a summary of the interaction (e.g., X amount of Bitcoin is being purchased with Y amount of Ether) and allow the user computing device 12 to confirm 107 the information or edit the interaction options 109. In another embodiment, scanning the code automatically sends the amount of the digital assets owed to the address associated with the bi-directional digital asset POS computing device 14. In this example, the user has selected to confirm 107 the interaction.

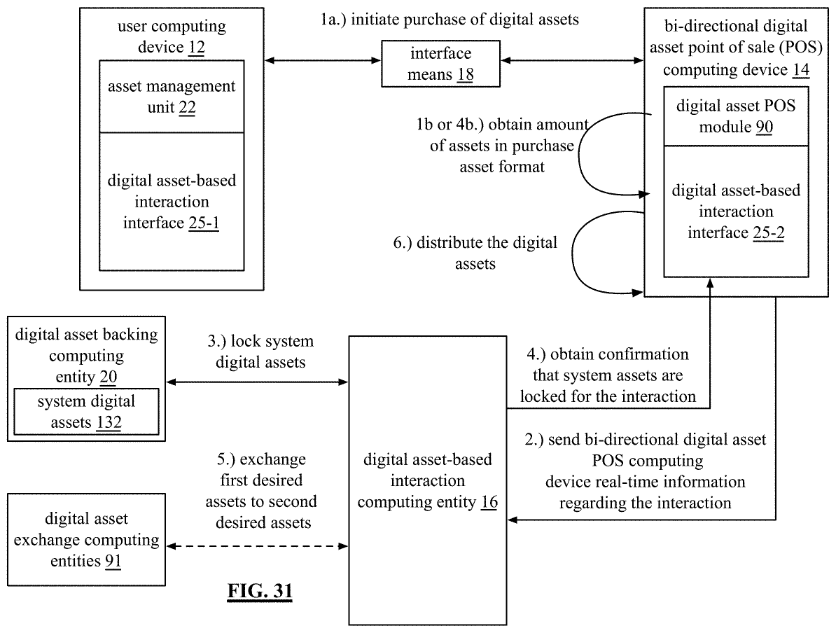

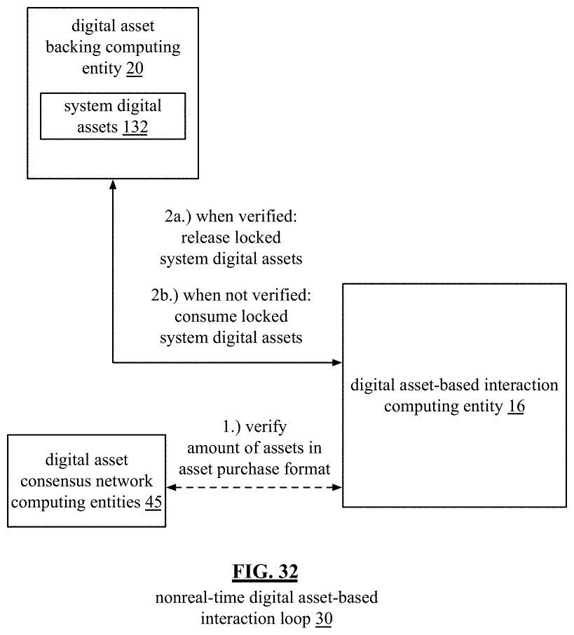

FIG. 31 is a flowchart of an example of a method of a digital asset purchase real-time digital asset-based interaction loop of a digital asset-based interaction system. FIG. 31 includes the user computing device 12, the bi-directional digital asset POS computing device 14, the digital asset-based interaction computing entity 16, the digital asset backing computing entity 20, and the one or more digital asset exchange computing entities 91 of the digital asset-based interaction system and depicts the real-time digital asset-based interaction loop steps of the interaction.

The method begins with steps 1a-1b (which may occur concurrently or in a different order (e.g., step 1b occurs slightly before step 1a)) where at step 1a, the digital asset purchase with is initiated between the user computing device 12 and the bi-directional digital asset POS computing device 14 via the interface means 18. For example, the user computing device 12 may use prompts displayed on the bi-directional digital asset POS computing device 14 (e.g., as discussed with reference to FIGS. 26A-30) to initiate the digital asset purchase.

At step 1b, the bi-directional digital asset POS computing device 14 obtains an amount of assets in a purchase asset format from the user computing device 12. The bi-directional digital asset POS computing device 14 may receive the amount of assets in the purchase asset format directly from the user computing device 12 (e.g., a user of the user computing device 12 inserts fiat currency into the bi-directional digital asset POS computing device 14) and/or the bi-directional digital asset POS computing device 14 directs the amount of assets in the purchase asset format to the digital asset-based interaction computing entity 16. For example, the user computing device 12 presents a code to the bi-directional digital asset POS computing device 14 where, when the code is scanned by the bi-directional digital asset POS computing device 14, the amount of assets in the purchase asset format are sent to an address associated with the bi-directional digital asset POS computing device 14 and the digital asset-based interaction computing entity 16.

In another example, the bi-directional digital asset POS computing device 14 obtains the amount of the first user desired assets from the user computing device 12 at step 4b (i.e., at a time prior to the exchange) which may occur concurrently or in a different order than step 4 discussed below (e.g., step 4b occurs slightly before step 4)).

The method continues with step 2, where the bi-directional digital asset POS computing device 14 sends real-time information regarding the interaction to the digital asset-based interaction computing entity 16. The real-time information includes bi-directional digital asset POS computing device real-time information and may also include user computing device real-time information where the bi-directional digital asset POS computing device 14 obtains user computing device real-time information from the user computing device 12 via the interface means 18. In another example, the user computing device 12 sends user computing device real-time information regarding the interaction to the digital asset-based interaction computing entity 16 and the bi-directional digital asset POS computing device 14 sends bi-directional digital asset POS computing device real-time information to the digital asset-based interaction computing entity 16.

The real-time information includes one or more identifiers (e.g., a user ID, a merchant ID, a terminal ID of the bi-directional digital asset POS computing device 14), a type of the digital asset-based interaction (e.g., the digital asset purchase), the purchase asset format (e.g., a user desired fiat currency, a user desired digital asset), a digital asset type, and an amount of the purchase. The real-time information may include further information and/or metadata such as transaction fees, loyalty information, personal information (address, name, etc.), a request for additional information, etc.

The method continues with step 3, where based on the interaction initiation (e.g., receiving the real-time information), the digital asset-based interaction computing entity 16 locks an amount of system digital assets 132 stored by the digital asset backing computing entity 20 to back the interaction. The amount of system digital asset locked may be based on one or more of an amount involved in the interaction, a type of asset involved in the interaction, a type of the interaction, a type of item involved in the interaction, the user computing device 12 (e.g., a typical amount the user computing device 12 spends, an account balance, trading behavior of the user computing device, etc.), and the bi-directional digital asset POS computing device 14 (e.g., the type of merchant the bi-directional digital asset POS computing device 14 is associated with, a type of goods the merchant sells, a default amount set by the merchant, etc.).

When the digital asset-based interaction computing entity 16 locks the system digital asset, a rate quote for the purchase asset format to the digital asset exchange may also be locked. The digital asset-based interaction computing entity 16 connects to or maintains a connection to the one or more digital asset exchange computing entities 91 to obtain the rate quote and is operable to adjust the rate quotes according to an asset's availability on the exchange. The digital asset-based interaction computing entity 16 may lock the rate quote based on a tolerance window acceptable to the user of the user computing device 12. For example, the rate quote may be higher than a current rate quote if a longer window of time is provided to the user computing device to receive funds is longer. As another example, once a user authorizes a digital asset-based interaction, the assets in the purchase asset format may be exchanged by the digital asset-based interaction computing entity 16 (via the one or more digital asset exchange computing entities 91) on credit (even if it has not been received yet) with the exchange to ensure a particular rate quote. Once the amount of the assets in the purchase asset format is received from the user computing device 12, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the digital asset-based payment) for a substantially equivalent amount of assets in the purchase asset format. When the amount of assets in the purchase asset format are received by the digital asset-based interaction computing entity 16, the digital asset-based interaction computing entity 16 is operable to exchange (via the one or more digital asset exchange computing entities 91) the amount of the assets in the purchase asset format to the substantially equivalent amount of the smart contract compatible token used to cover the real-time digital asset exchange.

The method continues with step 4 and step 4b (when applicable). At step 4, the bi-directional digital asset POS computing device 14 receives a confirmation from the digital asset-based interaction computing entity 16 that the amount of system digital assets have been locked to back the interaction. If the interaction is terminated (e.g., digital asset-based interaction initiation fails and/or is cancelled by the user computing device 12 and/or the bi-directional digital asset POS computing device 14) prior to step 5 (i.e., no exchange has occurred), the interaction is terminated and the digital asset-based interaction computing entity 16 instructs the digital asset backing computing entity 20 to release the amount of locked system digital assets. If the assets in the purchase asset format have been obtained prior to the termination, the transaction can be cancelled and/or the user computing device can be refunded (e.g., in the situation where the user computing device deposits fiat currency into the bi-directional digital asset POS computing device 14).

The method continues at step 5 where the digital asset-based interaction computing entity 16 connects to the one or more exchanging computing entities 91 of the digital asset-based interaction system to exchange the assets in the purchase asset format to an amount of digital assets where the amount of the assets in the purchase asset format is substantially equivalent to the amount of the digital assets. The digital asset exchange occurs quickly (e.g., 30 seconds to a few minutes) to account for exchange rate volatility and so that the bi-directional digital asset POS computing device 14 can provide and/or obtain desired assets in real-time.

When the bi-directional digital asset POS computing device 14 is operable to obtain fiat currency directly from the user computing device 12 as the assets in the purchase asset format, the bi-directional digital asset POS computing device 14 maintains an account with the digital asset-based interaction computing entity 16 such that the digital asset-based interaction computing entity 16 can access funds from the bi-directional digital asset POS computing device 14 account for the exchange. The merchant associated with bi-directional digital asset POS computing device 14 would then balance the accounting with the bi-directional digital asset POS computing device 14's account and the fiat currency received and stored within the with bi-directional digital asset POS computing device 14.

The method continues with step 6 where the bi-directional digital asset POS computing device 14 distributes the digital assets to the user computing device 12. For example, the bi-directional digital asset POS computing device 14 sends the amount of the digital assets to a location associated with the user computing device 12 (e.g., information in the real-time information (obtained via scanning a code from the user computing device) directs the amount of the second desired user assets from the digital asset-based interaction computing entity 16 (or one or more exchange entities) to a location associated with the user computing device 12, etc.). For example, the bi-directional digital asset POS computing device 14 directs the amount of the digital assets to an address of the asset management unit 22 of the user computing device 12. As another example, the bi-directional digital asset POS computing device 14 sends the amount of the digital assets to an address associated with a friend, family member, business associate, client, etc., of a user of the user computing device 12.

FIG. 32 is a flowchart of an example of a method of a digital asset purchase nonreal-time digital asset-based interaction loop of a digital asset-based interaction system. FIG. 32 includes the digital asset-based interaction computing entity 16, the digital asset backing computing entity 20, and one or more digital asset consensus network computing entities 45 of the digital asset-based interaction system and depicts the nonreal-time digital asset-based interaction loop 30 of the digital asset purchase of FIG. 31.

The nonreal-time digital asset-based interaction loop 30 (e.g., reconciliation of the digital asset-based interaction with the digital asset backing computing entity 20) occurs simultaneously with the real-time digital asset-based interaction loop 28 of FIG. 31, however; the nonreal-time digital asset-based interaction loop 30 occurs within a time frame that is longer than the time frame of the real-time digital asset-based interaction loop. For example, reconciliation of the digital asset-based interaction with the digital asset backing computing entity 20 occurs over the course of minutes whereas the time frame of the real-time digital asset-based interaction loop takes a few seconds.

The method begins at step 1, where when the amount of assets in the purchase asset format are obtained, the digital asset-based interaction computing entity 16 connects to the one or more digital asset consensus network computing entities 45 to verify the amount of assets in the purchase asset format received from the user computing device 12. The one or more digital asset consensus network computing entities 45 implement a verification process that may take minutes to hours of time.

For example, when the purchase asset format is a cryptocurrency hosted on a blockchain, the digital asset-based interaction computing entity 16 connects to the blockchain associated with the cryptocurrency to verify whether a certain amount of blocks including transaction of sending the amount of assets in the purchase asset format from the user computing device 12 have been added to the blockchain (e.g., a certain amount of confirmations are obtained). Other asset verification processes are possible and are based on the type of asset involved.

When the purchase asset format is a fiat currency obtained by the bi-directional digital asset POS computing device 14 directly from the user computing device 12, the digital asset-based interaction computing entity 16 accesses funds from an account associated with the bi-directional digital asset POS computing device 14 for the exchange. If the funds are stored by the digital asset-based interaction computing entity 16, the verification process may not be necessary. However, when the funds are not stored by the digital asset-based interaction computing entity 16, the digital asset-based interaction computing entity 16 may need to perform a verification process on the received assets (e.g., when the account associated with the bi-directional digital asset POS computing device 14 stores digital assets for a digital asset to fiat exchange).

The method continues with steps 2a or 2b. At step 2a, when the amount of assets in the purchase asset format are verified (or received via a method that does not involve the verification process), the digital asset-based interaction computing entity 16 instructs the digital asset backing computing entity 20 to unlock the locked amount of system digital assets.

At step 2b, when the amount of assets in the purchase asset format are not verified (or not received via a method that does not involve the verification process), the digital asset-based interaction computing entity 16 instructs the digital asset backing computing entity 20 to consume the locked amount of system digital assets. Consuming the amount of system digital asset means that the digital asset backing computing entity 20 transfers the amount of system digital assets to an address controlled by the digital asset-based interaction computing entity 16 in order to cover the amount of the digital asset-based interaction.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
initiating, by a user computing device, a sale of an amount of digital assets with a bi-directional digital asset point of sale (POS) computing device of a digital asset-based interaction system;
obtaining, by a digital asset-based interaction computing entity of the digital asset-based interaction system, real-time information regarding the sale of the amount of the digital assets from one or more of the bi-directional digital asset POS computing device and the user computing device, wherein the bi-directional digital asset POS computing device is associated with the digital asset-based interaction computing entity via a digital asset-based interaction interface, and wherein the real-time information includes a digital asset type of the digital assets, the amount of the digital assets, and a payment asset format;
locking, by the digital asset-based interaction computing entity, an amount of system digital assets to back the amount of the digital assets;
obtaining, by the bi-directional digital asset POS computing device, a confirmation from the digital asset-based interaction computing entity that the amount of system digital assets have been locked; and
providing, by the bi-directional digital asset POS computing device, an amount of assets in the payment asset format to the user computing device, wherein the amount of the assets is substantially equal to the amount of the digital assets.

2. The method of claim 1, wherein the initiating the sale of the amount of the digital assets comprises:
interacting, by the user computing device, with a user interface of the bi-directional digital asset POS computing device to select one or more prompts regarding the sale of the digital assets.

3. The method of claim 1, wherein the providing the amount of assets in the payment asset format to the user computing device comprises:
obtaining, by the bi-directional digital asset POS computing device, the amount of the digital assets from the user computing device;
providing, by the bi-directional digital asset POS computing device, the amount of the digital assets to the digital asset-based interaction computing entity;
exchanging, by the digital asset-based interaction computing entity, the amount of the digital assets to the amount of the assets in the payment asset format; and
providing, by the digital asset-based interaction computing entity, the amount of the assets in the payment asset format to the bi-directional digital asset POS computing device.

4. The method of claim 3, wherein the obtaining the amount of the digital assets from the user computing device comprises:
presenting, by the bi-directional digital asset POS computing device, a scannable code to the user computing device; and
scanning, by a scanning device of the user computing device, the scannable code, wherein scanning the scannable code pulls the amount of the digital assets from an address associated with the user computing device to an address associated with one of the bi-directional digital asset POS computing device and the digital asset-based interaction computing entity.

5. The method of claim 3, wherein the providing, by the bi-directional digital asset POS computing device, the amount of the digital assets to the digital asset-based interaction computing entity comprises one of:
sending, by the bi-directional digital asset POS computing device, the amount of the digital assets from an address associated with the bi-directional digital asset POS computing device to an address associated with the digital asset-based interaction computing entity; and
directing, the bi-directional digital asset POS computing device, the amount of the digital assets from an address associated with the user computing device to an address associated with the digital asset-based interaction computing entity.

6. The method of claim 3, wherein the providing the amount of the assets in the payment asset format to the bi-directional digital asset POS computing device comprises:
providing, by the digital asset-based interaction computing entity, the amount of the assets in the payment asset format to a bank account associated with the bi-directional digital asset POS computing device.

7. The method of claim 3, wherein the providing the amount of the assets in the payment asset format to the bi-directional digital asset POS computing device comprises:
providing, by the digital asset-based interaction computing entity, the amount of the assets in the payment asset format to an address associated with the bi-directional digital asset POS computing device.

8. The method of claim 1 further comprises:
implementing, by the digital asset-based interaction computing entity, a nonreal-time verification process associated with the digital asset type to verify obtaining the amount of the digital assets;
when the obtaining the amount of the digital assets is verified by the nonreal-time verification process:
unlocking, by the digital asset-based interaction computing entity, at least a portion of the amount of system digital assets; and
when the obtaining the amount of the digital assets is not verified by the nonreal-time verification process:
consuming, by the digital asset-based interaction computing entity, at least a portion of the amount of system digital assets.

9. The method of claim 1 further comprises:
locking, by the digital asset-based interaction computing entity, an exchange rate for the type of digital asset to the payment asset format.

10. A computer readable memory comprises:
a first memory element that stores operational instructions that, when executed by a user computing device, causes the user computing device to:
initiate a sale of an amount of digital assets with a bi-directional digital asset point of sale (POS) computing device of a digital asset-based interaction system;
a second memory element that stores operational instructions that, when executed by a digital asset-based interaction computing entity of the digital asset-based interaction system, causes the digital asset-based interaction computing entity to:
obtain real-time information regarding the sale of the amount of the digital assets from one or more of the bi-directional digital asset POS computing device and the user computing device, wherein the bi-directional digital asset POS computing device is associated with the digital asset-based interaction computing entity via a digital asset-based interaction interface, and wherein the real-time information includes a digital asset type of the digital assets, the amount of the digital assets, and a payment asset format; and
lock an amount of system digital assets to back the amount of the digital assets; and
a third memory element that stores operational instructions that, when executed by the bi-directional digital asset POS computing device, causes the bi-directional digital asset POS computing device to:
obtain a confirmation from the digital asset-based interaction computing entity that the amount of system digital assets have been locked; and
provide an amount of assets in the payment asset format to the user computing device, wherein the amount of the assets is substantially equal to the amount of the digital assets.

11. The computer readable memory of claim 10, wherein the first memory element further stores operational instructions that, when executed by the user computing device, causes the user computing device to initiate the sale of the amount of the digital assets by:
interacting with a user interface of the bi-directional digital asset POS computing device to select one or more prompts regarding the sale of the digital assets.

12. The computer readable memory of claim 10 further comprises, wherein the third memory element further stores operational instructions that, when executed by the bi-directional digital asset POS computing device, causes the bi-directional digital asset POS computing device to provide the amount of assets in the payment asset format to the user computing device by:
obtaining the amount of the digital assets from the user computing device; and
providing the amount of the digital assets to the digital asset-based interaction computing entity, and wherein a fourth memory element that stores operational instructions that, when executed by the digital asset-based interaction computing entity, causes the digital asset-based interaction computing entity to:
exchange the amount of the digital assets to the amount of the assets in the payment asset format; and
provide the amount of the assets in the payment asset format to the bi-directional digital asset POS computing device.

13. The computer readable memory of claim 12, wherein the third memory element further stores operational instructions that, when executed by the bi-directional digital asset POS computing device, causes the bi-directional digital asset POS computing device to obtain the amount of the digital assets from the user computing device by:
presenting, a scannable code to the user computing device, wherein a fifth memory element that stores operational instructions that, when executed by the user computing device, causes the user computing device to:
scan the scannable code, wherein scanning the scannable code pulls the amount of the digital assets from an address associated with the user computing device to an address associated with one of the bi-directional digital asset POS computing device and the digital asset-based interaction computing entity.

14. The computer readable memory of claim 12, wherein the third memory element further stores operational instructions that, when executed by the bi-directional digital asset POS computing device, causes the bi-directional digital asset POS computing device to provide the amount of the digital assets to the digital asset-based interaction computing entity by one of:
sending the amount of the digital assets from an address associated with the bi-directional digital asset POS computing device to an address associated with the digital asset-based interaction computing entity; and
directing the amount of the digital assets from an address associated with the user computing device to an address associated with the digital asset-based interaction computing entity.

15. The computer readable memory of claim 12, wherein the fourth memory element further stores operational instructions that, when executed by the digital asset-based interaction computing entity, causes the digital asset-based interaction computing entity to provide the amount of the assets in the payment asset format to the bi-directional digital asset POS computing device by:
providing the amount of the assets in the payment asset format to a bank account associated with the bi-directional digital asset POS computing device.

16. The computer readable memory of claim 12, wherein the fourth memory element further stores operational instructions that, when executed by the digital asset-based interaction computing entity, causes the digital asset-based interaction computing entity to provide the amount of the assets in the payment asset format to the bi-directional digital asset POS computing device by:
providing the amount of the assets in the payment asset format to an address associated with the bi-directional digital asset POS computing device.

17. The computer readable memory of claim 10 further comprises:
a fourth memory element that stores operational instructions that, when executed by the digital asset-based interaction computing entity, causes the digital asset-based interaction computing entity to:
implement a nonreal-time verification process associated with the digital asset type to verify obtaining the amount of the digital assets; and
when the obtaining the amount of the digital assets is verified by the nonreal-time verification process:
unlocking at least a portion of the amount of system digital assets; and
when the obtaining the amount of the digital assets is not verified by the nonreal-time verification process:
consuming at least a portion of the amount of system digital assets.

18. The computer readable memory of claim 10, wherein the second memory element further stores operational instructions that, when executed by the digital asset-based interaction computing entity, causes the digital asset-based interaction computing entity to:
lock an exchange rate for the type of digital asset to the payment asset format.
